(19) United States
(12) Patent Application Publication
(10) Pub. No.: US 2026/0125154 A1
(43) Pub. Date: May 7, 2026

(54) PASSENGER SEAT DEVICE

(71) Applicant: RECARO Aircraft Seating GmbH & Co. KG, Schwaebisch Hall (DE)

(72) Inventors: Thomas DRENZECK, Michelfeld (DE); Michael HORLACHER, Schwäbisch Hall (DE); Maik THIELE, Stuttgart (DE)

(21) Appl. No.: 19/130,838

(22) PCT Filed: Nov. 17, 2023
(86) PCT No.: PCT/EP2023/082296

§ 371 Date: May 16, 2025

(30) Foreign Application Priority Data
Nov. 18, 2022 (DE) 10 2022 130 632.1
Jun. 5, 2023 (DE) 10 2023 114 753.6

(51) Int. Cl. B64D 11/06

(52) U.S. Cl. CPC B64D 11/064

(57) ABSTRACT

A passenger seat device with two seat structure elements, which are in each case arranged on a respective side of a sitting area, with two bearing elements, wherein respectively one bearing element is fixedly connected with one of the seat structure elements, with a backrest including at least one pivotable backrest element which is pivotably supported on the seat structure elements via the bearing elements, with at least one reset module including at least one spring element to provide a resetting force for restoring the pivotable backrest element from a comfort position into an upright seat position, and with a locking device which is configured for locking the pivotable backrest element at least in the upright seat position, wherein the locking device includes at least one locking module, which is arranged between the first seat structure element and a load-bearing element of the pivotable backrest element.

### CROSS-REFERENCE TO RELATED APPLICATIONS

This patent application is a U.S. national stage application of the international patent application PCT/EP2023/082296, filed on Nov. 17, 2023, which is based on and claims priority to the German patent application DE 10 2022 130 632.1, filed on Nov. 18, 2022 and to the German follow-up patent application DE 10 2023 114 753.6, filed on Jun. 5, 2023, the contents of which are incorporated herein by reference.

### PRIOR ART

The invention concerns a passenger seat device.

A passenger seat device with a mounting unit for mounting on a mounting plane, with two seat structure elements, which are in each case arranged on a respective side of a sitting area, with two bearing elements, wherein respectively one bearing element is fixedly connected with one of the seat structure elements, with a backrest comprising at least one pivotable backrest element which is pivotably supported on the seat structure elements via the bearing elements, with at least one reset module comprising at least one spring element to provide a resetting force for restoring the backrest element from a comfort position into an upright seat position, and with a locking device which is configured for locking the pivotable backrest element at least in the upright seat position, has already been proposed.

The objective of the invention is in particular to provide a generic device with improved properties with regard to construction space requirements. The objective is achieved according to the invention.

### ADVANTAGES OF THE INVENTION

The invention is based on a passenger seat device with a mounting unit for mounting on a mounting plane, with two seat structure elements which are in each case arranged on a respective side of a sitting area, with two bearing elements, wherein respectively one bearing element is fixedly connected with one of the seat structure elements, with a backrest comprising at least one pivotable backrest element which is pivotably supported on the seat structure elements via the bearing elements, with at least one reset module comprising at least one spring element to provide a resetting force for restoring the backrest element from a comfort position into an upright seat position, and with a locking device which is configured for locking the pivotable backrest element at least in the upright seat position.

It is proposed that the locking device comprises at least one locking module, which is arranged between the first seat structure element and a load-bearing element of the pivotable backrest element. “Configured” is in particular to mean specifically programmed, designed and/or equipped. By an object being configured for a certain function is in particular to be understood that the object fulfils and/or carries out this certain function in at least one application state and/or operation state. A “passenger seat device” is preferably to mean a device that forms at least a portion of a passenger seat and/or the entire passenger seat. The passenger seat device is preferably realized as an aircraft seat device. Preferably, a “passenger seat” is in particular to mean a seat that is configured to form a sitting area for a passenger and is for this purpose arranged in a means of transport. The passenger seat is preferably realized as an aircraft seat. In principle, it is also conceivable that the passenger seat is realized as a train seat. In principle, it would also be conceivable that the passenger seat is realized as a seat for a different means of transport. The passenger seat is preferably realized as part of a seat row of several passenger seats which are arranged side by side. The passenger seat preferably comprises at least one seat bottom, which forms a sitting area for a passenger, and a backrest providing a backrest support surface on which a passenger sitting on the passenger seat can support himself/herself with his/her back. Herein a “seat bottom” is in particular to mean a portion of the passenger seat that provides a sitting area on which a passenger can sit, the seat bottom preferably comprising at least a base body and a cushion element arranged on the base body. Furthermore, the passenger seat comprises a mounting unit, via which the passenger seat is mounted on a floor, in particular a cabin floor, and to which further components of the passenger seat, such as the seat bottom and the backrest, are connected. Preferably, a “mounting unit” is to mean a base structure of the passenger seat that forms a load-bearing structure of the passenger seat. Via the mounting unit, the passenger seat is connected on a mounting plane, i.e. in particular on the cabin floor. The mounting unit preferably comprises at least two seat bases and at least one transverse element that is coupled with the seat bases. The transverse element forms a support tube. Preferably the mounting unit comprises two transverse elements, a front transverse element and a rear transverse element. The mounting unit is preferably coupled with the floor, preferably with corresponding fastening rails in the floor, via several fittings. The mounting unit forms a load-bearing frame of the passenger seat, preferably of the entire passenger seat row.

A “seat structure element” is preferably to mean a portion of a load-bearing structure of the passenger seat to which further components of the passenger seat, such as a backrest, a backrest element or an armrest, can be fastened. A seat structure element is preferably realized as a seat divider. The seat structure element that is realized as a seat divider is preferably rigidly connected with the at least one transverse element, preferably with the two transverse elements, of the mounting unit. The seat structure element that is realized as a seat divider preferably extends from the front transverse element substantially horizontally into a region behind the rear transverse element. In a region behind the rear transverse element, the seat structure element that is realized as a seat divider extends away from the mounting plane in a substantially vertical direction, preferably as far as an armrest level. In principle, it is also conceivable that the seat structure elements are realized integrally with a portion of a seat shell, for example with a lower backrest element. The seat structure elements that are realized integrally could in such a case be realized, for example, as lateral regions of a seat shell.

By a “pivotable backrest element” is preferably a backrest element to be understood which forms at least a portion, preferably a large portion, of the backrest surface of the backrest and which is supported pivotably relative to the mounting unit in order to realize the comfort position and the upright seat position. The pivotable backrest element is supported so as to be pivotable relative to the mounting unit in order to realize the comfort position and the upright seat position. The pivotable backrest element comprises a load-bearing element and forms the backrest surface in its inner region. The load-bearing element of the pivotable backrest element is realized as a backrest frame. The pivotable backrest element comprises a covering which is connected with the backrest frame, or a shell element which forms the backrest surface. In principle, it would also be conceivable that the pivotable backrest element is realized as a shell component which forms the backrest frame and the backrest surface conjointly. In such a case, it would be conceivable that the pivotable backrest element does not comprise a backrest frame. The load-bearing element of the pivotable backrest element would in such a case be realized as the sandwich component itself. In principle, it would likewise be conceivable that the pivotable backrest element is realized as a sandwich component. The pivotable backrest element is preferably pivotably connected to the mounting unit of the passenger seat. The pivotable backrest element is connected to seat structure elements of the passenger seat via the bearing elements.

An “upright seat position” is to mean a maximally upright seat position of the passenger seat, in which the passenger seat has a maximally upright seat position. If the passenger seat is realized as an aircraft seat, the upright seat position is preferably realized as a seat position that has to be assumed for safety reasons, in particular in a start phase, in a landing phase and during turbulences. Herein the upright seat position is realized as a so-called TTL position (taxi, takeoff, landing). In the upright seat position, the backrest, in particular a movably supported backrest element, and the seat bottom of the passenger seat are arranged substantially perpendicular to each other, preferably at an angle between 95 degrees and 115 degrees. A “comfort position” is in particular to mean a rearwards-inclined seat position of the passenger seat, in which at least the backrest, in particular a pivotable backrest element, is inclined rearwards counter to a sitting direction of the passenger seat, which enables a comfortable, rearwards-inclined seat position for a passenger sitting on the passenger seat. In principle, it is also conceivable that in the comfort position, in addition to the pivotable backrest element, the seat bottom is also inclined against the upright seat position of the passenger seat. In the comfort position, the backrest, in particular the pivotable backrest element, and the seat bottom may in particular include a different, in particular advantageously greater, angle with each other than in the upright seat position (TTL position). In the comfort position, the backrest, in particular the pivotable backrest element, is pivoted rearwards from a maximally upright seat position by at least 3 degrees, preferably at least 5 degrees, particularly preferably by more than 8 degrees.

A “reset module” is preferably to mean a module which is configured to exert a reset force for restoring the backrest, in particular a movably supported backrest element, in order to move it from a position, in particular a comfort position, into an upright seat position. For this purpose, the reset module preferably comprises a spring element providing a force for an adjustment of the backrest, in particular of the pivotable backrest element. The spring element for providing a reset force may for example be realized as a leaf spring element. In principle, it is also conceivable that the spring element is realized as a different spring element, for example as a gas compression spring, as a helical spring or as a different compression or tension spring element.

A “locking device” is preferably to mean a device configured to lock two components in a locking position in at least one defined position with respect to one another. The locking device is configured to fix the pivotable backrest element in two positions, on the one hand in the upright seat position and in the comfort position, relative to the mounting unit. Preferably, the locking device is configured to lock the pivotable backrest element only in the two positions, namely in the upright seat position and in the comfort position. In principle, it would also be conceivable that the locking device is configured to lock the pivotable backrest element in one or two defined intermediate positions. At least in some exemplary embodiments, the locking device is not configured for a stepless blocking of the pivotable backrest element. The locking device can only lock in the upright seat position and in the comfort position. By means of the locking device, the adjustable backrest element cannot be locked in any desired intermediate positions between the upright seat position and the comfort position. Preferably, in at least one exemplary embodiment, the locking device may be configured for the stepless blocking of the pivotable backrest element.

The locking module being “arranged between the first seat structure element and a load-bearing element of the pivotable backrest element” is to mean that the locking module is functionally arranged between, i.e., with respect to a force flow between, the first seat structure element and the load-bearing element. Herein the locking module does not necessarily also have to be arranged spatially between the seat structure element and the load-bearing element. The locking module may preferably be directly or indirectly connected to a seat structure element. Particularly preferably, the locking module is connected to the bearing element. An implementation according to the invention allows a locking device for locking the backrest being realized in an especially advantageously simple and space-saving fashion. The bearing elements are rigidly and rotationally fixedly connected with the seat structure elements. Preferably, the bearing elements are rotationally-fixedly connected with the respective seat structure element via a connecting flange and via several connecting screws. In principle, it is also conceivable that the bearing elements are rotationally-fixedly connected with the respective seat structure element in a different way, deemed expedient by someone skilled in the art, via which the support forces can be transferred from the bearing element into the seat structure element. For example, it would be conceivable that the bearing element comprises, on an end facing the seat structure element, at least one form-fitting element, which may be realized for example as an outer contour of the bearing element and via which the bearing element can be connected in a receptacle of the seat structure element in a form-fitting manner. For a connection with the seat structure element, the bearing element may thus, for example, be accommodated in a receptacle of the seat structure element in a form-fitting manner and be safeguarded against an axial displacement by means of a safeguarding element, for example a screw. The implementation according to the invention allows a blocking of a pivotable backrest element being realized in an especially simple manner and separately from the spring element.

Furthermore, it is proposed that the locking device is arranged mostly above the bearing elements. The locking device being “arranged mostly above the bearing elements” is preferably to mean that a substantial portion of the locking device, preferably more than 75% as seen from the cabin floor, is arranged above a lower extent of the bearing elements. Herein the lower extent is realized as the portion of a bearing element that has a smallest distance from the mounting plane. This allows integrating the locking device in the passenger seat in an especially advantageously space-saving fashion and providing an especially advantageously large knee region.

It is moreover proposed that the locking device is realized separately from the spring element. The “locking device being realized separately from the spring element” is to mean that the locking device is not realized as part of the spring element. The locking device is functional without the spring element, which means it is configured to lock the pivotable backrest element at least in the upright seat position. The locking device and the spring element are not realized conjointly. The locking device does not constitute an integral component of the spring element. The locking device is realized separately from a locking unit that is integrated in a gas compression spring. In principle, however, despite the separate implementation of the locking device and the spring element, it is conceivable that at least a portion of the locking device and the spring element are arranged in the same region of the passenger seat. In principle, it would even be conceivable that the spring element contacts a portion of the locking device, such that the spring element can support itself on the portion of the locking device. As a result, both the spring element and the locking device can be connected to the passenger seat in an especially space-saving and simple manner.

It is further proposed that the locking module is arranged on an outer side of the load-bearing element of the backrest element. As a result, the first locking module can be arranged in a particularly space-saving manner.

Beyond this, it is proposed that the locking module comprises a first locking unit and a second locking unit, which are supported movably with respect to each other and are configured to be locked with each other in the upright seat position and in the comfort position in a form-fitting and/or force-fitting manner. A “locking unit” is preferably to mean a subunit of the locking module which is connected to one of the two components that are to be locked with each other by means of the locking module. “Locking with each other in a form-fitting and/or force-fitting manner” is preferably to mean that a locking is achieved by a form-fitting engagement of two elements into each other and/or by a force fit, for example a friction fit, between two elements. Preferably the locking is implemented by at least one form-fitting connection of two elements. In principle, it is conceivable that a locking is achieved only by a force fit, or by a combination of a form fit and a force fit. This allows realizing the locking module in an especially simple manner.

Furthermore, it is proposed that the first locking unit comprises a base body, and comprises a blocking element, which is supported on the base body in a spring-loaded and adjustable manner between a locking position and a release position, and is configured to be coupled with the second locking unit in a form-fitting manner for locking. As a result, the locking module can be locked in form-fitting fashion in an especially simple manner and can be unlocked in an advantageously simple manner.

It is also proposed that the first locking unit comprises a linear guidance supporting the blocking element, which is supported in a spring-loaded and adjustable manner, linearly along a displacement path. The displacement path, along which the adjustably supported locking element is displaceable, is preferably realized as a straight displacement axis along which the locking element is adjustable in a straight path. In principle, it would also be conceivable that the displacement path is realized in a curved manner. In such a case, the blocking element would be displaceable along the curved displacement path. As a result, the locking element can be movably supported in an especially simple manner.

The displaceably supported blocking element is preferably realized as an element which is adjustable in a height direction and is connected to the pivotable backrest element. In principle, it is also conceivable that the adjustably supported blocking element is realized as a pin, which is supported so as to be displaceable in a horizontal direction and is connected in a locking unit that is fastened at the bearing element. Herein the blocking element, which is supported so as to be displaceable in a horizontal direction, would be supported so as to be displaceable in a transverse direction In a locking state, the blocking element, which is supported so as to be displaceable in a horizontal direction on the locking unit that is fastened at the bearing element, would be configured to engage in a form-fitting element in the backrest frame.

It is further proposed that the second locking unit comprises a form-fitting element which, for the purpose of locking the backrest element in the upright seat position, is configured to fix the blocking element of the first locking unit in a form-fitting and/or force-fitting manner. This enables especially simple locking of the blocking element for a locking of the locking module.

In addition, it is proposed that in a mounted state, the first locking unit is mounted on the pivotable backrest element and the second locking unit is mounted on the bearing element in a loss-proof manner. This allows particularly simple integration of the locking units in the passenger seat for the purpose of realizing the locking module.

Moreover, it is proposed that the second locking unit comprises an attachment element, which is in a normal operation state connected to the bearing element in a rotationally fixed manner, and comprises an overload unit, which is configured to permit a relative movement between the connection element and the bearing element in the event of an overload. This enables especially advantageous connection of the pivotable backrest element for the event of a crash.

It is furthermore proposed that the overload unit is configured to permit a rotation of the backrest by a defined angle in the event of an overload. The overload unit is configured to permit, in the event of an overload, a frontward rotation of the backrest in a direction opposed to the comfort position. This advantageously allows reducing an injury risk of a passenger in the event of a crash.

In addition, it is proposed that the second locking unit comprises a second form-fitting element, which forms an end abutment for the comfort position of the backrest element, and that the first locking unit comprises a second blocking element which is configured, in the comfort position, to lock the pivotable backrest element by a form-fitting connection to the second form-fitting element of the second locking unit. By a “second blocking element” is a further blocking element to be understood, which is realized separately from the first blocking element and may for example be realized as a blocking bolt. The second form-fitting element may advantageously be realized in space-saving fashion below the first form-fitting element of the second locking unit. This allows realizing the locking module in a particularly compact manner and with advantageously small installation space.

In principle, it would also be conceivable that the second blocking element is realized integrally with the first blocking element. For this it would be necessary to enlarge the second locking unit towards the rear in the region of the first form-fitting element and to provide a further form-fitting element there. As a result, the locking module could be realized in a simpler manner, but would have a greater installation space requirement towards the rear.

Beyond this, it is proposed that the second locking unit comprises an eccentric adjusting unit, by means of which a position of the form-fitting element is adjustable relative to the first locking unit. By an “eccentric adjusting unit” is preferably a unit to be understood which comprises at least one coupling element that is eccentrically supported by a connection element, wherein the coupling element brings about an adjustment of the elements, which are connected to one another by means of the eccentric unit, relative to on another by a rotation around the connection element. In principle, it would also be conceivable that an adjustment of the backrest angle is provided by a different adjusting unit instead of the eccentric adjusting unit. Herein the adjusting unit may be realized, for example, by an adjustment using a grub screw and a corresponding adjustment mechanism. This allows particularly simple adjustment of an angle of the pivotable backrest element in the comfort position, respectively in the upright seat position, during the mounting of the passenger seat, in order to advantageously compensate tolerances during installation. Especially advantageously, it is possible to easily adjust passenger seats of identical construction, for example for different customers or cabin conditions, with different seat angles in the upright seat position and with different reclining angles, i.e. angles of the pivotable backrest element, in the comfort position.

Furthermore, it is proposed that the second locking unit comprises an abutment surface, against which the blocking element of the first connection unit abuts in the comfort position of the backrest element, wherein the abutment surface forms an inclined surface via which the blocking element can be pressed out of its locking position into a release position. This advantageously allows the pivotable backrest element being pressed from the comfort position into the upright seat position by applying an overpressing force to the backrest element. This advantageously enables an adjustment of the backrest into the upright seat position, for example by personnel, wherein it is not necessary to actuate an actuating element for an unlocking of the locking device.

Moreover, it is proposed that the locking module comprises a release unit, which is configured to undo in a release position a coupling between the first locking unit and the second locking unit in order to enable a frontward pivoting of the backrest element, beyond the upright seat position into a non-use position. A “non-use position” is preferably to mean a position in which the pivotable backrest element is not intended to form a backrest surface for a passenger sitting on the passenger seat. In the non-use position, the pivotable backrest element preferably lies with its backrest surface upon the seat bottom of the passenger seat. This enables realizing the locking module in a particularly simple manner, such that the pivotable backrest element can be brought into a frontwardly folded non-use position. This advantageously allows providing a configuration of the passenger seat in which a stretcher can be arranged across two passenger seats with the backrest element folded down and frontwards.

It is further proposed that the locking device comprises a second locking module, which is arranged on a side of the backrest element that is situated opposite the first locking module and is realized substantially identically to the first locking module. The second locking module is preferably to a large extent realized identically to the first locking module. The second locking module is a mirror-image of the first locking module. In principle, it is conceivable that the two locking modules, in addition to being mirror-images of each other, also differ by different connections for an actuating or force transmission element, such as for example a Bowden cable. This allows realizing the locking device in an especially advantageous manner for a locking of the pivotable backrest element, and in particular enables the locking device to provide a rigid locking with little play of the pivotable backrest element in a locked position.

It is moreover proposed that the second locking module is actuatable together with the first locking module via a Bowden cable, wherein the second locking module is connected in series with the first locking module. The second locking module being “connected in series with the first locking module” is to mean that an actuation of the first locking module triggers an actuation of the second locking module. A transmission element, such as in particular a Bowden cable, transmitting the movement of the movably supported blocking element of the first locking module to the movably supported blocking element of the second locking module, is connected to the movably supported blocking element of the first locking module. Herein the transmission element is preferably not connected directly to the movably supported blocking element, but to the movably supported bearing slide of the linear bearing of the first locking module, to which the movably supported blocking element of the first locking module is connected. As a result, it is particularly advantageously possible for the two locking modules of the locking device to be actuated together.

In a mounted state, the locking device, in particular the two locking modules of the locking device, are inaccessible from the outside, in particular for a passenger. The passenger seat device preferably comprises a cover which covers the locking modules towards the outside. The cover may preferably be part of a backrest lining. In principle, it is also conceivable that the covers are in each case realized as individual modules which are separately removable from the backrest lining. Preferably, the covers are preferably realized such that access to the release unit is accessible for personnel.

Furthermore, it is proposed that the locking device is configured for a stepless blocking of the pivotable backrest element between the comfort position and the upright seat position. The locking device is configured for a stepless fixing of the pivotable backrest element. The locking device is configured to fix the pivotable backrest element in a force-fitting manner, i.e. by a frictional connection, in a positionally fixed manner in any positions between the upright seat position and the comfort position. Forces, in particular sitting forces or holding forces, which act on the pivotable backrest element in a normal operation, are transferred into the mounting unit in the intermediate positions in the locking device purely via a frictional connection. A fixing of the pivotable backrest element in the intermediate positions is realized by means of the locking device purely via a frictional connection. Forces acting on the backrest are supported in the locking device via a frictional connection. In the upright seat position and in the comfort position, at least forces in a movement direction of the pivotable backrest element, in which the pivotable backrest element is not fixed in a form-fitting manner, are supported via a frictional connection. As a result, comfort can be advantageously increased.

It is also proposed that the at least one locking module comprises a friction unit, which is configured to provide a holding force for a stepless blocking of the pivotable backrest element. A “friction unit” is preferably to mean a unit comprising at least two friction elements, which are configured for a frictional connection with one another and are arranged so as to be movable relative to one another. In at least one state, in particular a non-actuated state, the friction elements are configured to be in a frictional connection. In at least one further state, in particular an actuated state of the friction unit, the friction elements are at least partly, preferably completely, spaced apart from one another and are no longer in frictional contact with one another. The friction elements preferably each comprise a friction surface which is configured to be in a frictional connection with a friction surface of the other friction element. Friction surfaces of the friction elements may preferably be realized as planar surfaces. In principle, it is also conceivable that the friction surfaces of a friction element are realized as a shaped surface, for example a cone-shaped surface. Preferably, a friction element may also be realized as a lateral surface of a shaft. Preferably, it is also conceivable that a friction element is realized as a spring element, in particular as an inner side of a wrap spring. By a “holding force” is preferably a force to be understood which is required, in a state in which the friction elements are in frictional contact with one another, for moving the friction elements relative to one another. The holding force is realized as a sticking-friction force between the two friction elements of the friction unit. This allows realizing the locking module in a particularly simple manner for the stepless locking of the pivotable backrest element.

Beyond this, it is proposed that one of the locking units of the locking module comprises a rotatably supported shaft, which is configured to rotate during a pivoting of the pivotable backrest element, and comprises a friction unit which, for the locking of the pivotable backrest element, is configured to secure the rotatably supported shaft against rotation in a force-fitting manner. This allows especially simple integration of the friction unit in the locking module, and allows a force from the pivotable backrest element being supported on the friction unit.

It is further proposed that one of the locking units of the locking module comprises a base body, wherein the locking module comprises a coupling gear via which the base body is connected to the rotatably supported shaft of the other locking unit, and which is configured to transmit a pivoting movement of the pivotable backrest element to the rotatably supported shaft. A “coupling gear” is preferably to mean a gear via which two elements, which are supported movably relative to each other, can be coupled with each other, and via which a movement, in particular a rotary movement or pivoting movement, and a force can be transmitted between the coupled elements. The coupling gear is preferably realized as a toothed-wheel gear. A toothed-wheel gear preferably comprises at least two intermeshing toothed elements. The coupling gear has a transmission ratio. The coupling gear preferably has a transmission ratio which is between 1:5 and 1:20, preferably between 1:7 and 1:15. Particularly preferably, the coupling gear has a transmission ratio which is between 1:9 and 1:12. The coupling gear has a transmission ratio by means of which a force, in particular a momentum, is transmitted between the two elements which are coupled with each other via the coupling gear. By means of the coupling gear, forces are transmitted between the one locking unit and the other locking unit of the locking module. By the transmission ratio it is advantageously possible that large forces acting on the backrest are supported by the friction unit. This allows especially advantageous integration of the friction unit in the locking module and especially advantageous support of large forces by the friction unit.

Furthermore, it is proposed that the coupling gear comprises a toothed element, which is rigidly connected with the rotatably supported shaft, and comprises a toothed element which is rigidly connected with the base body and engages in a meshing manner in the toothed element that is connected with the shaft. A “toothed element” is preferably to mean an element having several teeth which are configured to mesh with teeth of a further toothed element. A toothed element may preferably be realized as a toothed wheel or as a partial toothed wheel. A toothed element may preferably be realized as a toothed bar. In this way the friction unit can especially advantageously be coupled with the other locking unit via the rotatably supported shaft.

Moreover, it is proposed that the at least one locking module comprises a friction unit, which for the purpose of providing a holding force comprises a first fixed friction element, a second friction element that is connected to a rotatably supported shaft of the locking module and at least one spring element, wherein the at least one spring element presses the two friction elements against each other in a non-actuated state. This allows realizing the friction unit in an especially simple manner.

It is further proposed that the two friction elements are realized as conical friction elements which are realized so as to correspond to each other, the friction unit comprising a spacer element which is configured to vary a friction force and/or a distance between the two friction elements by rotation. A “conical friction element” is preferably to mean a friction element whose friction surface has a cone-shaped shape, in particular a cone-shaped elevation or a cone-shaped depression. A “spacer element” is preferably to mean an element that changes a distance between two other elements, in particular a distance between a base body and an attachment element of the friction unit, by a movement, preferably by rotation. This especially advantageously allows realizing the friction unit with a small actuation travel path.

In addition, it is proposed that one of the friction elements is realized as an axially movable conical friction element, which is preferably realized integrally with the rotatably supported shaft of the locking module. “Integrally” is in particular to mean connected by material bonding, such as for example by a welding process and/or an adhesive-bonding process etc., and especially advantageously molded on, such as by production from a casting and/or by production in a single-component or multi-component injection-molding process. This allows realizing the one friction element in a particularly advantageous manner.

It is further proposed that the friction unit comprises a base body, wherein the spring element is arranged between the base body and the spacer element. This allows especially advantageous integration of the spring element in the friction unit.

Furthermore, it is proposed that a first friction element of the friction unit is realized as an inner surface of the spring element of the friction unit, which is realized as a spiral spring, and a second friction element of the friction unit is realized as a lateral-shell surface of a subregion of the rotatably supported shaft of the locking module. The spring element, which is embodied as a spiral spring, is preferably realized as a wrap-around spring which in a non-actuated state presses with its inner side onto the lateral surface of the shaft. The spring element, which is embodied as a wrap-around spring, is pressed by its inner spring tension onto the lateral surface of the shaft, resulting in a frictional connection between the inner side of the spring element and the shaft. In an actuated state, the spring element, which is embodied as a wrap-around spring, is preferably elastically deformed in such a way that it is released from the lateral surface of the shaft. This allows realizing the friction unit in a particularly simple manner.

The passenger seat device according to the invention shall here not be limited to the above-described application and implementation. In particular, in order to fulfil a functionality that is described here, the passenger seat device according to the invention may comprise a number of individual elements, components and units that differs from a number given here.

### DRAWINGS

Further advantages will become apparent from the following description of the drawings. In the drawings eight exemplary embodiments of the invention are illustrated. The drawings, the description and the claims contain numerous features in combination. Someone skilled in the art will purposefully also consider the features individually and will find further expedient combinations.

In the drawings:

FIG. 1 shows a schematic view of a passenger seat row with a passenger seat device in a first exemplary embodiment, with a backrest comprising a pivotable backrest element and with a locking device,

FIG. 2 shows a schematic view of a backrest frame of the pivotable backrest, with the locking device comprising two locking modules,

FIG. 3 shows a schematic exploded illustration of one of the locking modules with its two locking units,

FIG. 4 shows a further schematic exploded illustration of one of the locking modules with its two locking units from another perspective,

FIG. 5 shows a schematic view of one of the locking modules in a locking position, in an upright seat position of the pivotable backrest element, with an eccentric adjusting unit partially in an exploded view,

FIG. 6 shows a schematic sectional view through one of the locking modules in a locking position, in the upright seat position of the pivotable backrest element,

FIG. 7 shows a schematic view of one of the locking modules in a locking position, in a comfort position of the pivotable backrest element,

FIG. 8 shows a schematic sectional view through one of the locking modules in a locking position, in the comfort position of the pivotable backrest element,

FIG. 9 shows a schematic view of a portion of a locking device in a second exemplary embodiment, wherein only one of the two locking modules is shown, and

FIG. 10 shows a schematic view of a portion of a locking device in a third exemplary embodiment, wherein only one of the two locking modules is shown, with an alternative reset module,

FIG. 11 shows a schematic view of a passenger seat row with a passenger seat device in a fourth exemplary embodiment, with a backrest having an upper backrest pivot point and with a reset module,

FIG. 12 shows a schematic rear view of a passenger seat in the fourth exemplary embodiment,

FIG. 13 shows a schematic side view of the passenger seat in the fourth exemplary embodiment,

FIG. 14 shows a schematic view of an upper backrest element, with a reset module comprising two spring elements realized as spiral springs,

FIG. 15 shows a schematic view of an upper backrest element of a passenger seat device in a fifth exemplary embodiment, with a reset module comprising two spring elements realized as bar springs,

FIG. 16 shows a highly schematized view of a lower backrest element of a passenger seat device in a sixth exemplary embodiment,

FIG. 17 shows a schematic view of a passenger seat row with a passenger seat device in a seventh exemplary embodiment, with a backrest comprising a pivotable backrest element and with a locking device that is configured for a stepless locking of the pivotable backrest element,

FIG. 18 shows a schematic view of a backrest frame of the pivotable backrest, with the locking device comprising two locking modules,

FIG. 19 shows a schematic exploded illustration of one of the locking modules with its two locking units and with a friction unit with two conus-shaped friction elements,

FIG. 20 shows a further schematic exploded illustration of one of the locking modules with its two locking units and with the friction unit from another perspective,

FIG. 21 shows a schematic sectional view of one of the locking modules, cut through a rotatably mounted shaft and the friction unit,

FIG. 22 shows a schematic illustration of the pivotable backrest element in a comfort position,

FIG. 23 shows a schematic view of the passenger seat device in an eighth exemplary embodiment, with a backrest comprising a pivotable backrest element in a comfort position and with a locking device,

FIG. 24 shows a schematic exploded illustration of one of the locking modules with its two locking units and with a friction unit with a friction element that is realized as a spring element,

FIG. 25 shows a further schematic exploded illustration of one of the locking modules, with its two locking units and with the friction unit, from another perspective, and

FIG. 26 shows a schematic sectional view of one of the locking modules, cut through a rotatably mounted shaft and the friction unit.

### DESCRIPTION OF THE EXEMPLARY EMBODIMENTS

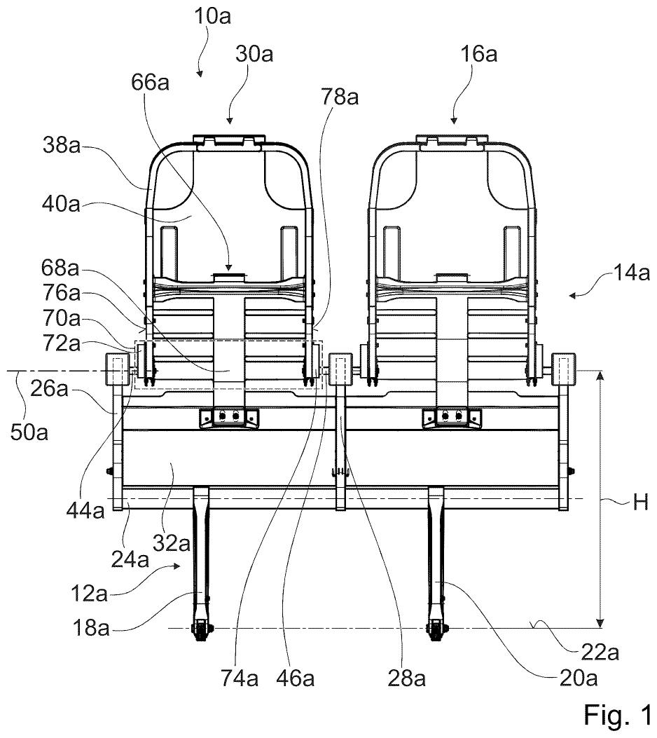

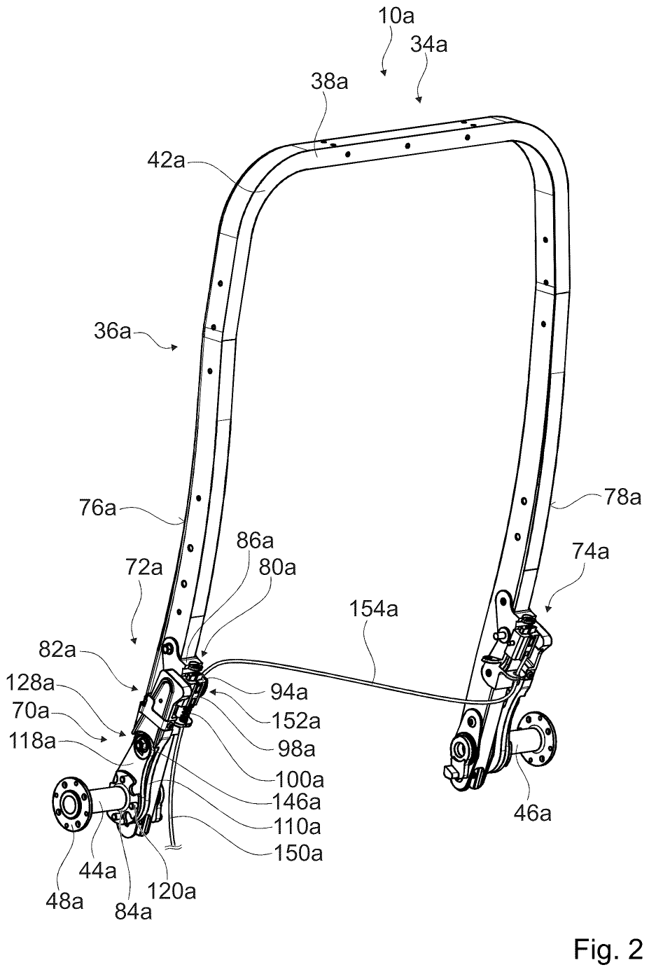

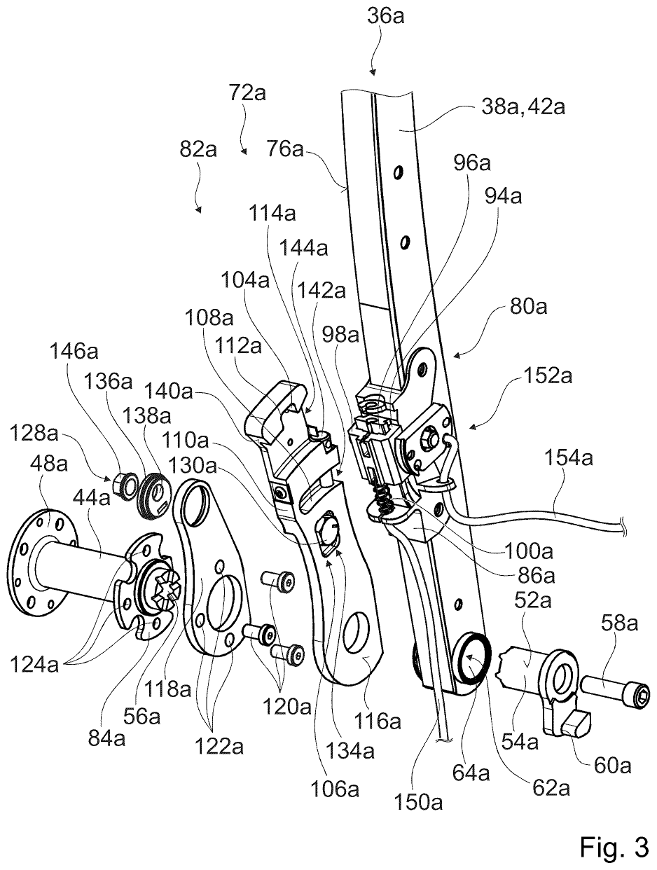

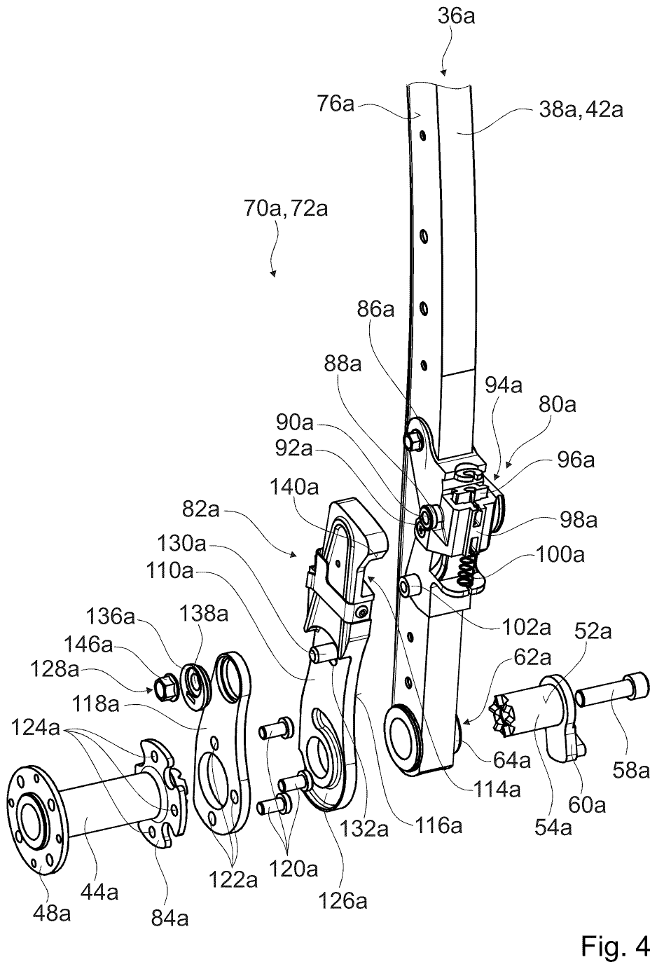

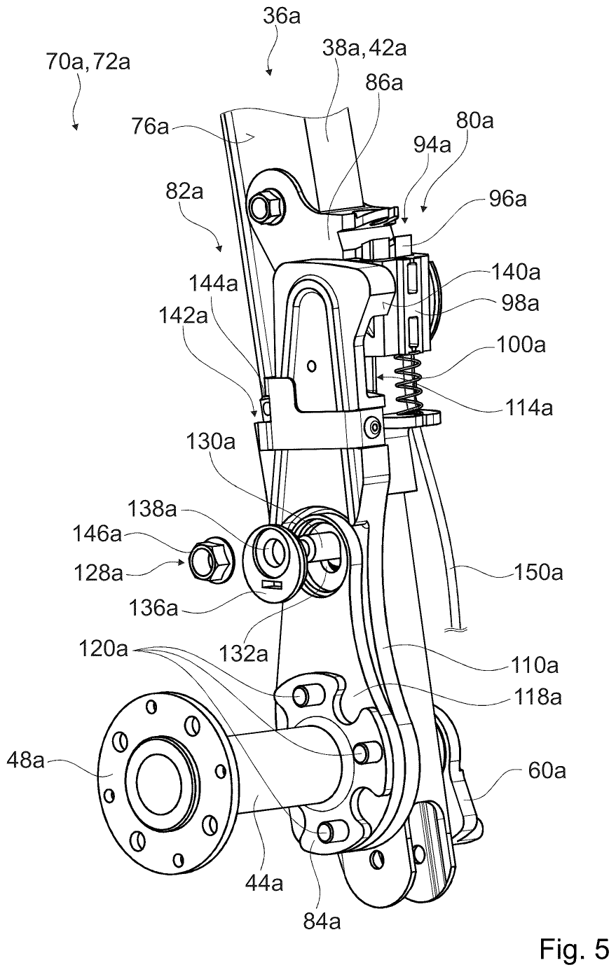

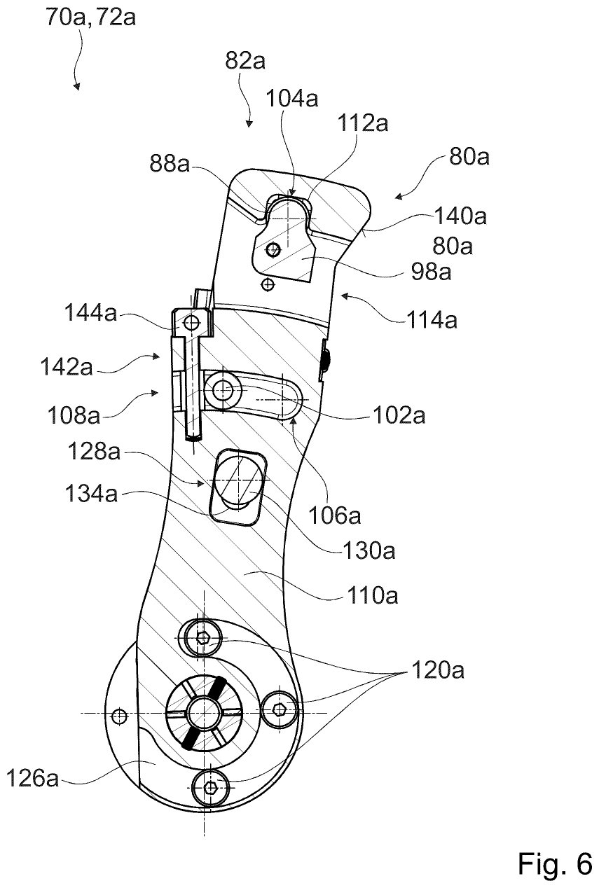

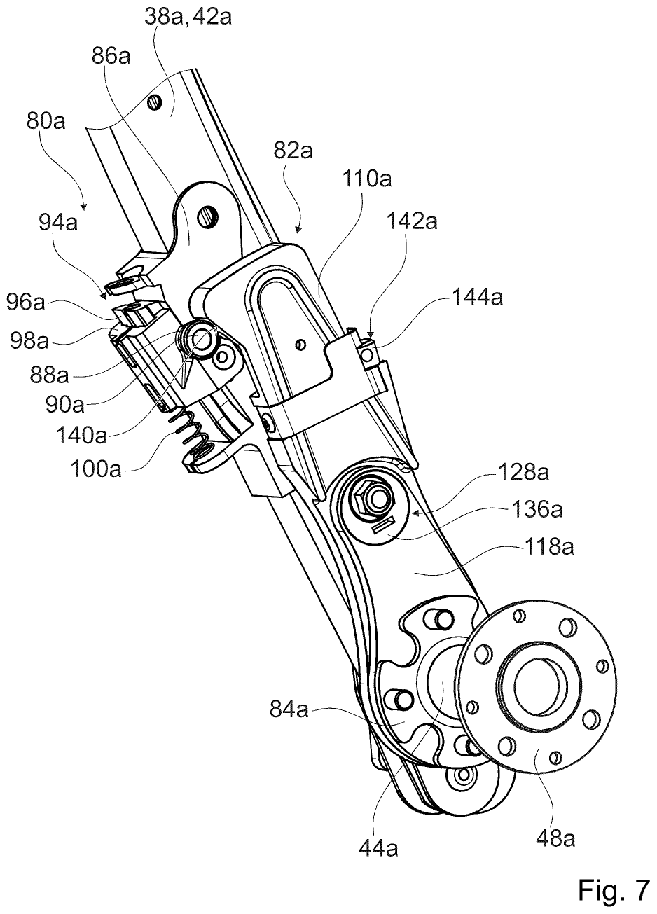

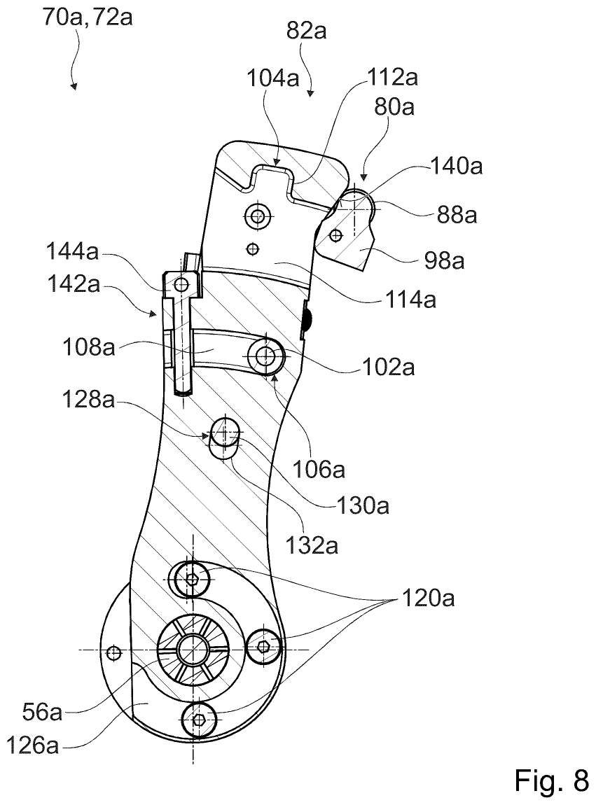

FIGS. 1 to 8 show a passenger seat device in a first exemplary embodiment. Herein the passenger seat device is part of a passenger seat 10a. The passenger seat 10a is embodied as an aircraft seat. In a mounted state, the passenger seat 10a is mounted in an aircraft cabin of an aircraft. The passenger seat 10a is configured to be fixedly mounted on a cabin floor 22a of the aircraft cabin in a mounted state. The passenger seat device comprises a mounting unit 12a. By means of the mounting unit 12a, the passenger seat 10a can be mounted on the cabin floor 22a of the aircraft cabin. The cabin floor 22a forms a mounting plane. The passenger seat 10a is realized as part of a passenger seat row 14a. The passenger seat 10a is preferably realized as part of a passenger seat row 14a comprising more than one passenger seat 10a. By way of example, the passenger seat row 14a is shown in the figures with two passenger seats 10a, 16a. The passenger seat row 14a shown by way of example comprises a second passenger seat 16a. The further passenger seat 16a is arranged so as to be neighboring the first passenger seat 10a. The second passenger seat 16a is preferably realized identically to the first passenger seat 10a; therefore only the one passenger seat 10a will be described in detail below. In principle, it is also conceivable that the passenger seat row 14a comprises three or more passenger seats 10a, 16a. Herein the mounting unit 12a is realized as a shared mounting unit 12a of the passenger seats 10a, 16a of a passenger seat row 14a. The mounting unit 12a comprises two seat bases 18a, 20a. The seat bases 18a, 20a are in each case, via fittings that are not shown in detail, coupled with fastening rails which are fixedly connected with the cabin floor 22a. The fittings can be blocked fixedly in the fastening rails.

The mounting unit 12a comprises two transverse beams 24a. The transverse beams 24a are realized as support tubes. A front transverse beam 24a is arranged in a front region of the passenger seat 10a. A rear transverse beam 24a is arranged in a rear region of the passenger seat 10a. The transverse beams 24a extend in a transverse direction of the passenger seat 10a. The transverse beams 24a extend at least substantially over an entire transverse extent of all passenger seats 10a of the passenger seat row 14a.

The passenger seat device comprises two seat structure elements 26a, 28a. The two seat structure elements 26a, 28a are in each case arranged on a respective side of a sitting area 30a of the passenger seat device. The two seat structure elements 26a, 28a are in each case arranged laterally with respect to a sitting area 30a that is formed by the passenger seat 10a. The seat structure elements 26a, 28a are realized as seat dividers. The seat structure elements 26a, 28a are arranged at the transverse beams 24a. The seat structure elements 26a, 28a are fastened to the transverse beams 24a so as to be spaced apart from one another in the transverse direction. The seat structure elements 28a are connected to the transverse beams 24a in a positionally fixed manner. The seat structure elements 28a are in each case connected to the front transverse beam 24a at their front ends. Herein the seat structure elements 26a, 28a are preferably connected to the front transverse beam 24a in a force-fitting and/or form-fitting manner. The seat structure elements 26a, 28a are realized in a substantially L-shaped manner. The seat structure elements 26a, 28a in each case comprise a first subregion which is in a mounted state oriented substantially horizontally. The seat structure elements 26a, 28a in each case comprise a second subregion which is in a mounted state oriented substantially vertically. The second subregion of the seat structure elements 26a, 28a is arranged in a rear region of the passenger seat 10a. The second subregion of the seat structure elements 26a, 28a extends as far as a rear end of the seat structure elements 26a, 28a. The second subregion of the seat structure elements 26a, 28a forms a rear region of the seat structure elements 26a, 28a. The seat structure elements 26a, 28a thus extend in their rear region upwards, away from the mounting unit 12a, in particular away from the mounting plane. The seat structure elements 26a, 28a extend in their rear region substantially as far upwards as an armrest level X. The seat structure elements 26a, 28a extend as far as an armrest level X of the passenger seat 10a. The armrest level X is 650 mm. In principle, it is preferably conceivable for the armrest level X to be in a range between 500 mm and 700 mm.

The seat structure elements 26a, 28a, which are realized as seat dividers, are configured such that different components of the corresponding passenger seat 10a, 16a are fastened to said seat structure elements 26a, 28a, as will be described at least partly in detail below. In principle, it is also conceivable that the mounting unit 12a comprises no seat structure elements 26a, 28a or differently realized seat structure elements 26a, 28a, and respective components of the passenger seat 10a, 16a are connected to the mounting unit 12a in a different manner. The passenger seat device comprises a seat bottom. The seat bottom forms the sitting area 30a. The seat bottom forms a seat surface of the passenger seat 10a. The seat bottom is connected to the mounting unit 12a.

The passenger seat device comprises a backrest 34a. The backrest 34a is configured such that a person sitting on the passenger seat 10a, of which the passenger seat device is a part, can support his/her back on the backrest 34a. The backrest 34a preferably comprises cushioning, which is not shown in detail. The backrest 34a forms a backrest support surface. The backrest 34a is arranged at a rear end of the seat bottom. The backrest 34a is arranged pivotably with respect to the mounting unit 12a. The backrest 34a is connected to the seat structure elements 26a, 28a. The passenger seat 10a herein realizes a sitting direction. The sitting direction is defined as the direction in which a passenger sits on the passenger seat 10a. The sitting direction is orthogonal to a backrest surface of the backrest 34a and extends parallel to the mounting plane in the direction of a front end of the seat bottom.

The backrest 34a is designed to be pivotable. The backrest 34a is configured for being pivoted between an upright seat position and a comfort position. The backrest 34a is configured for being pivoted relative to the mounting unit 12a. The backrest 34a is pivotable relative to the seat structure elements 26a, 28a. The backrest 34a comprises a pivotable backrest element 36a. The pivotable backrest element 36a is pivotably supported on the mounting unit 12a. The pivotable backrest element 36a is pivotably connected to the seat structure elements 26a, 28a.

The pivotable backrest element 36a comprises a backrest frame 38a. The backrest frame 38a forms a load-bearing structure of the pivotable backrest element 36a. The backrest frame 38a is realized as a circumferential frame. The backrest frame 38a is preferably realized in a substantially U-shaped manner. The backrest frame 38a has two lateral frame elements and an upper frame element, which connects the two lateral frame elements at an upper end of the backrest frame 38a. The backrest frame 38a is preferably open at a lower end. The lower end of the backrest frame 38a forms a lower end of the pivotable backrest element 36a. The pivotable backrest element 36a comprises a shell element 40a. The shell element 40a is realized as a plate-like element. The shell element 40a is made of a fiber-reinforced plastic. The shell element 40a is made, for example, of a GFRP or of a CFRP.

The shell element 40a is configured to form the backrest support surface of the pivotable backrest element 36a. The shell element 40a is arranged in an inner region of the pivotable backrest element 36a, which is spanned by the backrest frame 38a. The shell element 40a is fixedly connected with the backrest frame 38a of the pivotable backrest element 36a. The shell element 40a is at least region-wise fixedly connected with the lateral frame elements of the backrest frame 38a. The shell element 40a preferably forms a backrest contour of the pivotable backrest element 36a. The shell element 40a is configured to have a cushioning element of the backrest 34a attached on it. In principle, it would also be conceivable that the pivotable backrest element 36a comprises instead of the shell element 40a a covering which forms the backrest support surface.

The backrest frame 38a implements a load-bearing element 42a of the pivotable backrest element 36a. The load-bearing element 42a of the pivotable backrest element 36a is configured to transfer operating forces, in particular support forces acting on the pivotable backrest element 36a, into the mounting unit 12a, in particular via the seat structure elements 26a, 28a. The load-bearing element is preferably realized in a rigid manner and is configured to transmit torsional and bending forces. In principle, it would also be conceivable that the pivotable backrest element 36a does not comprise a backrest frame 38a. In this case, it would be conceivable that the entire backrest element 36a is implemented as a shell element which forms the backrest support surface and the load-bearing element 42a of the pivotable backrest element 36a integrally.

The passenger seat device comprises two bearing elements 44a, 46a for supporting the pivotable backrest element 36a. The pivotable backrest element 36a is connected to the mounting unit 12a via the bearing elements 44a, 46a. The bearing elements 44a, 46a are fixedly connected with the seat structure elements 26a, 28a. In the mounted state, the bearing elements 44a, 46a extend from the respective seat structure element 26a, 28a towards each other in the direction of the pivotable backrest element 36a. The bearing elements 44a, 46a are rigidly connected with the respective seat structure element 26a, 28a. The bearing element 44a is rigidly mounted on the lefthand seat structure element 26a. The bearing element 46a is rigidly mounted on the righthand seat structure element 28a. The bearing elements 44a, 46a are realized as fixed bearing axles. The bearing elements 44a, 46a realized as bearing axles each comprise a connecting flange 48a via which they are connected to the respective seat structure element 26a, 28a. By means of their connecting flanges 48a, the bearing elements 44a, 46a are mounted fixedly and rotationally-fixedly at the seat structure element 26a, 28a via screw connections. As a result of the connection of the bearing elements 44a, 46a via their respective connecting flanges 48a and the screw connections, an advantageous force flow from the bearing elements 44a, 46a into the seat structure elements 26a, 28a, and thus into the mounting unit 12a, is achievable. In principle, it would also be conceivable that the bearing elements 44a, 46a are rotationally-fixedly connected with the seat structure elements 26a, 28a in a different way, for example by means of a form-fitting element that is realized by the bearing elements 44a, 46a and engages in a receptacle of the respective seat structure element 26a, 28a. The bearing elements 44a, 46a are arranged at a level of a rotation axis 50a of the backrest 34a. The rotation axis 50a is the axis around which the pivotable backrest element 36a is supported pivotably. The rotation axis 50a is defined by the bearing elements 44a, 46a realized as bearing axles. The rotation axis 50a is oriented coaxially with a middle axis of the bearing elements 44a, 46a which are realized as bearing axles.

The bearing elements 44a, 46a form a glide-bearing region 52a in an end opposite the connecting flange 48a. The pivotable backrest element 36a is glidingly supported on the bearing elements 44a, 46a via the glide-bearing regions 52a of the bearing elements 44a, 46a. The backrest frame 38a, which implements the load-bearing element 42a of the pivotable backrest element 36a, is supported so as to be pivotable at the bearing elements 44a, 46a via the glide-bearing regions 52a. The glide-bearing regions 52a are realized as an axle extension 54a of the bearing elements 44a, 46a. The axle extensions 54a of the bearing elements 44a, 46a form an end region of the bearing elements 44a, 46a that faces away from the connecting flange 48a. The axle extensions 54a have, at least in the region of the glide-bearing regions 52a, a smaller diameter than the bearing elements 44a, 46a in a remaining region, in particular in a region facing towards the connecting flange 48a. The axle extension 54a is realized such that it is separable from a remaining portion of the respective bearing element 44a, 46a. The axle extension 54a is rotationally-fixedly connected to the remaining portion of the respective bearing element 44a, 46a via a spur gear toothing 56a. The axle extension 54a is secured at the remaining bearing element 44a, 46a via a screw 58a.

The axle extension 54a forms a table abutment element 60a on its side opposite the spur gear toothing 56a. In a mounted state, the table abutment element 60a is arranged on an inner side of the respective lateral frame element of the backrest frame 38a. In a mounted state, the table abutment element 60a extends radially outwards away from the rotation axis 50a on an inner side of the respective lateral frame element of the backrest frame 38a. The table abutment element 60a is configured such that a bearing arm for supporting a folding table attached to the passenger seat 10a can abut thereon in an unfolded position of the folding table, thus enabling a transfer of forces acting on the folding table into the mounting unit 12a via the bearing elements 44a, 46a.

The lateral frame elements of the backrest frame 38a each have at their lower end region a bearing receptacle 62a via which the backrest frame 38a is pivotably supported so as to be gliding on the glide-bearing regions 52a of the bearing elements 44a, 46a. The pivotable backrest element 36a in each case has a bearing bush 64a, which is arranged in the respective bearing receptacle 62a of the backrest frame 38a. In a mounted state, the bearing element 44a, 46a in each case extends with its glide-bearing region 52a through the bearing bush 64a that is arranged in the bearing receptacle 62a. For mounting, the axle extension 54a, which forms the glide-bearing region 52a of the bearing elements 44a, 46a, is guided from an inner side of the lateral frame elements of the backrest frame 38a through the bearing bush 64a in the bearing receptacle 62a and is in a rotationally fixed and loss-proof manner connected to the remaining portion of the respective bearing element 44a, 46a via the screw 58a and the spur gear toothing 56a.

The backrest 34a is designed as a backrest having a high backrest pivot point. The backrest pivot point is implemented by the rotation axis 50a. The backrest pivot point, i.e. the rotation axis 50a, is arranged above a knee region of the passenger seat 10a. The knee region of the passenger seat 10a extends, starting from the cabin floor 22a, to a level of 650 mm. The knee region is arranged as a region in which a passenger sitting behind the passenger seat 10a may arrange his knees. In order to realize the high backrest pivot point, the bearing elements 44a, 46a are connected to an upper end region of the seat structure elements 26a, 28a. The bearing elements 44a, 46a are connected to the seat structure elements 26a, 28a above the knee region. The bearing elements 44a, 46a are arranged at the armrest level X. The rotation axis 50a is arranged above the knee region of the passenger seat 10a.

The backrest 34a comprises a lower backrest element 32a. The lower backrest element 32a is realized in a rigid manner. The lower backrest element 32a is preferably realized in a non-movable manner. The lower backrest element 32a forms a lower region of the backrest 34a. The lower backrest element 32a forms the backrest support surface in the lower region of the backrest 34a. The lower backrest element 32a is fixedly fastened at the seat structure elements 26a, 28a. The lower backrest element 32a extends substantially between a level of the transverse beams 24a of the mounting unit 12a and a lower end of the pivotable backrest element 36a. The lower backrest element 32a preferably extends to just below the armrest level X.

The passenger seat device comprises a reset module 66a. The reset module 66a is configured for a resetting of the backrest 34a from the comfort position into an upright seat position. The reset module 66a is configured for a resetting of the backrest 34a from its pivoted seat position into the upright seat position. The reset module 66a is configured for a resetting of the pivotable backrest element 36a. For a resetting of the pivotable backrest element 36a, the reset module 66a is configured to provide a resetting force. For a resetting, the reset module 66a is configured to exert the resetting force onto the pivotable backrest element 36a. The reset module 66a is at least largely arranged above the knee region of the backrest 34a. As a result of this arrangement of the reset module 66a, the knee region of the backrest 34a may preferably remain substantially free of components of the reset module 66a. In particular, larger components of the reset module 66a may advantageously be arranged above the armrest level X, and thus outside the knee region of the backrest 34a.

For providing a resetting force, the reset module 66a comprises a spring element 68a. In principle, it would also be conceivable that the reset module 66a comprises several spring elements 68a in order to provide the resetting force. The spring element 68a is configured to exert a spring force onto the pivotable backrest element 36a in order to pivot it towards its upright seat position. The spring force of the spring element 68a realizes the resetting force of the reset module 66a. The spring element 68a is function-wise arranged between the pivotable backrest element 36a and the mounting unit 12a. The spring element 68a is configured to be supported on the mounting unit 12a with a first side. The spring element 68a is configured to be supported on the pivotable backrest element 36a with a second side. The spring element 68a is embodied as a leaf spring element. The spring element 68a embodied as a leaf spring element is realized as an elongate component. The spring element 68a embodied as a leaf spring element is function-wise arranged between the lower backrest element 32a and the pivotable backrest element 36a. The spring element 68a embodied as a leaf spring element is connected with its first, lower end to the lower backrest element 32a. The spring element 68a embodied as a leaf spring element is connected with its second, upper end to the pivotable backrest element 36a, in particular to the backrest frame 38a. The spring element 68a embodied as a leaf spring element preferably extends into a central region of the pivotable backrest element 36a. In principle, it would also be conceivable that the spring element 68a is realized as a different spring element, for example as a gas compression spring, as a spiral spring or as a different tension or compression spring deemed expedient by someone skilled in the art.

The passenger seat device comprises a locking device 70a. The locking device 70a is configured for a locking of the backrest 34a in its upright seat position. The locking device 70a is configured for a locking of the pivotable backrest element 36a in the upright seat position. The locking device 70a is configured for a locking of the backrest 34a in the comfort position. The locking device 70a is configured for a locking of the pivotable backrest element 36a in the comfort position. The locking device 70a is capable of locking the pivotable backrest element 36a in the comfort position and in the upright seat position. The locking device 70a has a locking state and an unlocking state. In the locking state of the locking device 70a, the backrest 34a, in particular the pivotable backrest element 36a, is locked in the current position, i.e. either the upright seat position or the comfort position. In the locking position of the locking device 70a, the pivotable backrest element 36a is fixed in a form-fitting manner in a position, i.e. the upright seat position or the comfort position. In the locking position of the locking device 70a, the pivotable backrest element 36a is fixed in a positionally fixed manner relative to the mounting unit 12a. In the locking position of the locking device 70a, the pivotable backrest element 36a is not pivotable around the rotation axis 50a of the bearing elements 44a, 46a. In the unlocking state of the locking device 70a, the backrest 34a, in particular the pivotable backrest element 36a, can be adjusted between its positions, i.e. the comfort position and the upright seat position. In the unlocking position, the locking device 70a permits a pivoting movement of the pivotable backrest element 36a between the upright seat position and the comfort position.

Preferably, the locking device 70a is configured only for locking the backrest 34a, i.e. the pivotable backrest element 36a, in the upright seat position and in the comfort position. Preferably, the locking device 70a is not configured for a stepless blocking of the pivotable backrest element 36a between the upright seat position and the comfort position: It is not possible for the pivotable backrest element 36a to be locked by the locking device 70a steplessly, i.e. fixedly positioned in intermediate positions, between the upright seat position and the comfort position. In principle, it would be conceivable that the locking device 70a is configured to lock the pivotable backrest element 36a in one or two defined intermediate positions in a form-fitting manner, wherein in such a case there would be no stepless blocking of the pivotable backrest element 36a either.

Preferably, the locking device 70a is arranged mostly above the bearing elements 44a, 46a. Herein “above the bearing elements 44a, 46a” is to mean on a side of the bearing elements 44a, 46a that faces away from the cabin floor 22a. The locking device 70a is arranged between the seat structure elements 26a, 28a and the pivotable backrest element 36a. The locking device 70a is arranged between the bearing elements 44a, 46a and the pivotable backrest element 36a. The locking device 70a is arranged at the bearing elements 44a, 46a and at the backrest frame 38a, which forms a load-bearing element 42a of the pivotable backrest element 36a. Parts of the locking device 70a may be arranged below the bearing elements 44a, 46a, in particular in the region of the connection to the bearing elements 44a, 46a. More than 75% of the locking device 70a are arranged above the bearing elements 44a, 46a. The locking device 70a is realized separately from the spring element 68a of the reset module 66a. In the exemplary embodiment described, the locking device 70a is realized so as to be spatially separate from the spring element 68a of the reset module 66a. In particular, the locking device 70a is not an integral component of the reset module 66a or of the spring element 68a. The locking device 70a is not integrated in the spring element 68a.

The locking device 70a comprises a first locking module 72a. The first locking module 72a of the locking device 70a is arranged on a lefthand side of the pivotable backrest element 36a. The first locking module 72a is arranged between the first, lefthand seat structure element 26a and the load-bearing element 42a of the pivotable backrest element 36a, which is formed by the backrest frame 38a. The first locking module 72a is arranged function-wise between the lefthand bearing element 44a and the lefthand lateral frame element of the backrest frame 38a. The first locking module 72a is with a first attachment region fixedly connected to the lefthand bearing element 44a. The first locking module 72a is with a second attachment region fixedly connected to the lateral frame element of the backrest frame 38a. The first locking module 72a is arranged on an outer side 76a of the load-bearing element 42a. The first locking module 72a is thus arranged on the outer side 76a of the lateral frame element of the backrest frame 38a. The first locking module 72a is arranged on the outer side 76a of the backrest frame 38a, which faces towards the lefthand seat structure element 26a.

The locking device 70a comprises a second locking module 74a. The second locking module 74a of the locking device 70a is arranged on a righthand side of the pivotable backrest element 36a. The second locking module 74a is arranged between the second, righthand seat structure element 28a and the load-bearing element 42a of the pivotable backrest element 36a, which is formed by the backrest frame 38a. The second locking module 74a is arranged function-wise between the righthand bearing element 46a and the righthand lateral frame element of the backrest frame 38a. The second locking module 74a is with a first attachment region fixedly connected to the righthand bearing element 46a. The second locking module 74a is with a second attachment region fixedly connected to the lateral frame element of the backrest frame 38a. The second locking module 74a is arranged on an outer side 78a of the load-bearing element 42a. The second locking module 74a is thus arranged on the outer side 78a of the lateral frame element of the backrest frame 38a. The second locking module 74a is arranged on the outer side 78a of the backrest frame 38a, which faces towards the righthand seat structure element 28a.

The two locking modules 72a, 74a are together configured for locking the backrest 34a, in particular the pivotable backrest element 36a. The two locking modules 72a, 74a of the locking device 70a are realized substantially identically. The locking modules 72a, 74a are realized substantially mirror-symmetrically to one another. Preferably, in the locking modules 72a, 74a only actuation connections or elements for transmitting an actuation force are different. The locking modules 72a, 74a have a substantially identical structure mirror-symmetrically to each other. The second locking module 74a is essentially a mirror-image of the first locking module 72a. Therefore, only the first locking module 72a will be described in detail below. The following description of the first locking module 72a can be used to explain the second locking module 74a. The differences of the second locking module 74a in comparison to the first locking module 72a will be described explicitly.

The passenger seat device comprises at least one respective cover element per locking module 72a, 74a. The cover elements are not shown in detail. The cover elements are configured to cover the locking modules 72a, 74a of the locking device 70a towards the outside. The cover elements are configured to make the locking modules 72a, 74a of the locking device 70a inaccessible for a passenger. The cover elements may preferably be realized as part of a backrest cover. Preferably, the cover elements are realized such that they are separately demountable, thus enabling a cabin personnel to easily access the locking modules 72a, 74a arranged under the cover elements if this is necessary. Preferably, the cover elements may be realized as dimensionally stable elements made of a lining material. In principle, it is also conceivable that the cover elements are made of a textile. In principle, it would be conceivable that the cover element is realized as part of a covering of the backrest 34a. The covering of the backrest 34a is preferably realized as a covering stretched over a cushioning of the backrest 34a. In a mounted state, the cover element realized as part of the covering is preferably stretched over the locking modules 72a, 74a of the locking device 70a. Preferably, in a region in which the covering forms a cover element, the covering has a closable opening through which the locking modules 72a, 74a are accessible. The closable openings in the cover elements are preferably closable by suitable means, such as for example by hook-and-loop straps, by a zip fastener or by push buttons. The locking module 72a comprises a first locking unit 80a. The first locking unit 80a is configured to be fastened at the pivotable backrest element 36a. The first locking unit 80a forms a portion of the locking module 72a facing towards the pivotable backrest element 36a. In a mounted state, the first locking unit 80a is fixedly connected with the pivotable backrest element 36a. The first locking unit 80a is connected to the load-bearing element 42a of the pivotable backrest element 36a. The first locking unit 80a is mounted on the lateral frame element of the backrest frame 38a in a loss-proof manner.

The locking module 72a comprises a second locking unit 82a. The second locking unit 82a is configured to be mounted on the bearing element 44a in a loss-proof manner. The second locking unit 82a forms a portion of the locking module 72a that faces towards the mounting unit 12a. In a mounted state, the second locking unit 82a is fixedly connected with the bearing element 44a, which is realized as a bearing axle. The second locking unit 82a is mounted on the bearing element 44a. The bearing element 44a comprises a connecting flange 84a for connecting the second locking unit 82a. The connecting flange 84a is arranged at an end region of the bearing element 44a that is situated opposite the connecting flange 48a. The second locking unit 82a is fixedly mounted on the connecting flange 84a of the bearing element 44a via several screw connections. In principle, it would also be conceivable that the first locking unit 80a of the locking module 72a is fixedly connected to the bearing element 44a and the second locking unit 82a is fixedly connected to the load-bearing element 42a of the pivotable backrest element 36a.

The first locking unit 80a and the second locking unit 82a of the locking module 72a are supported movably relative to each other. The first locking unit 80a and the second locking unit 82a are supported movably relative to each other by the connection to the pivotable backrest element 36a, respectively the bearing element 44a, by way of the pivotable backrest element 36a being borne around the rotation axis 50a. The first locking unit 80a and the second locking unit 82a are configured to be locked with each other in the upright seat position and in the comfort position in a form-fitting and/or force-fitting manner. As a result of the form-fitting and/or force-fitting coupling of the first locking unit 80a with the second locking unit 82a, the first locking module 72a is in a locking position. If the two locking modules 72a, 74a are in their locking position, the locking device 70a is in its locking position, in which it locks the pivotable backrest element 36a. In an unlocking position, the two locking units 80a, 82a are not connected to each other in a force-fitting and/or form-fitting manner. In the unlocking position of the locking module 72a, the two locking units 80a, 82a are movable relative to each other. If the two locking modules 72a, 74a are in their unlocking position, the locking device 70a is in its unlocking position.

The first locking unit 80a has a base body 86a. The base body 86a of the first locking unit 80a is attached to the load-bearing element 42a of the pivotable backrest element 36a. The base body 86a is fixedly mounted on the lateral frame element of the backrest frame 38a. The base body 86a is preferably screwed with the pivotable backrest element 36a. The base body 86a forms a U-shaped receiving region with which the base body 86a at least partly encompasses the backrest frame 38a. The first locking unit 80a comprises a blocking element 88a, which is spring-loaded and is adjustable between a locking position and a release position. The blocking element 88a is configured for a form-fitting connection to the second locking unit 82a. The blocking element 88a extends away from the backrest frame 38a.

The first locking unit 80a comprises a linear guidance 94a, via which the blocking element 88a is supported so as to be linearly displaceable. The linear guidance 94a comprises a linear-bearing rail 96a. The linear bearing rail 96a is realized by the base body 86a. The linear bearing rail 96a forms a displacement path of the linear guidance 94a. In a mounted state, the displacement path of the linear guidance 94a preferably extends parallel to the lateral frame element of the backrest frame 38a. The linear guidance 94a comprises a bearing slide 98a. The bearing slide 98a is supported on the linear bearing rail 96a so as to be displaceable along the displacement path. The bearing slide 98a is connected to the linear bearing rail 96a in a form-fitting manner. The linear guidance 94a is spring-loaded. The locking unit 80a comprises a spring element 100a, which is configured to exert a spring force onto the bearing slide 98a of the linear guidance 94a, the spring force being oriented towards a first position of the bearing slide 98a. The first position is realized as a locking position. The spring element 100a is realized as a compression spring. The spring element 100a is realized as a spiral spring. The spring element 100a is attached between the base body 86a and the bearing slide 98a. The bearing slide 98a is displaceable, counter to the spring force of the spring element 100a, along the linear bearing rail 96a from its first position into a second position. The second position of the bearing slide 98a is realized as a release position.

The blocking element 88a is realized as a rotatably supported blocking roller. The blocking element 88a that is realized as a blocking roller is rotatably connected to the bearing slide 98a. The bearing slide 98a comprises a bearing pin 90a, on which the blocking element 88a realized as a blocking roller is rotatably supported so as to be gliding. The bearing pin 90a is preferably realized integrally with the bearing slide 98a. The blocking element 88a that is realized as a blocking roller is safeguarded at the bearing slide 98a by means of a screw 92a on the bearing pin 90a. For a safeguarding of the blocking element 88a, the screw 92a is screwed into the bearing slide 98a and bears with its screw head against an axial side of the blocking element 88a, thus safeguarding the blocking element 88a on the bearing pin 90a in a form-fitting manner. The blocking element 88a is arranged laterally at the bearing slide 98a. As a result of the displacement of the bearing slide 98a between its first position and its second position, the blocking element 88a is supported so as to be displaceable between a locking position and a release position. In a non-actuated state, the blocking element 88a is pressed into its locking position by the spring element 100a. In an actuated state, the blocking element 88a is adjusted, counter to the spring force of the spring element 100a, from its locking position into its release position.

The blocking element 88a is configured for a locking of the pivotable backrest element 36a in the upright seat position. The blocking element 88a locks the pivotable backrest element 36a in the upright seat position in a form-fitting manner. In the upright seat position of the pivotable backrest element 36a, the blocking element 88a is configured to be coupled with the second locking unit 82a in a form-fitting manner.

The first locking unit 80a comprises a second blocking element 102a. The second blocking element 102a is configured for a locking of the pivotable backrest element 36a in the comfort position. The second blocking element 102a is realized as a blocking bolt. The second blocking element 102a is arranged at the base body 86a of the first locking unit 80a in a positionally fixed manner. The second blocking element 102a is arranged on a side surface of the base body 86a. The second blocking element 102a is arranged on the same side as the first blocking element 88a. The second blocking element 102a is preferably arranged below the first blocking element 88a. The second blocking element 102a is configured for a locking of the locking module 72a in the comfort position of the pivotable backrest element 36a. The second blocking element 102a is configured, in the comfort position, to bear against an end abutment of the second locking unit 82a in a form-fitting manner. The second blocking element 102a locks the pivotable backrest element 36a in the comfort position against a further adjustment to the rear.

The second locking unit 82a comprises a first form-fitting element 104a. The first form-fitting element 104a is configured for a locking of the pivotable backrest element 36a in the upright seat position. The first form-fitting element 104a is configured for a coupling with the first blocking element 88a of the first locking unit 80a, which is supported movably. For the locking of the pivotable backrest element 36a in the upright seat position, the first form-fitting element 104a of the second locking unit 82a is configured to fix the blocking element 88a of the first locking unit 80a in a form-fitting and/or force-fitting manner. The first form-fitting element 104a is realized as a depression in which the first blocking element 88a can engage in its locking position in a form-fitting manner.

The second locking unit 82a comprises a second form-fitting element 106a. The second form-fitting element 106a is configured for a locking of the pivotable backrest element 36a in the comfort position. The second form-fitting element 106a is configured for a coupling with the second blocking element 102a of the first locking unit 80a, which is supported non-movably. For the locking of the backrest element 36a in the comfort position, the second form-fitting element 106a of the second locking unit 82a is configured to fix the blocking element 88a of the first locking unit 80a in a form-fitting manner. The second form-fitting element 106a forms an end abutment for the pivotable backrest element 36a. The second form-fitting element 106a is realized as the end of a groove 108a. In a mounted state, the second blocking element 102a is arranged in the groove 108a in the comfort position and in the upright seat position.

The second locking unit 82a has a base body 110a. The base body 110a is realized as a flat, elongate body. The base body 110a is preferably made of a light metal. In principle, it would also be conceivable that the base body 110a is made of a different material, for example a plastic. The base body 110a forms the first form-fitting element 104a of the second locking unit 82a. The first form-fitting element 104a is realized as a depression 112a in a groove 114a of the base body 110a. The groove 114a is realized as a through-groove extending from a front end of the base body 110a to a rear end of the base body 110a. The groove 114a is introduced at an inner side 116a of the base body 110a. In a mounted state, the inner side 116a faces towards the backrest frame 38a. The depression 112a, which implements the first form-fitting element 104a, is introduced in a side wall of the groove 114a. The base body 110a forms the second form-fitting element 106a of the second locking unit 82a. The groove 108a, which forms the second form-fitting element 106a, is introduced in the inner side 116a of the base body 110a. The groove 108a has a curved course. The groove 108a is open towards a front side of the base body 110a. An end of the groove 108a which faces away from an opening arranged on the front side forms the form-fitting element 106a against which the second blocking element 102a abuts in the comfort position.

The second locking unit 82a comprises an attachment element 118a. In a normal operation state, the attachment element 118a is connected to the bearing element 44a in a rotationally fixed manner. The base body 110a of the second locking unit 82a is connected to the attachment element 118a via its form-fitting elements 104a, 106a. In the mounted state, the base body 110a of the second locking unit 82a is mounted at the attachment element 118a in a loss-proof manner. In a mounted state, the base body 110a preferably bears with its outer side against an inner side of the attachment element 118a. The attachment element 118a is rigidly connected to the bearing element 44a by means of several screws 120a. The attachment element 118a is connected to the connecting flange 84a of the bearing element 44a via the screws 120a in a rotationally fixed manner. The attachment element 118a has through holes 122a which the screws 120a are guided through. Preferably, the connecting flange 84a has several threaded holes 124a which the screws 120a can be screwed into. In principle, a connection by means of nuts is also conceivable. For the connection, the screws 120a are guided from a side that faces away from the bearing element 44a through the through holes 122a in the attachment element 118a. In the mounted state, the screw heads of the screws 120a are arranged on the side of the attachment element 118a that faces towards the base body 110a. The base body 110a of the second locking unit 82a has on its outer side an annular groove 126a in which the screw heads of the screws 120a are arranged in the mounted state. The annular groove 126a is open towards a front end of the base body 110a.

The second locking unit 82a comprises an eccentric adjusting unit 128a. By means of the eccentric adjusting unit 128a, a position of the form-fitting elements 104a, 106a is adjustable relative to the first locking unit 80a. The eccentric adjusting unit 128a is configured to change a position of the attachment element 118a relative to the base body 110a. The base body 110a of the second locking unit 82a is connected to the attachment element 118a via the eccentric adjusting unit 128a. An angle of the base body 110a relative to the attachment element 118a can be changed via the eccentric adjusting unit 128a. The eccentric adjusting unit 128a comprises a connecting screw 130a via which the base body 110a is connected to the attachment element 118a. The base body 110a has an elongate through hole 132a. The through hole 132a extends from an inner side to an outer side of the base body 110a. The through hole 132a has a width which is somewhat larger than the diameter of the threaded shank of the connecting screw 130a. The through hole 132a is realized as a long hole. The length of the through hole 132a is preferably by at least 5% larger than the diameter of the threaded shank of the connecting screw 130a. The through hole 132a has a counterbore 134a, which is larger than the screw head of the connecting screw 130a. In the mounted state, the screw head of the connecting screw 130a is arranged completely in the counterbore 134a of the through hole 132a. The eccentric adjusting unit 128a comprises an eccentric element 136a. The eccentric adjusting unit 128a is connected to the attachment element 118a. The attachment element 118a has a round receptacle in which the eccentric element 136a is arranged in a loss-proof and rotatable manner. The eccentric element 136a has an out-of-center through hole 138a. In the mounted state, the connecting screw 130a is guided through the out-of-center through hole 138a. The eccentric adjusting unit 128a comprises a nut 146a by which the connecting screw 130a is connected to the eccentric element 136a. When the base body 110a is mounted at the attachment element 118a, the position of the out-of-center through hole 138a relative to the base body 110a can be changed by rotating the eccentric element 136a in the receptacle of the attachment element 118a. This allows, during the mounting, an adaption of an angle of the first base body 110a relative to the attachment element 118a, i.e. also to the bearing element 44a. As a result, it is in particular possible to adjust the locking position for the pivotable backrest element 36a in the comfort position during the mounting.

The second locking unit 82a comprises an abutment surface 140a. The abutment surface 140a is configured such that the first blocking element 88a of the first locking unit 80a bears against the abutment surface 140a in the comfort position of the pivotable backrest element 36a. The abutment surface 140a implements the abutment for the blocking element 88a in the direction of the upright seat position. In the comfort position of the pivotable backrest element 36a, the abutment surface 140a is, in the locking position of the first blocking element 88a, in a form-fitting contact with the blocking element 88a and blocks a rotation of the pivotable backrest element 36a towards the upright seat position. The abutment surface 140a is realized as an inclined surface via which the blocking element 88a can be pressed out of its locking position into a release position. If in the comfort position a force directed towards the upright seat position is exerted on the pivotable backrest element 36a, the blocking element 88a is pressed into its release position and the pivotable backrest element 36a can be pressed into its upright seat position and be locked there.

The first locking module 72a comprises a release unit 142a. The release unit 142a is configured, in a release position, to undo a coupling between the first locking unit 80a and the second locking unit 82a in order to enable pivoting of the pivotable backrest element 36a forwards, beyond the upright seat position into a non-use position. The release unit 142a comprises a locking element 144a. The locking element 144a is configured, in a locking position, to lock the groove 114a, which forms the second form-fitting element 106a, at the open front end. The locking element 144a is embodied as a locking bolt. In the mounted state, the locking element 144a closes the groove 114a towards the front. The second blocking element 102a, which is arranged in the groove 114a, cannot be guided out of the groove 114a. The release unit 142a has a receiving hole, in which the locking element 144a can be arranged. In a mounted state, i.e. in a locking position, the locking element 144a is arranged in the receiving hole. Herein the locking element 144a extends into the groove 114a and blocks it. The receiving hole in which the locking element 144a is arranged extends transversely to the groove 114a. In a release position of the release unit 142a, the locking element 144a is guided out of the groove 114a and releases a path for the blocking element 102a out of the groove 114a. As a result, the pivotable backrest element 36a can be folded frontwards out of the upright seat position if the first blocking element 88a is in its unlocking position, too. Herein the pivotable backrest element 36a can be folded onto the seat bottom into a non-use position.

The passenger seat device comprises an actuating element for the locking device 70a. The actuating element is not shown in detail. The actuating element is configured to exert an actuation force onto the locking device 70a in order to move the locking device 70a from its locking position into its unlocking position. The actuating element is preferably realized as a push button. The actuating element realized as a push button may be arranged, for example, in an armrest of the passenger seat 10a. The passenger seat device comprises a Bowden cable 150a. The Bowden cable 150a is a transmission element configured to transmit an actuation force and an actuation movement from the actuating element to the locking device 70a. In principle, it would also be conceivable that the passenger seat device comprises a different force transmission element for transmitting the actuation force. The Bowden cable 150a is connected to the spring-loaded bearing slide 98a of the linear guidance 94a. The Bowden cable 150a is configured, when actuated by the actuating element, to pull the bearing slide 98a counter to the spring force of the spring element 100a, out of its locking position into its unlocking position. As a result, the first locking module 72a of the locking device 70a can be switched from the locking position into the unlocking position. The second locking module 74a is preferably actuatable together with the first locking module 72a via the Bowden cable 150a. The first locking module 72a comprises a force transmission unit 152a, which transfers an actuation force exerted by the Bowden cable 150a onto the first locking module 72a. The passenger seat device comprises a second Bowden cable 154a. The second Bowden cable 154a is configured to transmit an actuation force from the first locking module 72a to the second locking module 74a. The second locking module 74a is connected in series with the first locking module 72a via the second Bowden cable 154a. The actuation movement of the bearing slide 98a is transmitted to the second Bowden cable 154a by the force transmission unit 152a. The force transmission unit 152a may preferably convert a linear movement of the bearing slide 98a directly into an actuation of the second Bowden cable 154a. In principle, it would also be conceivable that the force transmission to the second Bowden cable 154a comprises at least one lever.

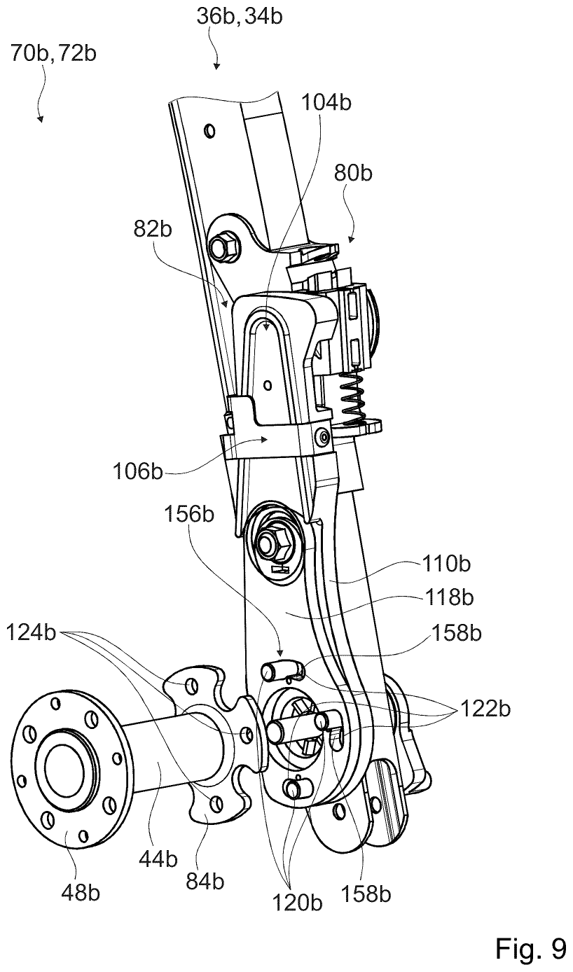

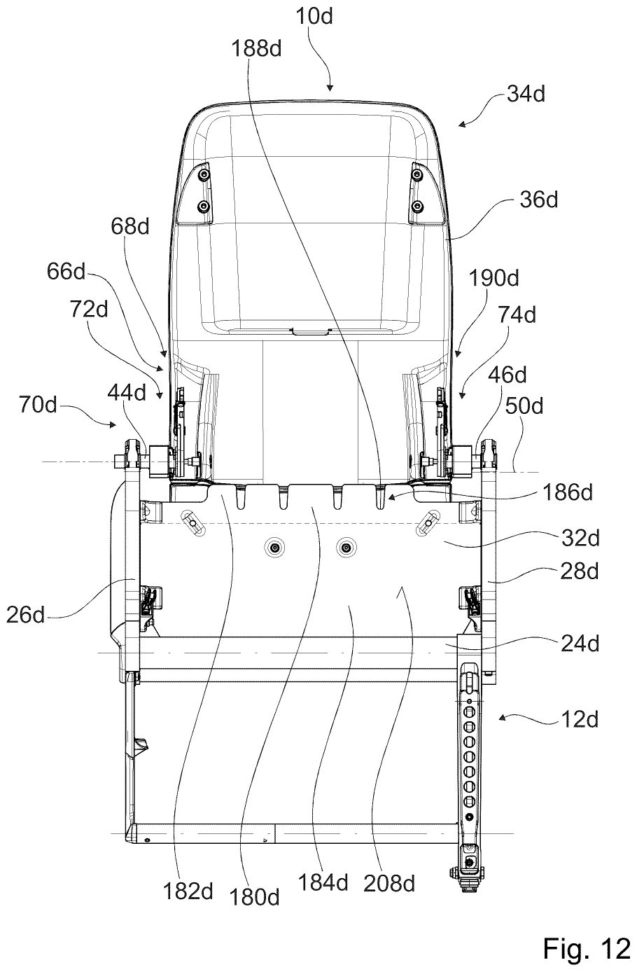

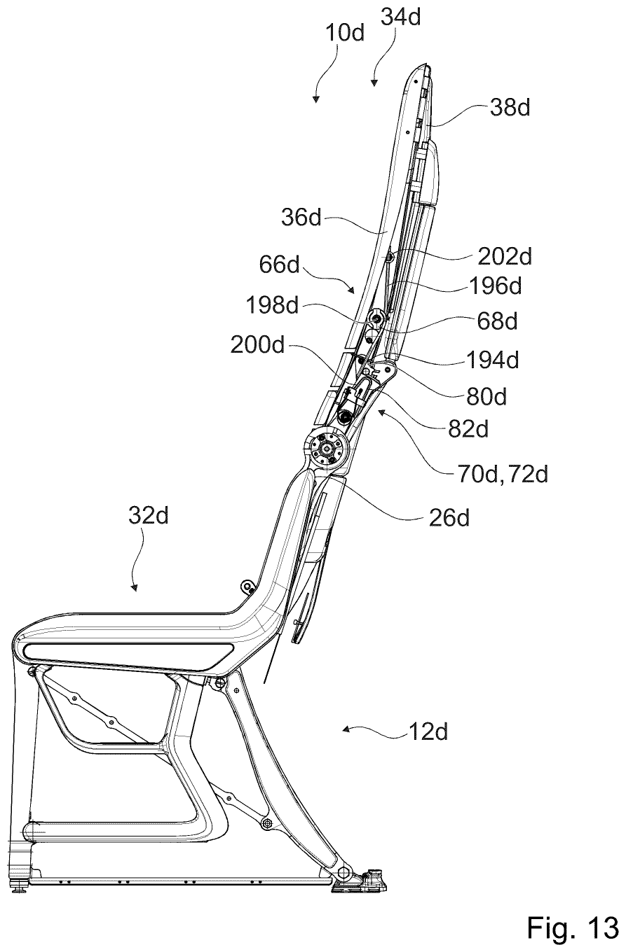

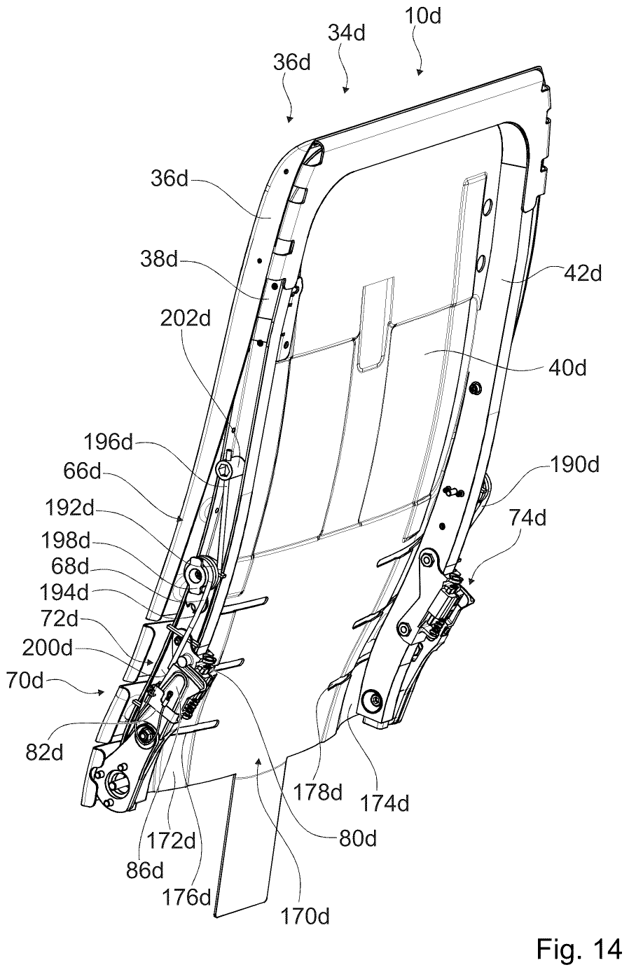

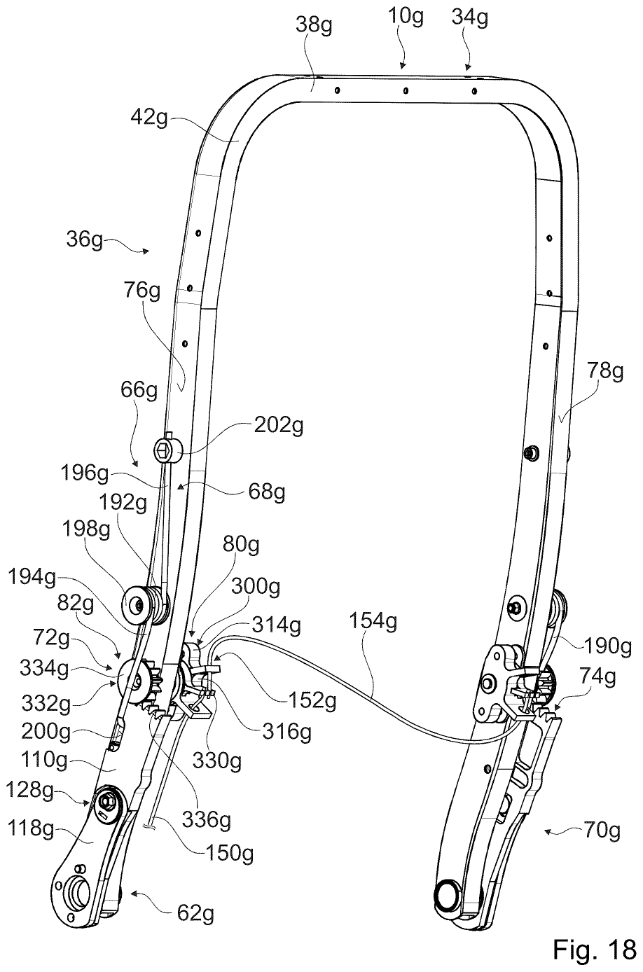

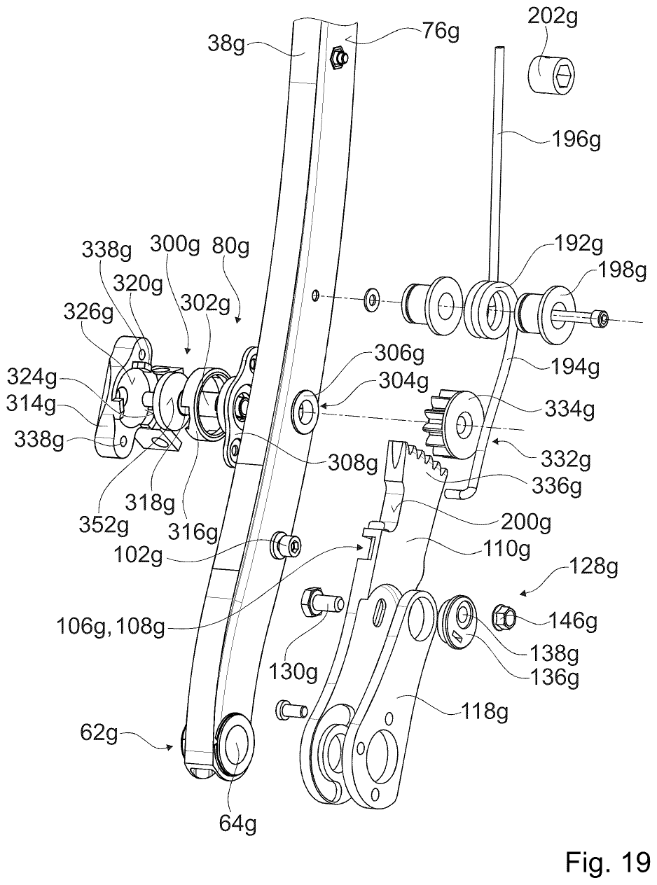

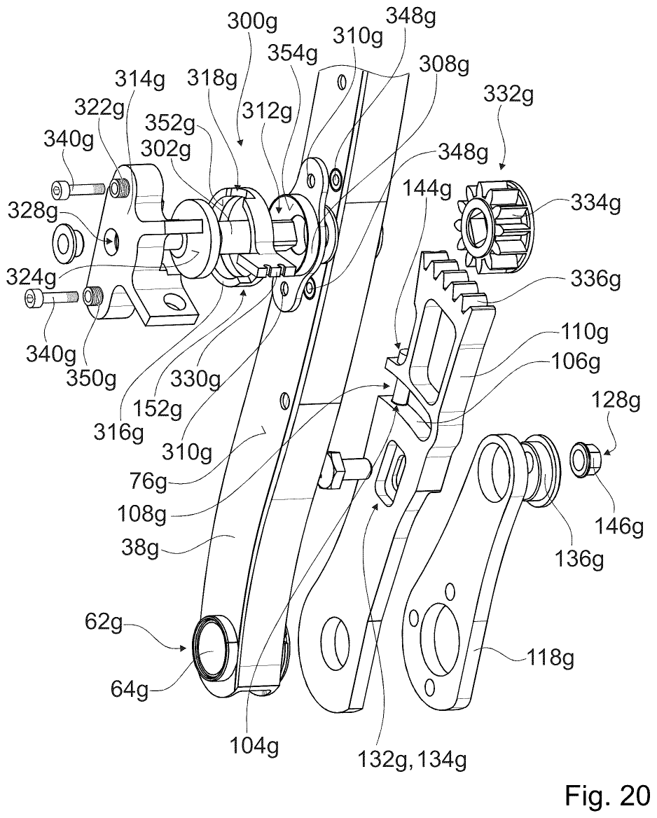

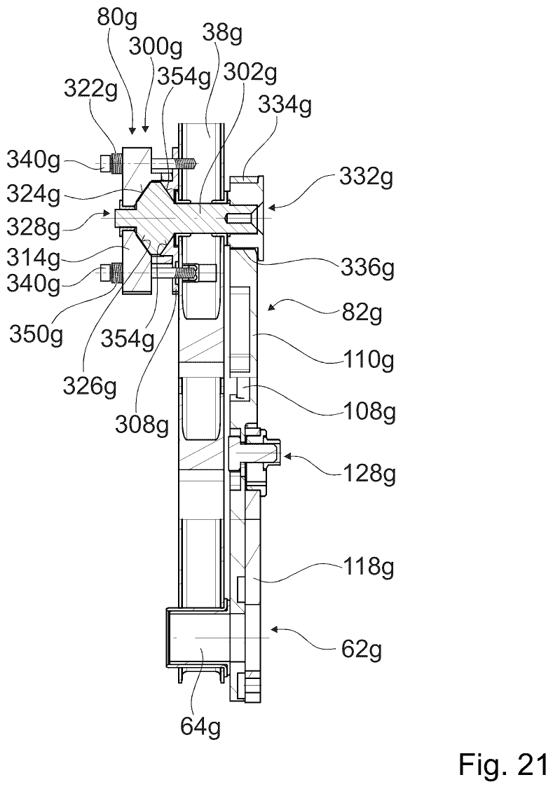

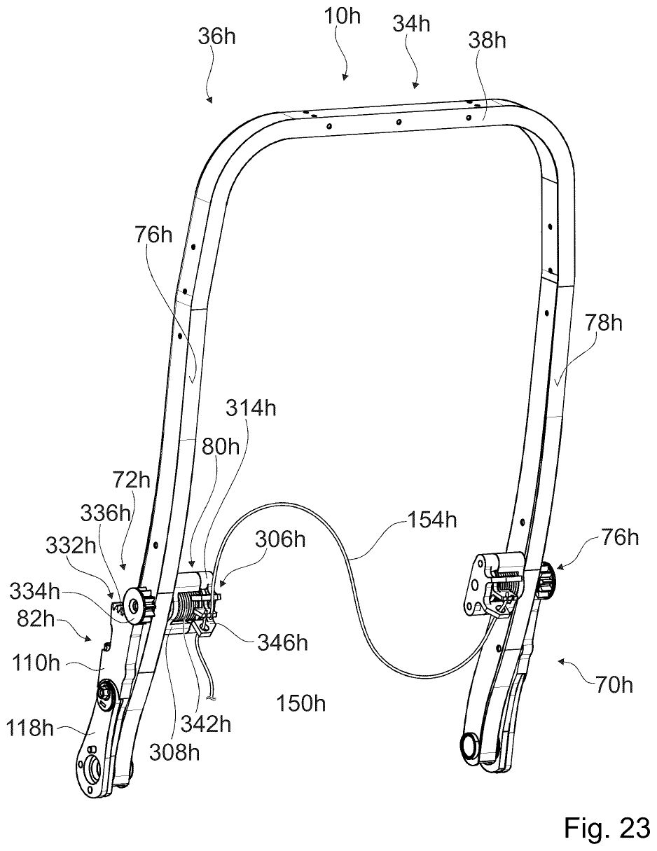

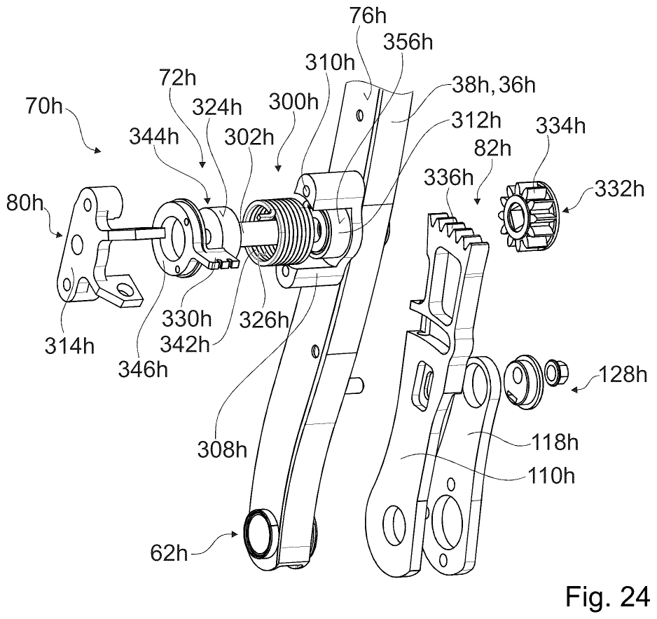

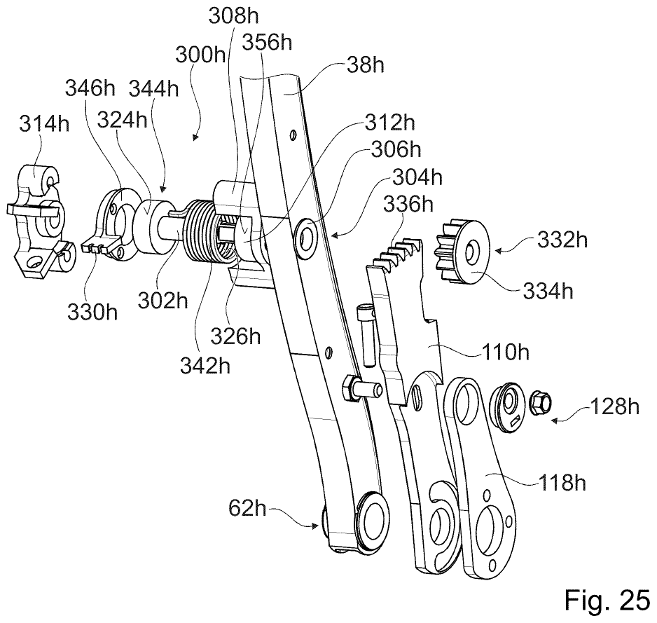

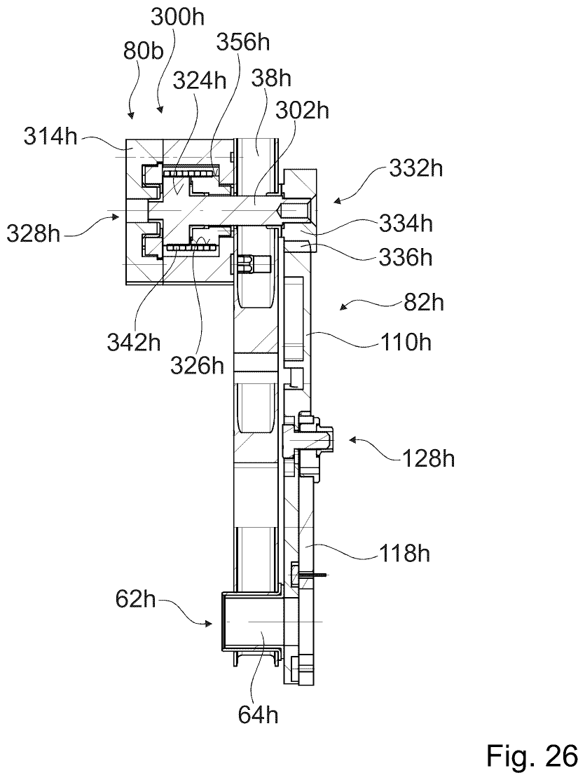

In FIGS. 9 to 26 seven further exemplary embodiments of the invention are shown. The following descriptions and the drawings are essentially limited to the differences between the exemplary embodiments, wherein with respect to components having the same denomination, in particular with respect to components having the same reference numerals, in principle reference may also be made to the drawings and/or the description of the other exemplary embodiments, in particular of FIGS. 1 to 8. To distinguish between the exemplary embodiments, the letter a has been added to the reference numerals of the exemplary embodiment in FIGS. 1 to 8. In the exemplary embodiments of FIGS. 9 to 26, the letter a has been replaced by the letters b to h.

FIG. 9 shows a second exemplary embodiment of a portion of a passenger seat device according to the invention. The passenger seat device comprises a backrest 34b. The backrest 34b is designed to be pivotable. The backrest 34b is configured for being pivoted between an upright seat position and a comfort position. The backrest 34b comprises a pivotable backrest element 36b. The pivotable backrest element 36b is supported pivotably on a mounting unit. The pivotable backrest element 36b comprises a backrest frame 38b. The backrest frame 38b realizes a load-bearing structure of the pivotable backrest element 36b. The backrest frame 38b realizes a load-bearing element of the pivotable backrest element 36b. The passenger seat device is realized substantially identically to the first exemplary embodiment.

The passenger seat device comprises a locking device 70b. The locking device 70b is configured for a locking of the backrest 34b in its upright seat position and in the comfort position. The locking device 70b has a locking state and an unlocking state. The locking device 70b comprises a first locking module 72b and a second locking module. The two locking modules 72b are together configured for a locking of the backrest 34b, in particular of the pivotable backrest element 36b. The first locking module 72b is fixedly connected to a lefthand bearing element 44b via a first connection region.

The locking module 72b comprises a first locking unit 80b. The first locking unit 80b is configured to be fastened at the pivotable backrest element 36b. The first locking unit 80b is realized identically to the first exemplary embodiment.

The locking module 72b comprises a second locking unit 82b. The second locking unit 82b is configured to be mounted on the bearing element 44b in a loss-proof manner. The second locking unit 82b constitutes a portion of the locking module 72b that faces towards a mounting unit 12b of the passenger seat. In a mounted state, the second locking unit 82b is fixedly connected to the bearing element 44b, which is realized as a bearing axle. The second locking unit 82b is mounted on the bearing element 44b. The bearing element 44b comprises a connecting flange 84b for connecting the second locking unit 82b. The connecting flange 84b is arranged at an end region of the bearing element 44b that is situated opposite a connecting flange 48b. The second locking unit has a base body 110b. The base body 110b is realized as a flat, elongate body. The second locking unit 82b comprises an attachment element 118b. The base body 110b of the second locking unit 82b is connected to the attachment element 118b by its form-fitting elements 104b, 106b. In a normal operation state, the attachment element 118b is connected to the bearing element 44b in a rotationally fixed manner.

Furthermore, in contrast to the first exemplary embodiment, the locking modules 72b, 74b each comprise an overload unit 156b. The second locking unit 82b of the locking module 72b comprises the overload unit 156b. The overload unit 156b is configured to permit, in the event of an overload, a relative movement between the attachment element 118b of the second locking unit 82b and a bearing element 44b. The overload unit 156b is arranged in the connection between the attachment element 118b of the second locking unit 82b and the bearing element 44b, in particular the connecting flange 84b. The attachment element 118b is connected to the bearing element 44b by means of several screws 120b. In a normal operation state, the attachment element 118b is connected to the connecting flange 84b of the bearing element 44b via the screws 120b in a rotationally fixed manner. In contrast to the first exemplary embodiment, through holes 122b in the attachment element 118b are realized as curved long holes. The through holes 122b have a curved course, with a center point situated in the rotation axis of the pivotable backrest element 36b. The overload unit 156b is integrated in the through holes 122b. The overload unit 156b comprises one deformation element 158b per through hole. The deformation elements 158b are realized as taperings of the through holes 122b. In a normal operation state, the deformation elements 158b realized as taperings hold the screws 120b in a defined position at an edge of the through holes 122b. In the normal operation state, the screws 120b are arranged in a positionally fixed manner in the through holes 122b realized as long holes. As a result, in the normal operation state, the attachment element 118b and the connecting flange 84b of the bearing element 44b are connected to one another in a rotationally fixed manner. In the event of an overload, for example in the event of a crash, in which forces act on the pivotable backrest element 36b frontwards, the deformation elements 158b are deformed by the screws 120b, and the screws 120b can be displaced in the through hole 122b that is realized as a curved long hole. As a result of the displacement of the screws 120b in the through holes 122b, a rotation of the attachment element 118b relative to the connecting flange 84b of the bearing element 44b is brought about. As a result, the overload unit 156b permits a rotation of the pivotable backrest element 36b by a defined angle in the event of an overload. Herein the defined angle is given by the extent of the through holes 122b which are realized as curved long holes and through which the screws 120b extend.

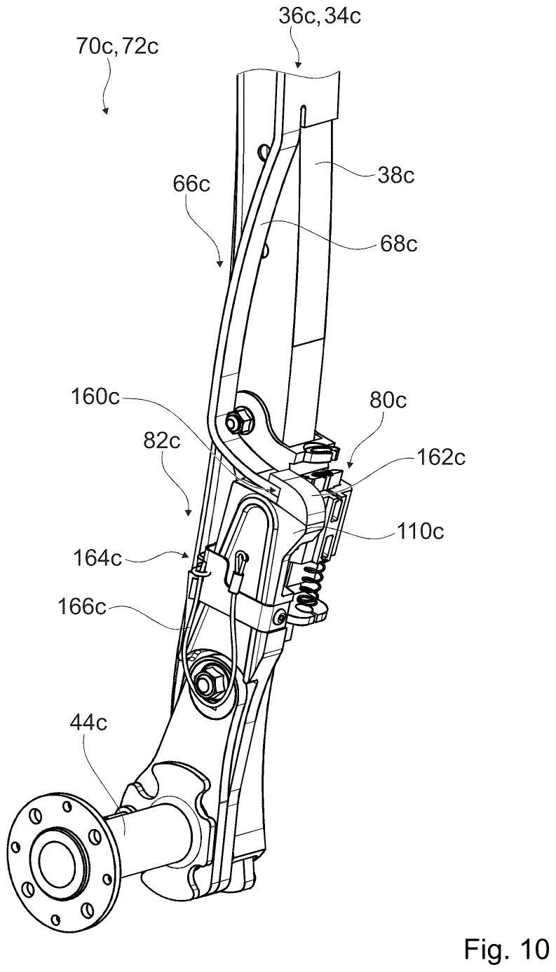

FIG. 10 shows a third exemplary embodiment of a portion of a passenger seat device according to the invention. The passenger seat device comprises a backrest 34c. The backrest 34c is designed to be pivotable. The backrest 34c is configured for being pivoted between an upright seat position and a comfort position. The backrest 34c comprises a pivotable backrest element 36c. The pivotable backrest element 36c is supported pivotably on a mounting unit. The pivotable backrest element 36c comprises a backrest frame 38c. The backrest frame 38c forms a load-bearing structure of the pivotable backrest element 36c. The backrest frame 38c forms a load-bearing element 42c of the pivotable backrest element 36c. The passenger seat device is realized substantially identically to the first exemplary embodiment.

The passenger seat device comprises a locking device 70c. The locking device 70c is configured for a locking of the backrest 34c in its upright seat position and in the comfort position. The locking device 70c has a locking state and an unlocking state. The locking device 70c comprises a first locking module 72c and a second locking module. The two locking modules 72c are together configured for a locking of the backrest 34c, in particular of the pivotable backrest element 36c. The first locking module 72c is with a first attachment region fixedly connected to a lefthand bearing element 44c.

The locking module 72c comprises a first locking unit 80c. The first locking unit 80c is configured to be fastened at the pivotable backrest element 36c. The first locking unit 80c is realized identically to the first exemplary embodiment.

The locking module 72c comprises a second locking unit 82c. The second locking unit 82c is configured to be mounted on the bearing element 44c in a loss-proof manner. The second locking unit 82c constitutes a portion of the locking module 72c that faces towards a mounting unit 12c of the passenger seat device. In a mounted state, the second locking unit 82c is fixedly connected with the bearing element 44c, which is realized as a bearing axle. The second locking unit 82c is mounted on the bearing element 44c. The bearing element 44c comprises a connecting flange 84c for connecting the second locking unit 82c. The connecting flange 84c is arranged at an end region of the bearing element 44c that is situated opposite a connecting flange 48c. The second locking unit 82c has a base body 110c. The base body 110c is realized as a flat, elongate body. The second locking unit 82c comprises an attachment element 118c. The base body 110c of the second locking unit 82c is connected to the attachment element 118c via its form-fitting elements 104c, 106c. In a normal operation state, the attachment element 118c is connected to the bearing element 44c in a rotationally fixed manner.

The passenger seat device comprises a reset module 66c. The reset module 66c is configured for a restoring of the backrest 34c from the comfort position into an upright seat position. The reset module 66c is configured for a restoring of the pivotable backrest element 36c. The reset module 66c is configured to provide a resetting force for a restoring of the pivotable backrest element 36c. The reset module 66c is arranged above the knee region of the backrest 34c. As a result of this arrangement of the reset module 66c, the knee region of the backrest 34c may preferably remain free of components of the reset module 66c.

The reset module 66c comprises a spring element 68c for providing a resetting force. The spring element 68c is configured to exert a spring force onto the pivotable backrest element 36c in order to pivot the pivotable backrest element 36c towards its upright seat position. The spring element 68c is function-wise arranged between the pivotable backrest element 36c and the mounting unit 12c. In contrast to the first exemplary embodiment, the spring element 68c is function-wise arranged between the pivotable backrest element 36c and the second locking unit 82c of the locking module 72c. The spring element 68c is configured to be supported on the pivotable backrest element 36c with its second side. The spring element 68c is realized as a leaf spring element. The spring element 68c that is embodied as a leaf spring element is realized as an elongate component. The spring element 68c that is embodied as a leaf spring element is realized as a narrow element. The spring element 68c that is embodied as a leaf spring element has a width which is smaller than a width of a backrest frame 38c of the pivotable backrest element 36c. The width of the spring element 68c that is embodied as a leaf spring element substantially corresponds to the width of the base body 110c of the second locking unit 82c.

The spring element 68c that is embodied as a leaf spring element is connected with its first, lower end to the base body 110c of the second locking unit 82c. The spring element 68c is supported with its lower end on the base body 110c of the second locking unit 82c. Preferably, the spring element 68c is with its lower end coupled to the base body 110c. The base body 110c of the second locking unit 82c comprises a receptacle 160c, which is configured to receive the spring element 68c. In a mounted state, the spring element 68c is supported at the receptacle 160c of the base body 110c. The receptacle 160c is realized as a form-fitting element. The spring element 68c that is embodied as a leaf spring element is arranged with its first, lower end in a form-fitting manner in the receptacle 160c that is realized as a form-fitting element. The receptacle 160c forms an undercut. The base body 110c comprises an elevation 162c on its upper side. The elevation 162c is arranged at a rear end of the base body 110c. The elevation 162c forms the receptacle 160c. In principle, it would also be conceivable that the receptacle 160c for the spring element 68c, which is embodied as a leaf spring element, is introduced in the base body 110c in an upper region of the base body 110c. The spring element 68c is advantageously connected, in a positionally secure manner, to the base body 110c of the second locking unit 82c by the receptacle 160c. Despite this, the spring element 68c is here realized separately from the locking device 70c, as a separate element. In principle, it is also conceivable that the spring element 68c is supported only at the upper side or at a front side surface of the base body 110c. The spring element 68c that is embodied as a leaf spring element is connected with its second, upper end to the pivotable backrest element 36c, in particular to the backrest frame 38c. The spring element 68c that is embodied as a leaf spring element preferably extends into a central region of the pivotable backrest element 36c. The spring element 68c that is embodied as a leaf spring element forms at its second upper end an attachment region. The spring element 68c is preferably directly connected to the backrest frame 38c via the attachment region. For example, the spring element 68c may be fixedly connected directly to the backrest frame 38c in the attachment region via screw connections. Preferably, the reset module 66c comprises a second spring element that is embodied as a leaf spring element. Herein the second spring element is arranged on a side of the backrest frame 38c that is situated opposite the first spring element 68c. The second spring element is not shown in detail and is arranged between the backrest frame 38c and the second locking module 74c. A functionality of the reset module 66c and of the locking device 70c is identical to the preceding exemplary embodiments and will therefore not be described in detail again here.

The first locking module 72c comprises a release unit 142c. The release unit 142c is configured, in a release position, to undo a coupling between the first locking unit 80c and the second locking unit 82c in order to enable a frontward pivoting of the pivotable backrest element 36c beyond the upright seat position into a non-use position. The release unit 142c comprises a locking element 144c. The locking element 144c is configured, in a locking position, to lock the groove that forms the second form-fitting element 106c at the open front end. The release unit 142c is realized substantially identically to the first exemplary embodiment.

The release unit 142c comprises a safeguarding device 164c. The safeguarding device 164c is configured for a safeguarding of the locking element 144c at the locking module 72c. The safeguarding device 164c is configured such that the locking element 144c—even in its release position, in which the locking element 144c has been moved out of its receiving hole—is arranged in a loss-proof manner at the first locking module 72c, in particular at the second locking unit 82c. The safeguarding device 164c comprises a safeguarding element 166c. The safeguarding element 166c is connected to the base body 110c of the second locking unit 82c and to the locking element 144c. The safeguarding element 166c is realized as a safeguarding wire. In principle, it would also be conceivable that the safeguarding element 166c is realized as a safeguarding cord. The safeguarding element 166c is connected with its first end to the base body 110c and with its second end to the locking element 144c. If the locking element 144c is released from the receiving hole, it is secured at the base body 110c via the safeguarding element 166c. The locking element 144c is suspended at the second locking unit 82c via the safeguarding element 166c. Because of this, the locking element 144c advantageously cannot be lost when not in use.

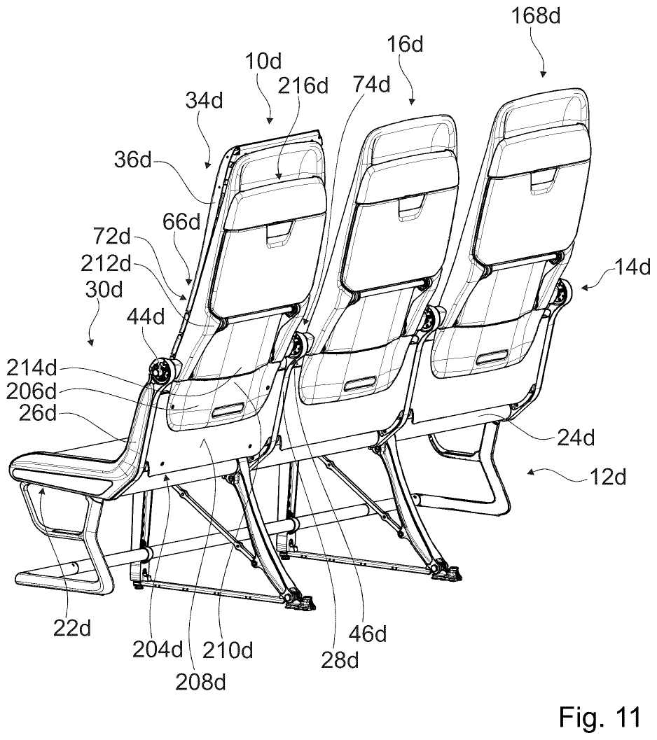

FIGS. 11 to 14 show a fourth exemplary embodiment of a passenger seat device according to the invention. Herein the passenger seat device is part of a passenger seat 10d. In a mounted state, the passenger seat 10d is mounted in an aircraft cabin of an aircraft. The passenger seat device comprises a mounting unit 12d. The passenger seat 10d can be mounted on the cabin floor of the aircraft cabin by means of the mounting unit 12d. The passenger seat 10d is preferably realized as part of a passenger seat row 14d which comprises more than one passenger seat 10d. By way of example, in the figures the passenger seat row 14d is shown comprising three passenger seats 10d, 16d, 168d. The passenger seat row 14d shown by way of example comprises a second passenger seat 16d and a third passenger seat 168d. The second passenger seat 16d is realized as a middle seat of the passenger seat row 14d and is arranged between the two other passenger seats 16d, 168d. The further passenger seats 16d, 168d of the passenger seat row 14d are preferably realized substantially identically to the first passenger seat 10d; therefore only the one passenger seat 10d will be described in detail below.

The mounting unit 12d comprises two transverse beams 24d. The transverse beams 24d are realized as support tubes. The transverse beams 24d extend at least substantially over an entire transverse extent of all passenger seats 10d, 16d, 168d of the passenger seat row 14d. The passenger seat device comprises two seat structure elements 26d, 28d. The two seat structure elements 26d, 28d are in each case arranged on a respective side of a sitting area 30d of the passenger seat device. The two seat structure elements 26d, 28d are in each case arranged laterally with respect to a sitting area 30d that is formed by the passenger seat 10d. The seat structure elements 26d, 28d are realized as seat dividers. The seat structure elements 26d, 28d, which are realized as seat dividers, are configured such that different components of the respective passenger seat 10d, 16d, 168d are fastened to said seat structure elements 26d, 28d. The seat structure elements 26d, 28d thus extend in their rear region upwards, away from the mounting unit 12d, in particular away from the mounting plane. The seat structure elements 26d, 28d extend in their rear region substantially as far upwards as an armrest level X. The seat structure elements 26d, 28d extend up to an armrest level X of the passenger seat 10d.

The passenger seat device comprises a backrest 34d. The backrest 34d is configured such that a person sitting on the passenger seat 10d, of which the passenger seat device is a part, can support his/her back on the backrest 34d. The backrest 34d is arranged pivotably with respect to the mounting unit 12d. The backrest 34d is connected to the seat structure elements 26d, 28d. The backrest 34d is configured to be pivoted between an upright seat position and a comfort position. The backrest 34d comprises a pivotable backrest element 36d. The pivotable backrest element 36d is pivotably supported at the mounting unit 12d. The pivotable backrest element 36d is pivotably connected to the seat structure elements 26d, 28d.

The passenger seat device comprises two bearing elements 44d, 46d for a support of the pivotable backrest element 36d. The pivotable backrest element 36d is connected to the mounting unit 12d via the bearing elements 44d, 46d. The bearing elements 44d, 46d are fixedly connected with the seat structure elements 26d, 28d. In the mounted state, the bearing elements 44d, 46d extend from the respective seat structure element 26d, 28d towards each other in the direction of the pivotable backrest element 36d. The bearing elements 44d, 46d are rigidly connected with the respective seat structure element 26d, 28d. The pivotable backrest element 36d is pivotable around the rotation axis 50d by means of the bearing elements 44d, 46d. The bearing elements 44d, 46d are in each case connected with the seat structure elements 26d, 28d.

The pivotable backrest element 36d comprises a backrest frame 38d. The backrest frame 38d implements a load-bearing element 42d of the pivotable backrest element 36d. The load-bearing element 42d of the pivotable backrest element 36d is configured to transfer operating forces, in particular support forces acting on the pivotable backrest element 36d, into the mounting unit 12d, in particular via the seat structure elements 26d, 28d. The backrest frame 38d is realized as a circumferential frame. The backrest frame 38d comprises two lateral frame elements and an upper frame element which connects the two lateral frame elements at an upper end of the backrest frame 38d. The lower end of the backrest frame 38d forms a lower end of the pivotable backrest element 36d. The bearing elements 44d, 46d are in each case connected, at a lower end of the backrest frame 38d, to the backrest frame 38d of the pivotable backrest element 36d at the lateral frame element facing towards the respective bearing element 44d, 46d. The backrest 34d is designed as a backrest having a high backrest pivot point. The backrest pivot point, i.e. the rotation axis 50d, is arranged above a knee region of the passenger seat 10d. In order to realize the high backrest pivot point, the bearing elements 44d, 46d are connected to the seat structure elements 26d, 28d in a high region in order to support the backrest 34d. The bearing elements 44d, 46d are connected to the seat structure elements 26d, 28d above the knee region. The bearing elements 44d, 46d are arranged at the armrest level X.

The pivotable backrest element 36d comprises a shell element 40d. The shell element 40d is realized as a plate-like element. The shell element 40d is made of a fiber-reinforced plastic. The shell element 40d is made, for example, of a GFRP or of a CFRP. The shell element 40d is configured to form the backrest support surface of the pivotable backrest element 36d. The shell element 40d is arranged in an inner region of the pivotable backrest element 36d, which is spanned by the backrest frame 38d. The shell element 40d is fixedly connected with the backrest frame 38d of the pivotable backrest element 36d. The shell element 40d is configured to have a cushioning element of the backrest 34d attached on it.

The pivotable backrest element 36d has in a lower region elastic ribs 172d, 174d, which in each case extend laterally outwards from a middle region 170d. By way of example, in the exemplary embodiment respectively three elastic ribs 172d, 174d are shown per each side. The elastic ribs 172d, 174d are in each case elastically deformable independently of one another. The elastic ribs 172d, 174d are preferably realized integrally with the shell element 40d, in particular with a middle region 170d. The shell element 40d forms the elastic ribs 172d, 174d in its lower region. The lower region is preferably realized by approximately a lower third of the shell element 40d. The shell element 40d has in its lower region a plurality of slots 176d, 178d for realizing the ribs 172d, 174d. The slots 176d, 178d extend in each case from a lateral outer edge of the shell element 40d as far as before the middle region 170d. The slots 176d, 178d separate the elastic ribs 172d, 174d, which are arranged one above the other, from one another.

The backrest 34d comprises a lower backrest element 32d. The lower backrest element 32d is realized in a rigid manner. The lower backrest element 32d is preferably realized in a non-movable manner. The lower backrest element 32d forms a lower region of the backrest 34d. The lower backrest element 32d forms the backrest support surface in the lower region of the backrest 34d. The lower backrest element 32d is fixedly fastened at the seat structure elements 26d, 28d. The lower backrest element 32d extends substantially between a level of the transverse beams 24d of the mounting unit 12d and a lower end of the pivotable backrest element 36d. The lower backrest element 32d is realized as a shell element. The lower backrest element 32d is realized as a shell made of a fiber-reinforced plastic. It is conceivable, for example, that the lower backrest element 32d is realized as a GFRP shell or a CFRP shell. In principle, it would also be conceivable that the lower backrest element 32d is made of a different material, for example of a metal sheet, or of a foil, or is realized as a multi-layer structure with a honeycomb structure. The lower backrest element 32d has an upper region 180d. The upper region 180d realizes approximately an upper quarter of the lower backrest element 32d. The uppermost 5-10 cm of the lower backrest element 32d form the upper region 180d. The backrest element 32d has a lip 182d at its upper end. The lip 182d forms an upper end region of the lower backrest element 32d. The lip 182d is realized in the upper region 180d of the lower backrest element 32d. The lip 182d forms an upper end of the upper region 180d of the lower backrest element 32d. The lip 182d is realized integrally with the remaining portion of the lower backrest element 32d. The lip 182d is arranged at the upper end of the lower backrest element 32d centrally in the transverse direction.

The lower backrest element 32d is realized so as to be flexible in its upper region 180d. The lower backrest element 32d is realized so as to be more flexible in its upper region 180d than in its main region 184d that is arranged below the upper region 180d. The lower backrest element 32d is realized so as to be elastically deflectable in its upper region 180d. In order to realize the flexibility in the upper region 180d, the lower backrest element 32d has a recess pattern 186d in the upper region 180d. The recess pattern 186d is realized by at least one recess 188d that is introduced in the lower backrest element 32d. The recess pattern 186d is arranged only in the upper region 180d. In principle, it would also be conceivable for the recess pattern 186d to be arranged only in the region of the lip 182d. In the present exemplary embodiment, the recess pattern 186d is implemented as a plurality of recesses 188d which are arranged spaced apart from one another and are realized as slots. The recesses 188d that are realized as slots extend from an upper edge of the lower backrest element 32d to below the lip 182d. In principle, it would also be conceivable for the recesses 188d to extend only up to a lower edge of the lip 182d. The recesses 188d that are realized as slots have a width of 10 mm. In principle, it would also be conceivable that the recesses 188d realized as slots have a width situated in a range from 5 mm to 30 mm. In the exemplary embodiment, four recesses 188d that are realized as slots are shown by way of example. In principle, it would also be conceivable that the recess pattern 186d comprises a different number of recesses 188d realized as slots. In principle, it would also be conceivable that the recesses 188d realized as slots are formed in a narrower manner.

In principle, however, it would also be conceivable that the lower backrest element 32d is made of a combination of different materials. For example, it would be conceivable that the upper region 180d or the lip 182d of the lower backrest element 32d is made of a different material than the main region 184d. For example, it would be conceivable that the main region 184d is made of a flexurally rigid fiber composite material or of a metal sheet and the upper region is made of a flexible plastic or fiber composite material that is fixedly attached to the main region 184d. If the lower backrest element 32d is made of a fiber composite material, the upper flexible region 180d is preferably made of a smaller number of lays of fiber composite layers than the main region 184d. This allows realizing the upper region 180d in an especially simple way, such that it is more flexible than the main region 184d, and realizing the lower backrest element 32d in an advantageous one-piece implementation.

The passenger seat device comprises a reset module 66d. The reset module 66d is configured for a restoring of the backrest 34d from the comfort position into an upright seat position. The reset module 66d is configured for a restoring of the backrest 34d from its pivoted seat position into the upright seat position. The reset module 66d is configured for a restoring of the pivotable backrest element 36d. For a restoring of the backrest 34d, in particular for a restoring of the pivotable backrest element 36d, the reset module 66d is configured to provide a resetting force. The reset module 66d is at least substantially arranged in a region above the bearing elements 44d, 46d. The reset module 66d is arranged at least substantially above the armrest level X, i.e. on a side of the armrest level X that faces away from the mounting plane. The reset module 66d is at least largely arranged above the knee region of the backrest 34d.

The reset module 66d comprises a locking device 70d. The locking device 70d is configured for a locking, respectively unlocking, of the reset module 66d. The locking device 70d is configured for a locking of the backrest 34d, i.e. of the pivotable backrest element 36d, at least in the upright seat position and in the comfort position. The locking device 70d is configured for a locking of the backrest 34d in its upright seat position. The locking device 70d is configured for a locking of the pivotable backrest element 36d in the upright seat position. The locking device 70d is capable of locking the pivotable backrest element 36d in the comfort position and in the upright seat position. The locking device 70d has a locking state and an unlocking state. In the locking state of the locking device 70d, the backrest 34d, in particular the pivotable backrest element 36d, is locked in the current position, i.e. either the upright seat position or the comfort position. In the locking position of the locking device 70d, the pivotable backrest element 36d is fixed in a form-fitting manner in a position, i.e. the upright seat position or the comfort position. In the locking position of the locking device 70d, the pivotable backrest element 36d is fixed in a positionally fixed manner relative to the mounting unit 12d. Preferably, the locking device 70d is configured only for locking the backrest 34d, i.e. the pivotable backrest element 36d, in the upright seat position and in the comfort position. Preferably, the locking device 70d is arranged mostly above the bearing elements 44d, 46d. The locking device 70d is arranged between the seat structure elements 26d, 28d and the pivotable backrest element 36d.

The locking device 70d comprises a first locking module 72d. The first locking module 72d of the locking device 70d is arranged on a lefthand side of the pivotable backrest element 36d. The first locking module 72d is arranged between the first, lefthand seat structure element 26d and the backrest frame 38d. The first locking module 72d is arranged function-wise between the lefthand bearing element 44d and the lefthand lateral frame element of the backrest frame 38d. The locking device 70d comprises a second locking module 74d. The second locking module 74d of the locking device 70d is arranged on a righthand side of the pivotable backrest element 36d. The second locking module 74d is arranged between the second, righthand seat structure element 28d and the backrest frame 38d. The second locking module 74d is arranged function-wise between the righthand bearing element 46d and the righthand lateral frame element of the backrest frame 38d. The two locking modules 72d, 74d are together configured for a locking of the backrest 34d, in particular of the pivotable backrest element 36d. The two locking modules 72d, 74d of the locking device 70d are realized substantially identically. The locking modules 72d, 74d are realized substantially mirror-symmetrically to each other. Preferably, in the locking modules 72d, 74d only actuation connections or elements for transmitting an actuation force are different. The locking modules 72d, 74d have a substantially identical structure mirror-symmetrically to each other.

The locking module 72d comprises a first locking unit 80d. The first locking unit 80d is configured to be fastened at the pivotable backrest element 36d. The first locking unit 80d forms a portion of the locking module 72d that faces towards the pivotable backrest element 36d. The locking module 72d comprises a second locking unit 82d. The second locking unit 82d is configured to be mounted on the bearing element 46d in a loss-proof manner. The second locking unit 82d constitutes a portion of the locking module 72d that faces towards the mounting unit 12d. The first locking unit 80d and the second locking unit 82d of the locking module 72d are supported movably relative to each other. The first locking unit 80d and the second locking unit 82d are supported movably relative to each other as they are connected to the pivotable backrest element 36d, respectively the bearing elements 44d, 46d, by the pivotable backrest element 36d being borne around the rotation axis 50d. The first locking unit 80d comprises a blocking element, which is spring-loaded and is adjustable between a locking position and a release position. The blocking element is configured for a form-fitting connection to the second locking unit 82d.

For the purpose of providing a resetting force, the reset module 66d comprises a first spring element 68d. For providing a resetting force, the reset module 66d comprises a second spring element 190d. In contrast to the preceding exemplary embodiments, the reset module 66d comprises two spring elements 68d, 190d. The spring elements 68d, 190d are in each case arranged on a respective side of the backrest frame 38d. The spring elements 68d, 190d are in each case connected to a lateral frame element of the backrest frame 38d. In the exemplary embodiment shown, the spring elements 68d, 190d are in each case connected to an outer side of a lateral frame element of the backrest frame 38d. The spring elements 68d, 190d are realized as flexible springs. The spring elements 68d, 190d are preferably realized as metallic flexible springs. The spring elements 68d, 190d are configured to provide a spring force.

The spring force of the spring elements 68d, 190d implements the resetting force of the reset module 66d. The spring elements 68d, 190d are function-wise arranged between the pivotable backrest element 36d and the mounting unit 12d. The spring elements 68d, 190d are configured to be supported on the mounting unit 12d with a first side. The spring elements 68d, 190d are configured to be supported in each case with a second side on the pivotable backrest element 36d. The spring elements 68d, 190d are each operatively arranged between one of the seat structure elements 26d, 28d and a lateral frame element of the backrest frame 38d. The spring elements 68d, 190d are in each case realized identically and are connected to the backrest frame 38d in an equivalent manner. Therefore, only the one spring element 68d and its connection will be described below, wherein the description can be used to explain the second spring element 190d. The spring element 68d is realized as a spiral spring. The spring element 68d has a spiral-shaped middle region 192d and two spring legs 194d, 196d protruding from the middle region 192d. The reset module 66d comprises a bearing element 198d, via which the spring element 68d is connected to the backrest frame 38d. The bearing element 198d is realized as a bearing cylinder. The bearing element 198d comprises a cylinder shell surface on which the spring element 68d rests with its spiral-shaped middle region 192d. The spring element 68d surrounds the bearing element 198d with its spiral-shaped middle region 192d. The bearing element 198d is fixedly connected to the outer side of the lateral frame element of the backrest frame 38d. Preferably, the bearing element 198d is screwed to the outer side of the lateral frame element of the backrest frame 38d in a positionally fixed manner by means of a screw connection.

The first spring leg 194d is configured to be supported on the bearing element 44d. The first spring leg 194d is configured to be supported on the first locking unit 80d. For a support of the first spring leg 194d, the reset module 66d comprises a first support element 200d. The first spring leg 194d is supported on the support element 200d, which is formed by the first locking unit 80d. The support element 200d is preferably implemented by a base body 86d of the locking unit 80d. The second spring leg 196d is configured to be supported on the backrest element 36d. The second spring leg 196d is configured to be supported on the lateral frame element of the backrest frame 38d. The reset module 66d comprises a second support element 202d for a support of the second spring leg 196d. The second support element 202d is configured for a support of the second spring leg 196d on the backrest frame 38d. The support element 202d is embodied as a support bolt, which is fixedly connected to a side surface of the lateral frame element of the backrest frame 38d. Preferably, the support element 202d is attached by means of a screw connection. For a support, the spring element 68d bears against the support element 202d with its spring leg 196d.

By means of the two separate spring elements 68d, 190d, which are in each case arranged on a respective side of the backrest frame 38d, it is advantageously possible for a resetting force provided by the reset module to act uniformly onto both sides of the pivotable backrest element 36d. As a result, it is in particular advantageously possible to dispense with a further reinforcement of the backrest frame 38d between the two lateral frame elements in a middle region. This allows realizing the pivotable backrest element 36d in an advantageously lightweight manner.

In principle, it would also be conceivable that the spring elements 68d, 190d and/or the locking modules 72d, 74d of the locking device 70d are in each case connected on an inner side of the respective lateral frame element of the backrest frame 38d. Due to the connection of the spring elements 68d, 190d and/or the locking modules 72d, 74d of the locking device 70d within the backrest frame 38d, the pivotable backrest element 36d could be realized in an especially advantageous manner.

The passenger seat device comprises a lower cover module 204d. The lower cover module 204d is configured to at least partially cover a lower region of the backrest 34d towards a rear side. The lower cover module 204d is preferably configured to cover at least a subregion of the lower backrest element 32d. The lower cover module 204d covers the lower backrest element 32d in a subregion towards the rear. The lower cover module 204d comprises a cover element 206d. The cover element 206d is arranged in an upper region of the lower backrest element 32d. The cover element 206d is arranged centrally on the lower backrest element 32d on its rear side. The cover element 206d covers at least the lip 182d and the upper region 180d of the lower backrest element 32d. The cover element 206d is configured to cover the flexible upper region 180d of the lower backrest element 32d towards the rear. The cover element 206d is connected to the lower backrest element 32d. Preferably, the cover element is detachably connected to the lower backrest element 32d via form-fitting elements, preferably in particular via screw connections. The cover element 206d may preferably form a literature pouch 210d or other additional units.

The cover element 206d does not cover a lower region of the lower backrest element 32d. The lower backrest element 32d forms in its lower region a visible surface 208d which is not covered towards the rear. The visible surface 208d of the lower backrest element 32d is not covered by any cover element 206d of the cover module 204d. The visible surface 208d of the lower backrest element 32d may be covered with a coating or a foil. In principle, it is also conceivable that the backrest element 32d does not have a covering in its visible surface 208d. The lower backrest element 32d forms with its visible surface 208d a kick panel of the backrest 34d.

The passenger seat device comprises an upper cover module 212d. The upper cover module 212d is configured to cover the upper region of the backrest 34d, in particular the pivotable backrest element 36d, towards the rear. The upper cover module 212d comprises a cover element 214d. The cover element 214d preferably extends over an entire rear side of the upper pivotable backrest element 36d. The upper cover module 212d preferably covers the laterally arranged locking modules 72d, 74d of the locking device 70d. Preferably, it is conceivable that the upper cover module 212d comprises in the regions of the locking modules 72d, 74d cover elements, which are separately demountable and which can be separated individually from the backrest element 36d for easily accessing the locking modules 72d, 74d. The cover element 214d forms in its upper region a literature pouch 216d. The literature pouch 216d is arranged in a head region of the backrest 34d. The passenger seat device moreover comprises a pivotable table 218d. The pivotable table 218d is foldable to the cover element 214d of the upper cover module 212d.

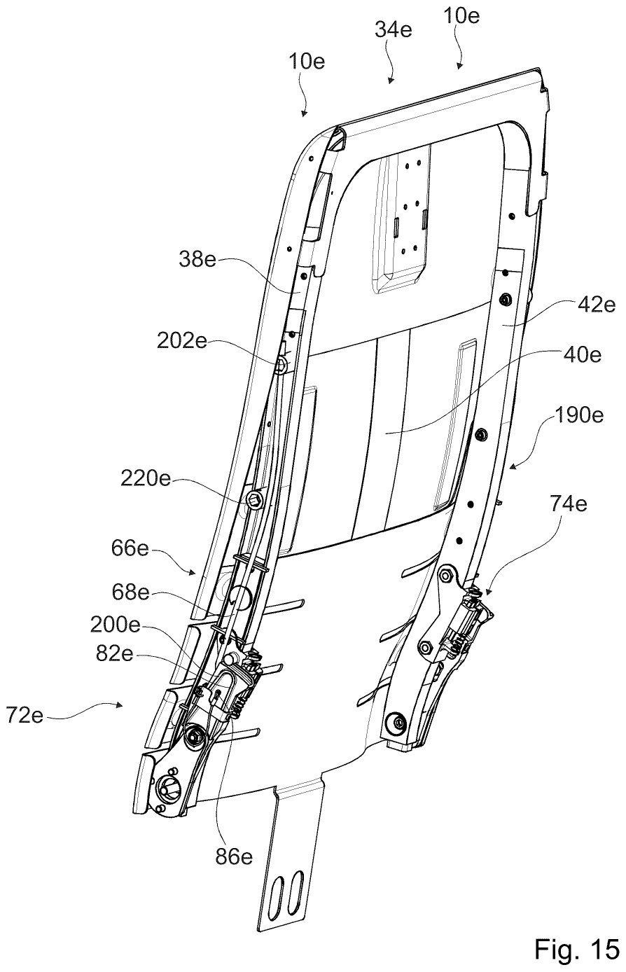

FIG. 15 shows a sixth exemplary embodiment of a passenger seat device according to the invention. The passenger seat device is realized substantially identically to the passenger seat device of the fifth exemplary embodiment. The passenger seat device comprises a backrest 34e. The backrest 34e is configured such that a person sitting on the passenger seat 10e, of which the passenger seat device is a part, can support his/her back on the backrest 34e. The backrest 34e comprises a pivotable backrest element 36e. The pivotable backrest element 36e is pivotably supported at the mounting unit 12e. The pivotable backrest element 36e comprises a backrest frame 38e. The passenger seat device comprises a reset module 66e. The reset module 66e is configured for restoring the backrest 34e from the comfort position into an upright seat position. The reset module 66e comprises a locking device 70e. The locking device 70e is configured for a locking, respectively unlocking, of the reset module 66e. The locking device 70e is configured for a locking of the backrest 34e, i.e. of the pivotable backrest element 36e, at least in the upright seat position and in the comfort position.

For providing a resetting force, the reset module 66e comprises a first spring element 68e and a second spring element 190e. In contrast to the preceding exemplary embodiment, the spring elements 68e, 190e are realized as bar spring elements. The bar spring elements 68e, 190e are respectively arranged between a support element 202e attached to the backrest frame 38e and a support element 200e connected to a locking unit 82e. The spring element 68e that is realized as a bar spring element is respectively supported at an end region with a same first side on the respective support element 200e, 202e. The reset module 66e comprises a deflecting element 220e, on which the spring element 68e that is realized as a bar spring element can be supported with an opposite-situated second side. The deflecting element 220e is arranged between the two support elements 200e, 202e. The deflecting element 220e is arranged substantially centrally between the two support elements 200e, 202e. The deflecting element 220e is realized as a support bolt that is connected to the backrest frame. The deflecting element 220e is screwed to an outer side of the lateral frame element of the backrest frame 38e.

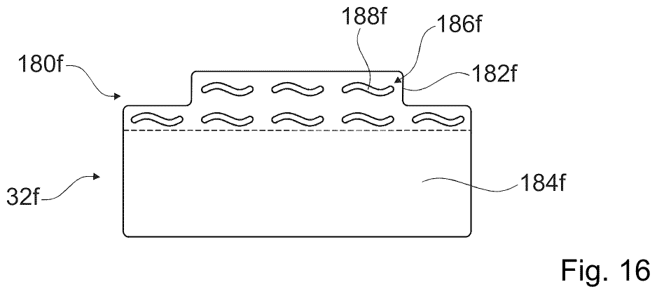

FIG. 16 shows an alternative implementation of a lower backrest element in a further exemplary embodiment. The basic implementation of the passenger seat device is substantially identical to the implementation of the fourth exemplary embodiment. The lower backrest element 32f is realized so as to be flexible in its upper region 180f. The lower backrest element 32f is realized so as to be more flexible in its upper region 180f than in its main region 184f, which is arranged below the upper region 180f. The lower backrest element 32f is realized so as to be elastically deflectable in its upper region 180f. In order to realize the flexibility in the upper region 180f, the lower backrest element has a recess pattern 186f in the upper region 180f. The recess pattern 186f is realized by at least one recess 188f that is introduced in the lower backrest element. The recess pattern 186f is arranged only in the upper region 180f. In the present exemplary embodiment, the recesses 188f are realized as wave-shaped recesses 188f. The wave-shaped recesses 188f extend in a transverse direction. Several wave-shaped recesses 188f are preferably arranged spaced apart from one another, in a transverse direction, in a row. In principle, it would also be conceivable that the recesses 188f have a different shape or realize different shapes.

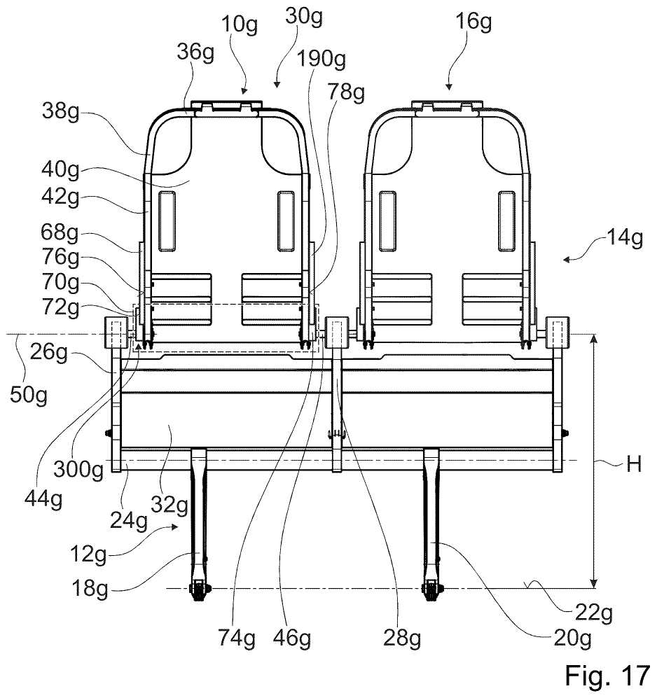

FIGS. 17-22 show a passenger seat device in a seventh exemplary embodiment. Herein the passenger seat device is part of a passenger seat 10g. The passenger seat 10g is realized as an aircraft seat. The passenger seat device comprises a mounting unit 12g. The passenger seat 10g can be mounted on the cabin floor 22g of the aircraft cabin by means of the mounting unit 12g. The passenger seat 10g is realized as part of a passenger seat row 14g. The passenger seat row 14g shown by way of example comprises a second passenger seat 16g. The further passenger seat 16g is arranged so as to be neighboring the first passenger seat 10g. The mounting unit 12g comprises two seat bases 18g, 20g. The seat bases 18g, 20g are in each case, via fittings that are not shown in detail, coupled with fastening rails which are fixedly connected with the cabin floor 22g. The fittings can be blocked fixedly in the fastening rails. The mounting unit 12g comprises two transverse beams 24g. The transverse beams 24g are realized as support tubes.

The passenger seat device comprises two seat structure elements 26g, 28g. The two seat structure elements 26g, 28g are in each case arranged on a respective side of a sitting area 30g of the passenger seat device. The two seat structure elements 26g, 28g are in each case arranged laterally with respect to a sitting area 30g that is formed by the passenger seat 10g. The seat structure elements 26g, 28g are realized as seat dividers. The seat structure elements 26g, 28g are arranged at the transverse beams 24g. The seat structure elements 26g, 28g are fastened to the transverse beams 24g so as to be spaced apart from one another in the transverse direction. The seat structure elements 26g, 28g are connected to the transverse beams 24g in a positionally fixed manner. The seat structure elements 26g, 28g are realized substantially in an L-shape. The seat structure elements 26g, 28g in each case have a first subregion, which is in a mounted state oriented substantially horizontally. The seat structure elements 26g, 28g in each case have a second subregion, which is in a mounted state oriented substantially vertically. The second subregion of the seat structure elements 26g, 28g is arranged in a rear region of the passenger seat 10g. The second subregion of the seat structure elements 26g, 28g extends as far as a rear end of the seat structure elements 26g, 28g. The second subregion of the seat structure elements 26g, 28g forms a rear region of the seat structure elements 26g, 28g. The seat structure elements 26g, 28g thus extend in their rear region upwards, away from the mounting unit 12g, in particular away from the mounting plane. The seat structure elements 26g, 28g extend in their rear region substantially as far upwards as an armrest level X. The seat structure elements 26g, 28g extend as far as an armrest level X of the passenger seat 10g. The armrest level X is 650 mm. In principle, it is preferably conceivable that the armrest level X is in a range between 500 mm and 700 mm.

The seat structure elements 26g, 28g, which are realized as seat dividers, are configured such that different components of the respective passenger seat 10g, 16g are fastened to said seat structure elements 26g, 28g; this will at least partly be described in detail below. In principle, it is also conceivable that the mounting unit 12g comprises no seat structure elements 26g, 28g or differently realized seat structure elements, and respective components of the passenger seat 10g, 16g are connected to the mounting unit 12g in a different way. The passenger seat device comprises a seat bottom. The seat bottom is not shown in detail. The seat bottom forms the sitting area 30g. The seat bottom forms a seat surface of the passenger seat 10g. The seat bottom is connected to the mounting unit 12g.

The passenger seat device comprises a backrest 34g. The backrest 34g is configured such that a person sitting on the passenger seat 10g, of which the passenger seat device is a part, can support his/her back on the backrest 34g. The backrest 34g preferably comprises cushioning, which is not shown in detail. The backrest 34g forms a backrest support surface. The backrest 34g is arranged at a rear end of the seat bottom. The backrest 34g is arranged pivotably with respect to the mounting unit 12g. The backrest 34g is connected with the seat structure elements 26g, 28g. The passenger seat 10g herein realizes a sitting direction. The sitting direction is defined as the direction in which a passenger sits on the passenger seat 10g. The sitting direction is orthogonal to a backrest surface of the backrest 34g and extends parallel to the mounting plane in the direction of a front end of the seat bottom.

The backrest 34g is designed to be pivotable. The backrest 34g is configured for being pivoted between an upright seat position and a comfort position. The backrest 34g is configured for being pivoted relative to the mounting unit 12g. The backrest 34g is pivotable relative to the seat structure elements 26g, 28g. The backrest 34g comprises a pivotable backrest element 36g. The pivotable backrest element 36g is pivotably supported at the mounting unit 12g. The pivotable backrest element 36g is pivotably connected to the seat structure elements 26g, 28g. The backrest 34g comprises a lower backrest element 32g. The lower backrest element 32g is realized in a rigid manner. The lower backrest element 32g is preferably realized in a non-movable manner. The lower backrest element 32g forms a lower region of the backrest 34g. The lower backrest element 32g forms the backrest support surface in the lower region of the backrest 34g.

The pivotable backrest element 36g comprises a backrest frame 38g. The backrest frame 38g implements a load-bearing structure of the pivotable backrest element 36g. The backrest frame 38g is realized as a circumferential frame. The backrest frame 38g is preferably realized in a substantially U-shaped manner. The backrest frame 38g comprises two lateral frame elements and an upper frame element, which connects the two lateral frame elements at an upper end of the backrest frame 38g. The backrest frame 38g is preferably open at a lower end. The lower end of the backrest frame 38g forms a lower end of the pivotable backrest element 36g. The pivotable backrest element 36g comprises a shell element 40g. The shell element 40g is realized as a plate-like element. The shell element 40g is made of a fiber-reinforced plastic. The shell element 40g is arranged in an inner region of the pivotable backrest element 36g, which is spanned by the backrest frame 38g.

The backrest frame 38g realizes a load-bearing element 42g of the pivotable backrest element 36g. The load-bearing element 42g of the pivotable backrest element 36g is configured to transfer operating forces, in particular support forces acting on the pivotable backrest element 36g, into the mounting unit 12g, in particular via the seat structure elements 26g, 28g. The load-bearing element 42g is preferably realized in a rigid manner and is configured to transmit torsional and bending forces. In principle, it would also be conceivable that the pivotable backrest element 36g does not comprise a backrest frame 38g. In such a case, it would be conceivable that the entire backrest element 36g is realized as a shell element which forms the backrest support surface and the load-bearing element 42g of the pivotable backrest element 36g integrally.

For the purpose of supporting the pivotable backrest element 36g, the passenger seat device comprises two bearing elements 44g, 46g. The pivotable backrest element 36g is connected to the mounting unit 12g via the bearing elements 44g, 46g. The bearing elements 44g, 46g are fixedly connected with the seat structure elements 26g, 28g. In the mounted state, the bearing elements 44g, 46g extend from the respective seat structure element 26g, 28g towards each other in the direction of the pivotable backrest element 36g. The bearing elements 44g, 46g are rigidly connected with the respective seat structure element 26g, 28g. The bearing element 44g is rigidly mounted at the lefthand seat structure element 26g. The bearing element 46g is rigidly mounted at the righthand seat structure element 28g. The bearing elements 44g, 46g are realized as fixed bearing axles. The bearing elements 44g, 46g are arranged at a level of a rotation axis 50g of the backrest 34g. The rotation axis 50g is the axis around which the pivotable backrest element 36g is supported pivotably. The rotation axis 50g is defined by the bearing elements 44g, 46g, which are realized as bearing axles. The rotation axis 50g is oriented coaxially with a middle axis of the bearing elements 44g, 46g realized as bearing axles. The bearing elements 44g, 46g form a glide-bearing region in an end that is situated opposite a connecting flange for a connection to the seat structure elements 26g, 28g. The pivotable backrest element 36g is glidingly supported on the bearing elements 44g, 46g via the glide-bearing regions of the bearing elements 44g, 46g. The backrest frame 38g implementing the load-bearing element 42g of the pivotable backrest element 36g is pivotably supported at the bearing elements 44g, 46g via the glide-bearing regions. The glide-bearing regions are realized as an axle extension of the bearing elements 44g, 46g. The lateral frame elements of the backrest frame 38g each have in their lower end region a respective bearing receptacle 62g, via which the backrest frame 38g is pivotably supported so as to be gliding on the glide-bearing regions of the bearing elements 44g, 46g. The pivotable backrest element 36g in each case has a bearing bush 64g, which is arranged in the respective bearing receptacle 62g of the backrest frame 38g. In a mounted state, the bearing element 44g, 46g in each case extends with its glide-bearing region through the bearing bush 64g that is arranged in the bearing receptacle 62g.

The backrest 34g is designed as a backrest having a high backrest pivot point. The backrest pivot point is implemented by the rotation axis 50g. The backrest pivot point, i.e. the rotation axis 50g, is arranged above a knee region of the passenger seat 10g. The knee region of the passenger seat 10g extends, starting from the cabin floor 22g, to a level of 650 mm. The knee region is arranged as a region in which a passenger sitting behind the passenger seat 10g may arrange his knees. In order to realize the high backrest pivot point, the bearing elements 44g, 46g are connected to an upper end region of the seat structure elements 26g, 28g. The bearing elements 44g, 46g are connected to the seat structure elements 26g, 28g above the knee region. The bearing elements 44g, 46g are arranged at the armrest level X. The rotation axis 50g is arranged above the knee region of the passenger seat 10g.

The passenger seat device comprises a reset module 66g. The reset module 66g is configured for a restoring of the backrest 34g from the comfort position into an upright seat position. The reset module 66g is configured for restoring the backrest 34g from its pivoted seat position into the upright seat position. The reset module 66g is configured for restoring the pivotable backrest element 36g. For the purpose of restoring the backrest 34g, in particular for restoring the pivotable backrest element 36g, the reset module 66g is configured to provide a resetting force. The reset module 66g is at least substantially arranged in a region above the bearing elements 44g, 46g. The reset module 66g is arranged at least substantially above the armrest level X, i.e. on a side of the armrest level X that faces away from the mounting plane. The reset module 66g is at least to a large extent arranged above the knee region of the backrest 34g.

In order to provide a resetting force, the reset module 66g comprises a first spring element 68g. In order to provide a resetting force, the reset module 66g comprises a second spring element 190g. The spring elements 68g, 190g are in each case arranged on a respective side of the backrest frame 38g. The spring elements 68g, 190g are respectively connected to a lateral frame element of the backrest frame 38g. In the exemplary embodiment shown, the spring elements 68g, 190g are respectively connected on an outer side of a lateral frame element of the backrest frame 38g. The spring elements 68g, 190g are realized as flexible springs. The spring elements 68g, 190g are preferably realized as metallic flexible springs. The spring elements 68g, 190g are configured to provide a spring force. The spring force of the spring elements 68g, 190g realizes the resetting force of the reset module 66g. The spring elements 68g, 190g are function-wise arranged between the pivotable backrest element 36g and the mounting unit 12g. The spring elements 68g, 190g are configured to be supported with a first side on the mounting unit 12g. The spring elements 68g, 190g are configured to be respectively supported with a second side on the pivotable backrest element 36g. The spring elements 68g, 190g are in each case operatively arranged between one of the seat structure elements 26g, 28g and a lateral frame element of the backrest frame 38g. The spring elements 68g, 190g are realized as spiral springs. In principle, it would also be conceivable that the spring elements 68g, 190g are realized as different spring elements. It would be conceivable, for example, that the spring elements are realized as bar springs. In principle, it would also be conceivable that the reset module comprises only one spring element 68g.

The passenger seat device comprises a locking device 70g. The locking device 70g is configured for a locking of the backrest 34g in its upright seat position. The locking device 70g is configured for a locking of the pivotable backrest element 36g in the upright seat position. The locking device 70g is configured for a locking of the backrest 34g in the comfort position. The locking device 70g is configured for a locking of the pivotable backrest element 36g in the comfort position. The locking device 70g is capable of locking the pivotable backrest element 36g in the comfort position and in the upright seat position. The locking device 70g is configured for a locking of the pivotable backrest element 36g in the upright seat position in a form-fitting manner. The locking device 70g is configured for a locking of the pivotable backrest element 36g in the comfort position in a form-fitting manner. By means of the locking device 70g, the pivotable backrest element 36g can be locked in the upright seat position and in the comfort position in a form-fitting manner.

The locking device 70g is configured for a stepless blocking of the pivotable backrest element 36g between the comfort position and the upright seat position. The locking device 70g is configured for fixing the pivotable backrest element 36g in a positionally fixed manner in any desired positions between the comfort position and the upright seat position. The locking device 70g is configured for a locking of the pivotable backrest element 36g in any desired intermediate positions between the comfort position and the upright seat position in such a way that forces, in particular sitting and holding forces, can be transferred away. In an intermediate position, the pivotable backrest element 36g is locked by means of the locking device 70g in such a way that a passenger sitting on the passenger seat 10g can support himself/herself on the pivotable backrest element 36g. The locking device 70g is preferably configured to fix the pivotable backrest element 36g in a force-fitting manner in any desired intermediate position between the upright seat position and the comfort position. The locking device 70g is configured to fix the pivotable backrest element 36g in any desired intermediate position by friction fit.

The locking device 70g is realized separately from the spring element 68g, 190g of the reset module 66g. The locking device 70g is realized separately from the two spring elements 68g, 190g of the reset module 66g. The function of the locking device 70g is independent of the spring elements 68g, 190g of the reset module 66g.

The locking device 70g comprises a first locking module 72g. The first locking module 72g of the locking device 70g is arranged on a lefthand side of the pivotable backrest element 36g. The first locking module 72g is arranged between the first, lefthand seat structure element 26g and the load-bearing element 42g of the pivotable backrest element 36g, which is formed by the backrest frame 38g. The first locking module 72g is arranged function-wise between the lefthand bearing element 44g and the lefthand lateral frame element of the backrest frame 38g. The first locking module 72g is with a first attachment region fixedly connected to the lefthand bearing element 44g. The first locking module 72g is with a second attachment region fixedly connected to the lateral frame element of the backrest frame 38g. The first locking module 72g is arranged on an outer side 76g of the load-bearing element 42g. The first locking module 72g is thus arranged on the outer side 76g of the lateral frame element of the backrest frame 38g. The first locking module 72g is arranged on the outer side 76g of the backrest frame 38g, which faces towards the lefthand seat structure element 26g.

The locking device 70g comprises a second locking module 74g. The second locking module 74g of the locking device 70g is arranged on a righthand side of the pivotable backrest element 36g. The second locking module 74g is arranged between the second, righthand seat structure element 28g and the load-bearing element 42g of the pivotable backrest element 36g, which is formed by the backrest frame 38g. The second locking module 74g is arranged function-wise between the righthand bearing element 46g and the righthand lateral frame element of the backrest frame 38g. The second locking module 74g is with a first attachment region fixedly connected to the righthand bearing element 46g. The second locking module 74g is with a second attachment region fixedly connected to the lateral frame element of the backrest frame 38g. The first locking module 72g is arranged on an outer side 78g of the load-bearing element 42g. The second locking module 74g is thus arranged on the outer side 78g of the lateral frame element of the backrest frame 38g. The second locking module 74g is arranged on the outer side 78g of the backrest frame 38g, which faces towards the righthand seat structure element 28g.

The two locking modules 72g, 74g are together configured for the locking of the backrest 34g, in particular of the pivotable backrest element 36g. The two locking modules 72g, 74g of the locking device 70g are realized substantially identically. The locking modules 72g, 74g are realized substantially mirror-symmetrically to one another. Preferably, in the locking modules 72g, 74g only actuation connections or elements for transmitting an actuation force are different. The locking modules 72g, 74g have a substantially identical structure mirror-symmetrically to one another. The second locking module 74g is essentially a mirror-image of the first locking module 72g. Therefore, only the first locking module 72g will be described in detail below. The following description of the first locking module 72g may be used to explain the second locking module 74g. The differences of the second locking module 74g in comparison to the first locking module 72g will be described explicitly.

The locking module 72g comprises a first locking unit 80g. The first locking unit 80g is configured to be fastened at the pivotable backrest element 36g. The first locking unit 80g is realized as a portion of the locking module 72g that faces towards the pivotable backrest element 36g. In a mounted state, the first locking unit 80g is fixedly connected with the pivotable backrest element 36g. The first locking unit 80g is connected to the load-bearing element 42g of the pivotable backrest element 36g. The first locking unit 80g is mounted at the lateral frame element of the backrest frame 38g in a loss-proof manner.

The locking module 72g comprises a second locking unit 82g. The second locking unit 82g is configured to be mounted at the bearing element 44g in a loss-proof manner. The second locking unit 82g forms a portion of the locking module 72g that faces towards the mounting unit 12g. In a mounted state, the second locking unit 82g is fixedly connected with the bearing element 44g, which is realized as a bearing axle. The second locking unit 82g is mounted on the bearing element 44g. The bearing element 44g comprises a connecting flange for connecting the second locking unit 82g. The second locking unit 82g is fixedly mounted at the connecting flange of the bearing element 44g via several screw connections. In principle, it would also be conceivable that the first locking unit 80g of the locking module 72g is fixedly connected to the bearing element 44g and the second locking unit 82g is fixedly connected to the load-bearing element 42g of the pivotable backrest element 36g.

The first locking unit 80g and the second locking unit 82g of the locking module 72g are supported movably relative to each other. The first locking unit 80g and the second locking unit 82g are supported movably relative to each other—as they are connected to the pivotable backrest element 36g, respectively the bearing element 44g—by the pivotable backrest element 36g being borne around the rotation axis 50g. The first locking unit 80g and the second locking unit 82g are configured to be locked with each other in the upright seat position and in the comfort position in a form-fitting and/or force-fitting manner. The first locking unit 80g and the second locking unit 82g are respectively configured to be in the upright seat position and in the comfort position in a form-fitting contact with each other, in at least one movement direction, for the purpose of fixing the pivotable backrest element 36g. The first locking unit 80g and the second locking unit 82g are configured to abut against each other in the upright seat position in a form-fitting manner in order to prevent a frontward adjustment of the pivotable backrest element 36g. The first locking unit 80g and the second locking unit 82g are configured to abut against each other in the comfort position in a form-fitting manner in order to prevent a rearward adjustment of the pivotable backrest element 36g. The first locking unit 80g and the second locking unit 82g are configured to be additionally fixed in the upright seat position and in the comfort position in a force-fitting, i.e. friction-fitting, manner. The first locking unit 80g and the second locking unit 82g are configured to be fixed in a friction-fitting manner in any desired intermediate positions between the upright seat position and the comfort position. In any desired intermediate positions, the first locking unit 80g and the second locking unit 82g are fixed relative to each other only in a force-fitting manner.

The locking module 72g comprises a friction unit 300g. The friction unit 300g is configured to provide a holding force for the stepless blocking of the pivotable backrest element 36g. The friction unit 300g is configured to fix the pivotable backrest element 36g in a position in a force-fitting manner. The friction unit 300g is configured to fix the pivotable backrest element 36g in the upright seat position, in the comfort position and in any desired intermediate positions in a force-fitting manner via a frictional connection. The friction unit 300g has a non-actuated state and an actuated state. A non-actuated state is realized as a closed state of the friction unit 300g. In a non-actuated state, the friction unit 300g is closed and the locking module 72g blocks the pivotable backrest element 36g in its current position. An actuated state is realized as an open state of the friction unit 300g. In an actuated state, the friction unit 300g is open and the locking module 72g releases the pivotable backrest element 36g. In the actuated state of the friction unit 300g, the pivotable backrest element 36g can be pivoted between the upright seat position and the comfort position.

The friction unit 300g is preferably arranged on the first locking unit 80g of the locking module 72g. The friction unit 300g is part of the first locking unit 80g. The friction unit 300g is connected to the backrest frame 38g.

The first locking unit 80g has a rotatably supported shaft 302g. The rotatably supported shaft 302g is arranged at the pivotable backrest element 36g. The rotatably supported shaft 302g is rotatably supported at the backrest frame 38g. The rotatably supported shaft 302g is oriented in a transverse direction with respect to the backrest frame 38g. In a mounted state, the rotatably supported shaft 302g extends from an outer side 76g of the backrest frame 38g to an inner side of the backrest frame 38g. The rotatably supported shaft 302g extends through the backrest frame 38g. The backrest frame 38g comprises a bearing receptacle 304g. The bearing receptacle 304g is realized as a through hole through the backrest frame 38g. Preferably a bearing bush 306g, in which the rotatably supported shaft 302g is glidingly supported, is arranged in the bearing receptacle 304g that is realized as a through hole. The rotatably supported shaft 302g is configured to connect the friction unit 300g to the other locking unit 82g. The rotatably supported shaft 302g is configured to rotate during a pivoting of the pivotable backrest element 36g. The rotatably supported shaft 302g is coupled with the friction unit 300g. For the force-fit locking of the pivotable backrest element 36g, the friction unit 300g is configured to secure the rotatably supported shaft 302g against rotation in a force-fitting manner. The friction unit 300g is arranged at a first, inner end of the rotatably supported shaft 302g. The friction unit 300g is arranged at an inner side of the backrest frame 38g. The friction unit 300g is connected to the rotatably supported shaft 300g on the inner side of the backrest frame 38g.

The friction unit 300g comprises an attachment element 308g. The attachment element 308g is configured to be directly connected to the inner side of the backrest frame 38g. The attachment element 308g is realized as a flat element. The attachment element 308g is preferably realized as a milled part. The attachment element 308g preferably comprises two fastening holes 310g, via which the attachment element 308g is connectable to the backrest frame 38g, preferably by means of a screw connection. The fastening holes 310g are preferably realized as threaded holes. In principle, it would also be conceivable for the fastening holes 310g to be realized merely as simple through holes. The attachment element 308g has a central receiving region 312g. The receiving region 312g is preferably configured to support a portion of the rotatably supported shaft 302g. The attachment element 308g has a central through hole through which the rotatably supported shaft 302g is guided. The attachment element 308g forms an attachment region for the friction unit 300g. The friction unit 300g is connected to the backrest frame 38g via the attachment element 308g.

The friction unit 300g comprises a base body 314g. The base body 314g is realized as a counter holder. The base body 314g is configured to be connected to the attachment element 308g. The base body 314g is connected in a rotationally-fixed manner to the attachment element 308g. The base body 314g is supported so as to be displaceable—against a spring force—with respect to the attachment element 308g and the shaft 302g, in an axial direction of the rotatably supported shaft 302g. The base body 314g is configured to support the rotatable shaft 302g. The base body 314g comprises a bearing receptacle 328g. The bearing receptacle 328g is realized as a through hole. The rotatably supported shaft 302g is supported with its first end glidingly in the bearing receptacle 328g of the base body 314g. The rotatably supported shaft 302g has at its first end a bearing region with which the shaft 302g is supported glidingly at the base body 314g. The base body 314g is displaceable along the bearing region of the rotatably supported shaft 302g in the axial direction of the shaft 302g.

The base body 314g has two fastening holes 338g for connecting to the attachment element 308g. The fastening holes 338g are realized as simple through holes. The fastening holes 338g of the base body 314g are realized correspondingly to the fastening holes 310g of the attachment element 308g. The friction unit 300g comprises connection elements 340g via which the friction unit 300g can be mounted. The friction unit 300g is connectable to the backrest frame 38g by means of the connection elements 340g. The connection elements 340g connect the base body 314g to the attachment element 308g. The connection elements 340g connect the base body 314g and the attachment element 308g to the backrest frame 38g. The base body 314g is connected to the attachment element 308g such that it is displaceable in the axial direction via the connection elements 340g. The connection elements 340g are realized as screw elements. The connection elements 340g, which are embodied as screw elements, preferably have an external thread only in a frontal end region that faces away from a screw head. The base body 314g is supported so as to be gliding with respect to the connection elements 340g via its fastening holes 338g. For the connection of the base body 314g to the attachment element 308g, the connection elements 340g are in each case guided through a fastening hole 338g of the base body 314g and through a fastening hole 310g of the attachment element 308g. If the fastening holes 310g of the attachment element 308g are realized as threaded holes, the connection elements 340g are fixedly screwed in the fastening holes 310g. For the connection of the friction unit 300g to the backrest frame 38g, the backrest frame 38g comprises threaded bushings 348g. The threaded bushings 348g are introduced in the outer side 76g of the backrest frame 38g. For the fastening of the friction unit 300g, the base body 314g—together with the attachment element 308g—is screwed with the connection elements 340g at the threaded bushings 348g of the backrest frame 38g.

The friction unit 300g comprises a spacer element 316g. The spacer element 316g is arranged between the attachment element 308g and the base body 314g. The spacer element 316g is realized in an annular shape. The spacer element 316g lies flat against the attachment element 308g with a first side. On a second side, the spacer element 316g has a groove that forms an inclined surface. The groove 318g and the inclined surface are configured for contact with an engagement element 320g of the base body 314g. The engagement element 320g is realized as an elevation on an inner side of the base body 314g. The spacer element 316g is supported so as to be rotatable relative to the base body 314g and to the attachment element 308g. The spacer element 316g is configured to vary a distance between the base body 314g and the attachment element 308g by rotation. In a neutral position of the spacer element 316g, a distance between the base body 314g and the attachment element 308g is at its smallest. In the neutral position, the engagement element 320g of the base body 314g is arranged in the groove 318g. In the neutral position of the spacer element 316g, the friction unit 300g is in its non-actuated state. Upon rotation of the spacer element 316g out of its neutral position, the inclined surface comes into contact with the engagement element 320g of the base body 314g and thus presses the base body 314g away from the attachment element 308g. In an actuating position, in which the spacer element 316g is rotated out of its neutral position, the spacer element 316g presses the base body 314g away from the attachment element 308g into an unlocking position.

The friction unit 300g comprises at least one spring element 322g, which is configured to exert a spring force, directed towards the attachment element 308g, onto the base body 314g. The friction unit 300g comprises a second spring element 350g, which is configured to exert a spring force, directed towards the attachment element 308g, onto the base body 314g. The spring elements 322g, 350g are preferably realized identically. The spring elements 322g, 350g are realized as compression springs. The spring elements 322g, 350g are realized as metal compression springs. Preferably the spring elements 322g, 350g are made of a wound-up spring steel. In principle, it would also be conceivable that the spring elements 322g, 350g are made of an elastically deformable plastic. The spring elements 322g, 350g are configured to press the base body 314g against the attachment element 308g. The spring elements 322g, 350g are likewise configured to press the spacer element 316g into its neutral position. The spring elements 322g, 350g are configured to exert a spring force onto the spacer element 316g, which moves the spacer element 316g into its neutral position. The spring elements 322g, 350g are arranged between the connection elements 340g and the base body 314g of the friction unit 300g. The spring elements 322g, 350g are connected function-wise between the base body 314g and the connection elements 340g. The spring elements 322g, 350g are respectively arranged between a screw head of one of the connection elements 340g and the base body 314g, in particular an outer side of the base body 314g. The spring elements 322g, 350g are clamped between the screw head of the respective connection element 340g and the outer side of the base body 314g of the friction unit 300g. The spring elements 322g, 350g are configured to be supported on the screw head of the connection element 340g which is fixedly connected with the backrest frame 38g, and to exert a force onto the base body 314g which acts towards the attachment element 308g.

The friction unit 300g comprises a first friction element 324g. The friction element 324g forms a friction surface. The friction element 324g is realized with its friction surface for frictional contact with a correspondingly realized friction surface. The first friction element 324g is realized as a rotationally fixed friction element. The first friction element 324g is realized so as to be rotationally fixed with respect to the backrest frame 38g. The first friction element 324g is fixedly connected with the base body 314g. The first friction element 324g is arranged on an inner side of the base body 314g. The first friction element 324g is preferably realized as an inner side of the base body 314g. The first friction element 324g is realized as a conical friction element. The first friction element 324g is realized as a cone-shaped recess. The first friction element 324g forms a cone-shaped friction surface.

The friction unit 300g comprises a further first friction element 352g. The friction element 352g forms a friction surface. The further first friction element 352g is realized as a rotationally fixed friction element. The further first friction element 352g is realized so as to be rotationally fixed relative to the backrest frame 38g. The further first friction element 352g is fixedly connected with the attachment element 308g. The further first friction element 352g is arranged on an inner side of the attachment element 308g. The further first friction element 352g is preferably realized as an inner side of the attachment element 308g. The further first friction element 352g is realized as the receiving region 312g of the attachment element 308g. The further first friction element 352g is likewise realized as a conical friction element. The further first friction element 352g is likewise realized as a cone-shaped recess. The further first friction element 352g forms a cone-shaped friction surface.

The friction unit 300g comprises a second friction element 326g. The second friction element 326g is realized fixedly with the rotatably supported shaft 302g. The second friction element 326g is realized so as to be rotationally fixed with the rotatably supported shaft 302g. The second friction element 326g is realized as a conical friction element. The second friction element 326g forms a cone-shaped friction surface. The second friction element 326g faces towards the base body 314g. The second friction element 326g faces towards the first friction element 324g that is formed by the base body 314g. The second friction element 326g is realized as a friction disk having a cone-shaped friction surface. The second friction element 326g is realized so as to correspond to the first friction element 324g. The second friction element 326g is configured for frictional contact with the first friction element 324g. The second friction element 326g is preferably realized integrally with the rotatable shaft 302g. In principle, it would also be conceivable that the second friction element 326g is in a rotationally-fixed manner connected with the shaft 302g via connecting means.

The friction unit 300g comprises a further second friction element 354g. The further second friction element 354g is realized fixedly with the rotatably supported shaft 302g. The further second friction element 354g is realized so as to be rotationally fixed with the rotatably supported shaft 302g. The further second friction element 354g is realized as a conical friction element. The further second friction element 354g forms a cone-shaped friction surface. The further second friction element 354g faces towards the attachment element 308g. The further second friction element 354g faces towards the further first friction element 352g, which is formed by the attachment element 308g. The further second friction element 354g is realized as a friction disk having a cone-shaped friction surface. The further second friction element 354g is realized correspondingly to the further first friction element 352g. The further second friction element 354g is configured for frictional contact with the further first friction element 352g. The further second friction element 354g is preferably realized integrally with the rotatable shaft 302g. In principle, it would also be conceivable that the further second friction element 354g is in a rotationally-fixed manner connected to the shaft 302g via connecting means. The two second friction elements 326g, 354g are preferably together realized integrally with the shaft 302g.

In principle, it would also be conceivable that the friction unit 300g comprises only the one first friction element 324g and the one correspondingly-realized second friction element 326g. By way of the implementation of the friction unit 300g with two first friction elements 324g, 352g and two second friction elements 326g, 354g, it is advantageously possible to provide a large, in particular twice as large, friction surface. This advantageously allows increasing a force that can be supported by the friction unit 300g. The two friction elements 324g, 326g and the two friction elements 352g, 354g of the friction unit 300g are configured to be connected to one another in a friction-fitting manner. In a non-actuated state of the friction unit 300g, the corresponding friction elements 324g, 326g, 352g, 354g of the friction unit 300g are respectively connected to one another in a force-fitting manner. As a result of the spring force of the spring elements 322g, 350g of the friction unit 300g, the corresponding friction elements 324g, 326g, 352g, 354g of the friction unit 300g are respectively pressed against one another. In the non-actuated state, the friction element 324g that is realized by the base body 314g is pressed by the spring elements 322g, 350g of the friction unit 300g against the friction element 326g that is realized with the rotatably supported shaft 302g. As a result of the spring force of the spring elements 322g, 350g, the further second friction element 354g that is realized with the shaft 302g is pressed by the base body 314g against the further first friction element 352g that is realized by the attachment element 308g. In the non-actuated state of the friction unit 300g, the second friction elements 326g, 354g, which are rigidly connected with the rotatably supported shaft 302g, are pressed by the spring elements 322g, 350g against the corresponding first friction elements 324g, 352g, such that the friction elements 324g, 326g and the friction elements 352g, 354g are coupled with one another in a friction-fitting manner, and the rotatably supported shaft 302g is thus coupled in a force-fitting manner with the base body 314g, which is rotation-fixedly connected to the backrest frame 38g, and with the attachment element 308g. As a result of this, in the non-actuated state, the rotatably supported shaft 302g is secured against rotation in a force-fitting manner and is rigidly connected with the backrest frame 38g. In the non-actuated state of the friction unit 300g, the rotatably supported shaft 302g is arranged so as to be rotationally fixed relative to the pivotable backrest element 36g, in particular to the backrest frame 38g.

The base body 314g is pressed away from the attachment element 308g by rotation of the spacer element 316g out of its neutral position. As a result of the rotation of the spacer element 316g and the resulting axial displacement of the base body 314g, the friction element 324g that is realized by the base body 314g is lifted off the second friction element 326g that is rigidly connected with the shaft 302g. As a result of the rotation of the spacer element 316g out of its neutral position, a friction force between the friction elements 324g, 326g and the friction elements 352g, 354g is reduced. Advantageously, a frictional connection between the two friction elements 324g, 326g and the friction elements 352g, 354g of the friction unit 300g is undone if the spacer element 316g is rotated into an unlocking position. If the spacer element 316g is in a position rotated out of the neutral position and the frictional connection between the friction elements 324g, 326g and the friction elements 352g, 354g of the friction unit 300g has been reduced or undone, the rotatably supported shaft 302g is released and can rotate around its rotation axis.

For an actuation of the friction unit 300g, the locking device comprises a Bowden cable 150g as actuating means. The Bowden cable 150g is a transmission element configured to transmit an actuating force and an actuating movement from the actuation element to the locking device 70g. In principle, it would also be conceivable that the passenger seat device comprises a different force transmission element for transmitting the actuating force. The Bowden cable 150g is configured to adjust the locking module 72g from a locking position into an unlocking position. The Bowden cable 150g is configured to adjust the friction unit 300g from a non-actuated position into an actuated position. The Bowden cable 150g is configured to rotate the spacer element 316g. The Bowden cable 150g is connected to the spacer element 316g. The spacer element 316g has on its circumference a form-fitting element 330g that is configured for connecting the Bowden cable 150g. An actuating wire of the Bowden cable 150g is connected to the form-fitting element 330g in a form-fitting manner. Preferably, the base body 314g comprises a holding element 332g to which a Bowden cable sheath is connected. The Bowden cable 150g is connected with its first end to the locking module 80g, i.e. to the spacer element 316g of the friction unit 300g. A second end of the Bowden cable 150g is preferably connected to an actuating element, which is not shown in detail and is preferably realized as an actuating button or an actuating lever. Via the actuating element, an actuating force can be transmitted to the Bowden cable 150g, which force is transferred to the friction unit 300g of the locking module 80g in order to actuate the friction unit 300g.

The second locking unit 82g comprises a base body 110g. The base body 110g is realized as a flat, elongate body. The base body 110g is preferably made of a light metal. In principle, it would also be conceivable that the base body 110g is made of a steel. In principle, it would also be conceivable that the base body 110g is made of a different material, for example a synthetic material. In a mounted state, the base body 110g preferably extends from the bearing receptacle 62g to a level just below the first locking unit 80g. In a mounted state, the base body 110g is configured to be rigidly coupled with the bearing element 44g. The base body 110g of the second locking unit 82g is configured for a coupling with the rotatable shaft 302g of the first locking unit 80g.

The locking module 72g has a coupling gear 332g. The coupling gear 332g is configured to couple the first locking unit 80g movably with the second locking unit 82g. The coupling gear 332g is configured, in an actuated state of the friction unit 300g, to convert a relative movement of the movable backrest frame 38g relative to the mounting unit 12g, in particular to the bearing element 44g, into a rotational movement of the rotatable shaft 302g. The coupling gear 332g is configured, in a non-actuated state of the friction unit 300g, to connect the fixed rotatably supported shaft 302g of the first locking unit 80g non-movably to the base body 110g of the second locking unit 82g. The coupling gear 332g connects the rotatably supported shaft 302g of the first locking unit 80g to the base body 110g of the second locking unit 82g. The coupling gear 332g comprises a first toothed element 334g, which is connected with the shaft 302g. The toothed element 334g is realized as a toothed wheel. The toothed element 334g that is realized as a toothed wheel is connected with the shaft 302g in a rotationally-fixed manner. The toothed element 334g that is realized as a toothed wheel is connected to a second end of the shaft 302g on the outer side of the backrest frame 38g. In principle, it would also be conceivable that the toothed element 334g is realized merely as a toothed-wheel section. The coupling gear 332g comprises a second toothed element 336g. The second toothed element 336g of the coupling gear is rigidly connected with the second locking unit 82g. The second toothed element 336g of the coupling gear is rigidly connected with the base body 110g of the second locking unit 82g. The second toothed element 336g forms an upper region of the base body 110g of the second locking unit 82g. The second toothed element 336g is preferably realized integrally with the base body 110g. The second toothed element 336g is realized as a toothed-wheel section having several teeth. The second toothed element 336g is realized by an upper end of the base body 110g. The second toothed element 336g preferably extends over a large extent, preferably over the entire upper side of the base body 110g. The second toothed element 336g meshes with its teeth in the teeth of the first toothed element 334g that is realized as a toothed wheel and is rigidly connected with the shaft 302g.

In a non-actuated state of the friction unit 300g, in which the shaft 302g is fixed by the friction unit 300g, the first toothed element 334g that is realized as a toothed wheel cannot run on the second toothed element 336g that is rigidly arranged on the base body 110g. A supporting force of the pivotable backrest element 36g is transferred via the friction unit 300g into the rotatably supported shaft 302g, via the coupling gear 332g into the base body 110g of the second locking unit 82g, and from there via the bearing element 44g into the mounting unit 12g. In an actuated state of the friction unit 300g, in which the shaft 302g can rotate, the first toothed element 334g that is realized as a toothed wheel can run on the second toothed element 336g that is rigidly arranged on the base body 110g, and the pivotable backrest element 36g can be pivoted relative to the mounting unit 12g.

The first toothed element 334g that is realized as a toothed wheel can be fixed in different positions in the second toothed element 336g by way of fixing the rotatably supported shaft 302g via the friction unit 300g. As a result, the pivotable backrest element 36g can be fixed in different intermediate positions relative to the mounting unit 12g.

In principle, it would also be conceivable that the friction unit 300g is arranged at the first locking unit 80g and is thus connected to the bearing element 44g. In this case, the rotatably supported shaft 302g would also be realized by the first locking unit 80g and would be supported rotatably at the bearing element 44g.

The second locking unit 82g comprises an attachment element 118g. In a normal operation state, the attachment element 118g is connected to the bearing element 44g in a rotationally fixed manner. The base body 110g of the second locking unit 82g is connected to the attachment element 118g. In the mounted state, the base body 110g of the second locking unit 82g is mounted at the attachment element 118g in a loss-proof manner. In a mounted state, the base body 110g preferably bears with its outer side against an inner side of the attachment element 118g. The attachment element 118g is rigidly connected with the bearing element 44g by means of several screws. The attachment element 118g is connected to the connecting flange of the bearing element 44g in a rotationally fixed manner via the screws.

The second locking unit 82g comprises an eccentric adjusting unit 128g. A position of the second locking unit 82g relative to the first locking unit 80g is adjustable by means of the eccentric adjusting unit 128g. A position of the toothed element 336g of the base body 110g of the second locking unit 82g, relative to the shaft 302g and the toothed element 334g of the first locking unit 80g that is connected therewith, is adjustable by means of the eccentric adjusting unit 128g. The eccentric adjusting unit 128g is configured to change a position of the attachment element 118g relative to the base body 110g. The base body 110g of the second locking unit 82g is connected to the attachment element 118g via the eccentric adjusting unit 128g. An angle of the base body 110g relative to the attachment element 118g can be changed via the eccentric adjusting unit 128g. The eccentric adjusting unit 128g comprises a connecting screw 130g, via which the base body 110g is connected to the attachment element 118g. The base body 110g has an elongate through hole 132g. The through hole 132g extends from an inner side to an outer side of the base body 110g. The through hole 132g has a width which is somewhat larger than the diameter of the threaded shank of the connecting screw 130g. The through hole 132g is realized as a long hole. The length of the through hole 132g is preferably by at least 5% larger than the diameter of the threaded shank of the connecting screw 130g. The through hole 132g has a counterbore 134g, which is larger than the screw head of the connecting screw 130g. In the mounted state, the screw head of the connecting screw 130g is arranged completely in the counterbore 134g of the through hole 132g. The eccentric adjusting unit 128g comprises an eccentric element 136g. The eccentric adjusting unit 128g is connected to the attachment element 118g. The attachment element 118g has a round receptacle in which the eccentric element 136g is arranged in a loss-proof and rotatable manner. The eccentric element 136g has an out-of-center through hole 138g. In the mounted state, the connecting screw 130g is guided through the out-of-center through hole 138g. The eccentric adjusting unit 128g comprises a nut 146g, by which the connecting screw 130g is connected to the eccentric element 136g. When the base body 110g is mounted at the attachment element 118g, the position of the out-of-center through hole 138g relative to the base body 110g can be changed by rotating the eccentric element 136g in the receptacle of the attachment element 118g. This allows, during the mounting, an adaption of an angle of the first base body 110g relative to the attachment element 118g, i.e. also relative to the bearing element 44g.

The first locking unit 80g comprises a blocking element 102g. The blocking element 102g is arranged such that it is positionally fixed relative to the first locking unit 82g. The blocking element 102g is realized by the backrest frame 38g, respectively connected thereto. The blocking element 102g is configured for a form-fitting locking of the pivotable backrest element 36g in the comfort position. The blocking element 102g is configured for a form-fitting locking of the pivotable backrest element 36g in the upright seat position. The blocking element 102g is realized as a blocking bolt. The blocking element 102g is arranged on an outer side 76g of the backrest frame 38g. The blocking element 102g is configured to block the pivotable backrest element 36g in the upright seat position in a form-fitting manner in such a way that a further forward-traversing is not possible. The blocking element 102g is configured to block the pivotable backrest element 36g in the comfort position in a form-fitting manner in such a way that a further rearward-traversing is not possible.

The second locking unit 82g comprises a form-fitting element 106g. The form-fitting element 106g is configured for a locking of the pivotable backrest element 36g in the comfort position. The form-fitting element 106g is configured for a coupling with the non-movably supported blocking element 102g of the first locking unit 80g. For the locking of the backrest element 36g in the comfort position, the form-fitting element 106g of the second locking unit 82g is configured to fix the blocking element 102g of the first locking unit 80g in a form-fitting manner. The form-fitting element 106g forms an end abutment for the pivotable backrest element 36g. The form-fitting element 106g is realized as the end of a groove 108g. In a mounted state, the blocking element 102g is in the comfort position and in the upright seat position arranged in the groove 108g. The base body 110g forms the form-fitting element 106g of the second locking unit 82g. The groove 108g, which forms the form-fitting element 106g, is introduced in the inner side of the base body 110g. The groove 108g has a curved course. The groove 108g is open towards a front side of the base body 110g. An end of the groove 108g, which faces away from an opening arranged on the front side, realizes the form-fitting element 106g against which the blocking element 102g abuts in the comfort position.

The second locking unit 82g comprises a further form-fitting element 104g. The form-fitting element 104g is configured for a locking of the pivotable backrest element 36g in the upright seat position. The first form-fitting element 104g is configured for a form-fitting coupling with the blocking element 102g of the first locking unit 80g. For the form-fitting locking of the pivotable backrest element 36g in the upright seat position, the form-fitting element 104g of the second locking unit 82g is configured to fix the blocking element 102g of the first locking unit 80g in a form-fitting manner in one direction. The form-fitting element 104g realizes an abutment element for the blocking element 102g. The form-fitting element 104g is realized as a locking element 144g. The locking element 144g is configured to lock the groove 108g, which forms the second form-fitting element 106g, at the open front end. The locking element 144g is embodied as a locking bolt. In the mounted state, the locking element 144g closes the groove 108g frontwards. The blocking element 102g, which is arranged in the groove 108g, cannot be guided out of the groove 108g. The base body 110g has a receiving hole in which the locking element 144g can be arranged. In a mounted state, the locking element 144g is arranged in the receiving hole. Herein the locking element 144g extends into the groove 108g and blocks it. The receiving hole in which the locking element 144g is arranged extends transversely to the groove 108g. When the locking element 144g has been guided out of the groove 108g, there is an open path for the blocking element 102g out of the groove 108g. As a result, the pivotable backrest element 36g can be folded out of the upright seat position frontwards. Herein the pivotable backrest element 36g can be folded as far as the seat bottom, into a non-use position.

The spring elements 68g, 190g are in each case realized identically and are connected to the backrest frame 38g in an equivalent manner. Therefore, only the one spring element 68g and its connection will be described below, wherein the description may be used for an explanation of the second spring element 190g. The spring element 68g is realized as a spiral spring. The spring element 68g has a spiral-shaped middle region 192g and two spring legs 194g, 196g which protrude from the middle region 192g. The reset module 66g comprises a bearing element 198g, via which the spring element 68g is connected to the backrest frame 38g. The bearing element 198g is realized as a bearing cylinder. The bearing element 198g has a cylinder shell surface on which the spring element 68g rests with its spiral-shaped middle region 192g. The spring element 68g encompasses the bearing element 198g with its spiral-shaped middle region 192g. The bearing element 198g is fixedly connected to the outer side of the lateral frame element of the backrest frame 38g.

Preferably, the bearing element 198g is screwed to the outer side of the lateral frame element of the backrest frame 38g in a positionally fixed manner by means of a screw connection. The first spring leg 194g is configured to be supported on the bearing element 44g. The first spring leg 194g is configured to be supported on the second locking unit 82g. For a support of the first spring leg 194g, the reset module 66g comprises a first support element 200g. The first spring leg 194g is supported on the support element 200g, which is implemented by the second locking unit 82g. The support element 200g is preferably implemented by a base body 86g of the locking unit 82g. The second spring leg 196g is configured to be supported on the backrest element 36g. The second spring leg 196g is configured to be supported on the lateral frame element of the backrest frame 38g. The reset module 66g comprises a second support element 202g for a support of the second spring leg 196g. The second support element 202g is configured for a support of the second spring leg 196g on the backrest frame 38g. The support element 202g is realized as a supporting bolt, which is fixedly connected to a side surface of the lateral frame element of the backrest frame 38g. Preferably, the support element 202g is attached by means of a screw connection. For a support, the spring element 68g bears against the support element 202g with its spring leg 196g.

The first locking module 72g comprises a force transmission unit 152g, which forwards an actuation force exerted by the Bowden cable 150g to the first locking module 72g. The passenger seat device comprises a second Bowden cable 154g. The second Bowden cable 154g is configured to transmit an actuation force from the first locking module 72g to the second locking module 74g. The second locking module 72g is connected in series with the first locking module 72g via the second Bowden cable 154g.

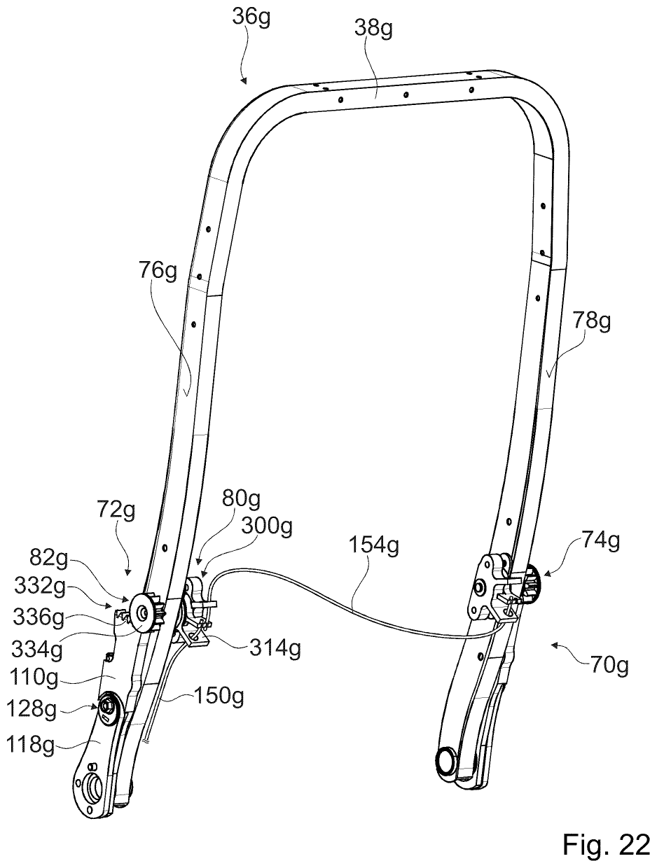

FIGS. 22 to 26 show an eighth exemplary embodiment of a portion of a passenger seat device according to the invention.

The passenger seat device comprises a backrest 34h. The backrest 34h is designed to be pivotable. The backrest 34h is configured to be pivoted between an upright seat position and a comfort position. The backrest 34h comprises a pivotable backrest element 36h. The pivotable backrest element 36h is pivotably supported at a mounting unit. The pivotable backrest element 36h is pivotable between an upright seat position and a comfort position. The pivotable backrest element 36h comprises a backrest frame 38h. The backrest frame 38h forms a load-bearing structure of the pivotable backrest element 36h. The backrest frame 38h forms a load-bearing element of the pivotable backrest element 36h. The passenger seat device is realized substantially identically to the first exemplary embodiment.

The passenger seat device comprises a reset module 66h, which is not shown in detail in the figures. The reset module 66h is configured for a restoring of the backrest 34h from the comfort position into an upright seat position. The reset module 66h is configured for a restoring of the backrest 34h from its pivoted seat position into the upright seat position. For the purpose of restoring the backrest 34h, in particular for restoring the pivotable backrest element 36h, the reset module 66h is configured to provide a resetting force. For the purpose of providing a resetting force, the reset module 66h comprises a first spring element 68h. For the purpose of providing a resetting force, the reset module 66h comprises a second spring element 190h. The spring elements 68h, 190h are in each case arranged on a respective side of the backrest frame 38h. The spring elements are realized identically to the first exemplary embodiment and are therefore not shown in detail here.

The passenger seat device comprises a locking device 70h. The locking device 70h is configured for a locking of the backrest 34h in its upright seat position and in its comfort position. The locking device 70h is configured for a locking of the pivotable backrest element 36h in the upright seat position in a form-fitting manner. The locking device 70h is configured for a locking of the pivotable backrest element 36h in the comfort position in a form-fitting manner.

The locking device 70h is configured for a stepless blocking of the pivotable backrest element 36h between the comfort position and the upright seat position. The locking device 70h is configured for fixing the pivotable backrest element 36h in a positionally fixed manner in any desired positions between the comfort position and the upright seat position. The locking device 70h is configured for a fixing of the pivotable backrest element 36h in any desired intermediate position in a friction-fitting manner. The locking device 70h is realized separately from the spring element 68h, 190h of the reset module 66h.

The locking device 70h comprises a first locking module 72h. The first locking module 72h of the locking device 70h is arranged on a lefthand side of the pivotable backrest element 36h. The locking device 70h comprises a second locking module 74h. The second locking module 74h of the locking device 70h is arranged on a righthand side of the pivotable backrest element 36h. The two locking modules 72h, 74h are together configured for a locking of the backrest 34h, in particular of the pivotable backrest element 36h. The two locking modules 72h, 74h of the locking device 70h are realized substantially identically.

The locking module 72h comprises a first locking unit 80h. The first locking unit 80h is configured to be fastened at the pivotable backrest element 36h. The locking module 72h comprises a second locking unit 82h. The second locking unit 82h is configured to be mounted at a bearing element 44h, which is not shown in detail, in a loss-proof manner.

The locking module 72h comprises a friction unit 300h. The friction unit 300h is configured to provide a holding force for the stepless blocking of the pivotable backrest element 36h. The friction unit 300h is configured to fix the pivotable backrest element 36h in a position in a force-fitting manner. The friction unit 300h is configured to fix the pivotable backrest element 36h in the upright seat position, in the comfort position and in any desired intermediate positions in a force-fitting manner by means of a frictional connection.

The first locking unit 80h has a rotatably supported shaft 302h. The rotatably supported shaft 302h is arranged at the pivotable backrest element 36h. The rotatably supported shaft 302h is rotatably supported at the backrest frame 38h. The rotatably supported shaft 302h is oriented in a transverse direction with respect to the backrest frame 38h. In a mounted state, the rotatably supported shaft 302h extends from an outer side 76h of the backrest frame 38h to an inner side of the backrest frame 38h. The rotatably supported shaft 302h extends through the backrest frame 38h. The backrest frame 38h comprises a bearing receptacle 304h. The bearing receptacle 304h is realized as a through hole through the backrest frame 38h. For the force-fit locking of the pivotable backrest element 36h, the friction unit 300h is configured to secure the rotatably supported shaft 302h against rotation in a force-fitting manner.

The friction unit 300h comprises an attachment element 308h. The attachment element 308h is configured to be directly connected to the inner side of the backrest frame 38h. The attachment element preferably has two fastening holes via which the attachment element 308h is connectable to the backrest frame 38h, preferably by means of a screw connection or a rivet connection. The attachment element 38h has a central receiving region 312h and a through hole through which the rotatably supported shaft 302h is guided. In contrast to the first exemplary embodiment, the receiving region 312h is realized as a spring receptacle.

The friction unit 300h comprises a base body 314h. The base body 314h is realized as a counter holder. The base body 314h is configured to be connected to the attachment element 308h. In contrast to the first exemplary embodiment, the base body 314h is rigidly and non-movably connected to the attachment element 308h. The base body 314h is configured to support the rotatable shaft 302h. The base body 314h comprises a bearing receptacle 328h. The bearing receptacle 328h is realized as a through hole.

The friction unit 300h comprises a first friction element 324h. The first friction element 324h is fixedly connected with the attachment element 308h. The friction unit 300h comprises a spring element 342h. The spring element 342h is realized differently than the spring elements of the friction unit of the first exemplary embodiment. The spring element 342h is realized as a spiral spring. The spring element 342h is realized as a wrap-around spring.

The spring element 342h, which is realized as a wrap-around spring, forms the first friction element 324h. The inner side of the spring element 342h, which is realized as a spiral spring, forms the first friction element 324h of the friction unit 300h. The friction unit 300h comprises a further friction element 356h, which is rigidly connected with the attachment element 308h. The further friction element 356h is realized by the attachment element 308h. The further friction element 356h is realized as the receiving region 312h of the attachment element 308h, which is realized as a spring receptacle region. The receiving region 312h is realized as a lateral-shell surface of the cylindrical spring receptacle region. The friction element 324h, which is realized as a wrap-around spring, is configured to enter into friction-fitting contact with the further friction element 356h, which is realized by the receiving region 312h.

The friction unit 300h comprises a second friction element 326h. The second friction element 326h is realized fixedly with the rotatably supported shaft 302h. The second friction element 326h is realized so as to be rotationally fixed with the rotatably supported shaft 302h. The second friction element 326h is realized integrally with the shaft 302h. The shaft 302h comprises a subregion 344h, in which the shaft 302h has a thicker diameter than in a remaining region. The subregion 344h of the shaft 302h forms the second friction element 326h of the friction unit 300h. The first friction element 324h, which is realized by the spring element 342h, is configured to be connected in a friction-fitting manner to the further friction element 356h, which is realized by the attachment element 308h, and to the second friction element 326h, which is realized by the subregion 344h of the shaft 302h, in a friction-fitting manner. In a non-actuated state of the friction unit 300h, the first friction element 324h, which is realized by the spring element 342h, is respectively connected in a force-fitting manner to the further friction element 356h of the friction unit 300h, which is realized by the attachment element 308h, and to the second friction element 326h of the friction unit 300h, which is realized by the subregion 344h of the shaft 302h. In a non-actuated state, the spring element 342h presses with its inner side, which forms the first friction element 342h of the friction unit 300h, onto the lateral surface of the subregion 344h of the shaft 302h, which forms the second friction element 326h, as a result of which the two friction elements 324h, 326h are connected to one another in a friction-fitting manner. In a non-actuated state, the spring element 342h presses with its inner side, which forms the first friction element 342h of the friction unit 300h, onto the lateral surface of the attachment region 312h, which forms the further friction element 356h, as a result of which the two friction elements 324h, 356h are connected to one another in a friction-fitting manner. In a non-actuated state, the rotatably supported shaft 302h and the attachment element 308h are directly coupled with each other in a rotationally fixed manner via the spring element 342h via a frictional connection. The spring element 342h, which forms the first friction element 324h, is connected in a rotationally-fixed manner to the shaft 302h via the second friction element 326h, and is connected in a friction-fitting manner to the attachment element 308h via the further friction element 356h in a rotationally-fixed manner. In an actuated state, the spring element 342h is rotated and is thus detached with its inner side from the lateral surface of the shaft 302h, as a result of which a friction force between the first friction element 324h and the second friction element 326h, as well as between the first friction element 324h and the further friction element 356h, is reduced and a frictional connection is undone.

The spring element 342h that is realized as a spiral spring is connected to the attachment element 308h in a rotationally fixed manner. The spring element 342h is with a first end fixedly connected to the attachment element. The friction unit 300h comprises an actuating element 346h. The actuating element 346h is configured to be rotated for an actuation of the spring element 342h. The actuating element 346h is supported so as to be rotatable with the base body 314h. The spring element 342h is with a second end fixedly connected to the actuating element 346h. By rotating the actuating element 346h, the spring element 342h can be adjusted from its non-actuated state into its actuated state. As a result of the rotation of the actuating element 346h out of its neutral position, a friction force between the friction elements 234h, 236h is reduced. Advantageously, a frictional connection between the two friction elements 324h, 326h of the friction unit 300h is undone if the actuating element 346h is rotated into an unlocking position. If the actuating element 346h is in a position rotated out of the neutral position and the resulting reduced or undone frictional connection between the friction elements 324h, 326h of the friction unit 300h has been reduced or undone, the rotatably supported shaft 302h is released and can rotate around its rotation axis.

For an actuation of the friction unit 300h, the locking device comprises a Bowden cable 150h as actuating means. The Bowden cable 150h is a transmission element configured to transmit an actuating force and an actuating movement from the actuating element to the locking device 70h. The Bowden cable 150h is configured to adjust the locking module 80h from a locking position into an unlocking position. The Bowden cable 150h is configured to rotate the actuating element 346h. The Bowden cable 150h is connected to the actuating element 346h. The actuating element 346h comprises on its circumference a form-fitting element 330h that is configured for connecting the Bowden cable 150h.

The second locking unit 82h comprises a base body 110h. The base body 110h is realized as a flat, elongate body. The locking module 72h comprises a coupling gear 332h. The coupling gear 332h is configured to couple the first locking unit 80h movably with the second locking unit 82h. The coupling gear 332h is configured, in an actuated state of the friction unit 300h, to convert a relative movement of the movable backrest frame 38h relative to the mounting unit 12h, in particular to the bearing element 44h, into a rotational movement of the rotatable shaft 302h. The coupling gear 332h comprises a first toothed element 334h, which is connected with the shaft 302h. The toothed element 334h is realized as a toothed wheel. The coupling gear 332h comprises a second toothed element 336h. The second toothed element 336h of the coupling gear 332h is rigidly connected with the second locking unit 82h. The second toothed element 336h of the coupling gear 332h is rigidly connected with the base body 110h of the second locking unit 82h. The second toothed element 336h is realized as a toothed-wheel section having several teeth. The second toothed element 336h is realized by an upper end of the base body 110h. The second locking unit 82h, the coupling gear 332h and an eccentric adjusting unit 128h are realized substantially identically to the first exemplary embodiment and will therefore not be described in detail again here.

1. A passenger seat device with a mounting unit for mounting on a mounting plane, with two seat structure elements, which are in each case arranged on a respective side of a sitting area, with two bearing elements, wherein respectively one bearing element is fixedly connected with one of the seat structure elements, with a backrest comprising at least one pivotable backrest element which is pivotably supported on the seat structure elements via the bearing elements, with at least one reset module comprising at least one spring element to provide a resetting force for restoring the pivotable backrest element from a comfort position into an upright seat position, and with a locking device which is configured for locking the pivotable backrest element at least in the upright seat position, wherein the locking device comprises at least one locking module, which is arranged between the first seat structure element and a load-bearing element of the pivotable backrest element.

2. The passenger seat device according to claim 1, wherein the locking device is arranged mostly above the bearing elements.

3. The passenger seat device according to claim 1, wherein the locking device is realized separately from the spring element.

4. The passenger seat device according to claim 1, wherein the locking module is arranged on an outer side of the load-bearing element of the pivotable backrest element.

5. The passenger seat device according to claim 1, wherein the locking module comprises a first locking unit and a second locking unit, which are supported movably with respect to each other and are configured to be locked with each other in the upright seat position and in the comfort position in at least one of a form-fitting and force-fitting manner.

6. The passenger seat device according to claim 5, wherein the first locking unit comprises a base body, and comprises a blocking element which is supported on the base body in a spring-loaded and adjustable manner between a locking position and a release position, and is configured to be coupled with the second locking unit in a form-fitting manner for locking.

7. The passenger seat device according to claim 5, wherein the first locking unit comprises a linear guidance supporting the blocking element, which is supported in a spring-loaded and adjustable manner, linearly along a displacement path.

8. The passenger seat device according to claim 6, wherein the second locking unit comprises a form-fitting element which, for the purpose of locking the pivotable backrest element in the upright seat position, is configured to fix the blocking element of the first locking unit in at least one of a form-fitting and force-fitting manner.

9. The passenger seat device according to claim 5, wherein in a mounted state, the first locking unit is mounted on the pivotable backrest element and the second locking unit is mounted on the bearing element, in a loss-proof manner.

10. The passenger seat device according to claim 7, wherein the second locking unit comprises an attachment element, which is in a normal operation state connected to the bearing element in a rotationally fixed manner, and comprises an overload unit, which is configured to permit a relative movement between the attachment element and the bearing element in the event of an overload.

11. The passenger seat device according to claim 5, wherein the second locking unit comprises a second form-fitting element, which forms an end abutment for the comfort position of the pivotable backrest element, and that the first locking unit comprises a second blocking element which is configured, in the comfort position, to lock the pivotable backrest element by a form-fitting connection to the second form-fitting element of the second locking unit.

12. The passenger seat device according to claim 5, wherein the second locking unit comprises an eccentric adjusting unit, by means of which a position of the form-fitting element is adjustable relative to the first locking unit.

13. The passenger seat device according to claim 6, wherein the second locking unit comprises an abutment surface against which the blocking element of the first locking unit abuts in the comfort position of the pivotable backrest element, wherein the abutment surface forms an inclined surface via which the blocking element can be pressed out of its locking position into a release position.

14. The passenger seat device according to claim 1, wherein the reset module comprises a release unit, which is configured, in a release position, to undo a coupling between the first locking unit and the second locking unit in order to enable a pivoting of the pivotable backrest element forwards, beyond the upright seat position into a non-use position.

15. The passenger seat device according to claim 1, wherein the locking device comprises a second locking module, which is arranged on a side of the pivotable backrest element that is situated opposite the first locking module and is realized substantially identically to the first locking module.

16. The passenger seat device according to claim 5, wherein the second locking module is actuatable together with the first locking module via a Bowden cable, wherein the second locking module is connected in series with the first locking module.

17. The passenger seat device according to claim 1, wherein the locking device is configured for a stepless blocking of the pivotable backrest element between the comfort position and the upright seat position.

18. The passenger seat device according to claim 17, wherein the at least one locking module comprises a friction unit, which is configured to provide a holding force for a stepless blocking of the pivotable backrest element.

19. The passenger seat device according to claim 17, wherein one of the locking units of the locking module comprises a rotatably supported shaft, which is configured to rotate during a pivoting of the pivotable backrest element, and comprises a friction unit which, for the locking of the pivotable backrest element, is configured to secure the rotatably supported shaft against rotation in a force-fitting manner.

20. The passenger seat device according to claim 17, wherein one of the locking units of the locking module comprises a base body, wherein the locking module comprises a coupling gear via which the base body is connected to the rotatably supported shaft of the other locking unit, and which is configured to transmit a pivoting movement of the pivotable backrest element to the rotatably supported shaft.

21. The passenger seat device according to claim 17, wherein the at least one locking module comprises a friction unit, which for the purpose of providing a holding force comprises a first friction element, a second friction element that is connected to a rotatably supported shaft of the locking module, and at least one spring element, wherein the at least one spring element presses the two friction elements against each other in a non-actuated state.
